(19) United States
(12) Patent Application Publication
(10) Pub. No.: US 2012/0225962 A1
(43) Pub. Date: Sep. 6, 2012

(54) MOLECULARLY IMPRINTED POLYMERS, METHODS FOR THEIR PRODUCTION AND USES THEREOF

(75) Inventors: Milton T.W. Hearn, Balwyn (AU); Jamil M. Chowdhury, Skye (AU); Reinhard Ingemar Boysen, Wheelers Hill (AU); Yididya B. Banti, Clayton (AU)

(73) Assignee: MONASH UNIVERSITY, Clayton, Victoria (AU)

(21) Appl. No.: 13/388,772

(22) PCT Filed: Aug. 5, 2010
(86) PCT No.: PCT/AU2010/000992

§ 371 Date: May 16, 2012

(30) Foreign Application Priority Data
Aug. 5, 2009 (AU) 2009903658

(51) Int. Cl. C08J 9/06; C07F 9/6506; C08F 220/10; C07F 9/572

(52) U.S. Cl. 521/108; 548/415; 548/119; 521/149

(57) ABSTRACT

The present invention relates to methods of preparing molecularly imprinted polymers (MIPs) which facilitate chemical hydrolysis and more particularly the hydrolysis of chemical substrates which possess hydrolytically labile bonds such as peptides and proteins. The present invention is thus directed to MIPs designed to possess hydrolytic activity, methods for preparing such MIPs and uses of the MIPs.

### FIELD OF THE INVENTION

The present invention generally relates to methods of preparing molecularly imprinted polymers (MIPs) which facilitate chemical hydrolysis and more particularly the hydrolysis of chemical substrates which possess hydrolytically labile bonds such as peptides and proteins. Accordingly, the present invention is directed to MIPs designed to possess hydrolytic activity, methods for preparing such MIPs and uses of the MIPs.

### BACKGROUND OF THE INVENTION

Serine proteases (also known as serine endopeptidases) are proteases in which one of the amino acids at the active site is serine.

This family of enzymes is found in both single-cell and complex organisms, and in both eukaryotes and prokaryotes.

Serine proteases are grouped into superfamilies based on structural homology and are then further sub-grouped into families with similar sequences.

The major superfamilies found in humans and other mammals include the chymotrypsin-like, the subtilisin-like, the alpha/beta hydrolase, and signal peptidase clans.

While serine proteases were originally digestive enzymes, in mammals, they have evolved to also serve functions in blood clotting, the immune system, and inflammation.

The three most studied serine proteases of the chymotrypsin-like clan are chymotrypsin, trypsin, and elastase. All three enzymes are synthesized by the pancreatic acinar cells, secreted in the small intestine, and are responsible for catalyzing the hydrolysis of peptide bonds. While these enzymes are similar in structure, they differ with respect to the peptide bond that is being cleaved; this is called the scissile bond. Like most enzymes, each of chymotrypsin, trypsin, and elastase are highly specific in the reactions that they catalyze. Each target a different region of a polypeptide chain, based upon the side chains of the amino acid residues surrounding the site of cleavage.

Chymotrypsin is responsible for cleaving peptide bonds following a bulky hydrophobic amino acid residue. Such residues include phenylalanine, tryptophan, and tyrosine.

Trypsin is responsible for cleaving peptide bonds following a positively-charged amino acid residue (and preferably lysine and/or arginine). Instead of having the hydrophobic pocket of the chymotrypsin, there exists an aspartic acid residue at the base of the pocket. This can then interact with positively-charged residues such as arginine and lysine on the substrate peptide to be cleaved.

Elastase is responsible for cleaving peptide bonds following a small neutral amino acid residue, such as alanine, glycine, and valine. These amino acid residues form much of the connective tissues in meat. The pocket that is in “trypsin” and “chymotrypsin” is partially occupied with valine and threonine, rendering it a mere depression, which can accommodate these smaller amino acid residues.

The main component in the catalytic mechanism in the chymotrypsin and subtilisin-like clan of enzymes is called the “catalytic triad”. The triad is located in the active site of the enzyme, where catalysis occurs, and is preserved in all serine protease enzymes. The triad is a coordinated structure consisting of three essential amino acids: histidine (H is 57), serine (Ser 195) and aspartic acid (Asp 102). Located very near one another, these three key amino acids each play a role in the cleaving ability of the proteases.

An ordered mechanism occurs during catalysis in which several intermediates are generated. In the catalysis involving peptide cleavage a substrate binds (for instance, the polypeptide being cleaved), a product is released (the N-terminal “half” of the peptide), another substrate binds (in this case, water), and another product is released (the C-terminal “half” of the peptide).

Each amino acid in the triad performs a specific task in this process and this is illustrated by the scheme in FIG. 1. The serine has an —OH group that is able to act as a nucleophile, attacking the carbonyl carbon of the scissile peptide bond of the substrate. A pair of electrons on the histidine nitrogen has the ability to accept the hydrogen from the serine —OH group, thus coordinating the attack of the peptide bond. While the carboxyl group on the aspartic acid in turn forms hydrogen bonds with the histidine, making the pair of electrons mentioned above much more electronegative.

While the catalytic abilities of such enzymes have been employed in industry for some time, proteases, like most other enzymes, are sensitive to temperature and pH. Often industrial processes (for instance, bioremediation) utilise pH and temperature resilient genetically modified microbes. However, it is feared that the use of such microbes could be problematic should they be accidentally or deliberately released into the environment. Thus, applications of such biotechnology require additional measures for managing these environmental concerns. Accordingly, it would be beneficial and desirable to prepare non-biological mimics of such enzymes.

### SUMMARY OF THE INVENTION

The present invention is based on the discovery that the molecularly imprinted polymers (MIPs) can be designed which are able to effectively hydrolyse amide and ester bonds and more particularly mimic enzymatic amide bond catalysis. Such MIPs have significant potential for use in, for instance, the treatment of protein/peptide industrial waste effluent. For example, during curing and tanning in leather processing both protein and fat are removed from the hides. The protein/peptide by-products of such processes (effluent) are typically considered biohazardous and therefore can be a major expense to treat.

The digestion of the protein component of effluent produced by some of the processes described above can be achieved by alkali salt solutions or alkaline protease enzymes at elevated temperatures but such treatment processes also suffer from the use of toxic or potentially biohazardous materials.

Other industrial applications include the use of enzymes in detergents (laundry and dishwashing), food (including dairy), baking, pulp and paper processing and also in the textile and biotechnology industries. Also, in many of the applications which use enzymes the chemical nature of the feed stock and reaction conditions are often not amenable to allow the recycling of the enzymes which also increases capital expenditure.

The MIPs of the present invention offer a safer and economical alternative to these chemical/enzymatic processes in addition to providing recyclable, as well as chemically and biologically stable polymeric catalysts.

In the field of analytical protein chemistry and proteomics, proteases are used for the site specific in-solution proteolysis of proteins or for their on-column proteolysis with immobilised enzymes. The resulting peptides are then separated using high-performance liquid chromatography and identified with mass spectrometry. The enzymes employed in the in-solution proteolysis of proteins are normally not retrieved, since they may undergo autolysis. Although enzymes used in on-column proteolysis are less susceptible to autolysis in comparison to enzymes used in in-solution processes, their lifetime is still limited due to their chemical and biological instability (including their susceptibility to other proteases) thus limiting the life time of such columns. The MIPs of the present invention which may be in the form of beads, may be used as an alternative to enzymes in batch incubation processes, where the MIP is retrieved after this process is completed.

The MIPs of the present invention can be designed with variable levels of cross-linking to produce polymers with controlled rigidity or flexibility, dependent upon the functional requirement, and which contain cavities that can be tailor made to be specific for any particular substrate. MIPs may be generally thought of as a plastic mold, cast or pocket of a molecule of interest (also referred to as a template), where recognition is based on the shape of the pocket and the chemical functionalities within the pocket. Using a template molecule, MIPs can be prepared that are specific for the template compound or selective for other molecules having a similar chemical structure. The MIPs of the present invention are based on a polymeric network having high selectivity and specificity. The MIPs of the present invention offer the benefits of enhanced resistance to temperature, extremes of pH, solvents, and degradation or denaturation.

Accordingly, in one aspect the invention provides a process for preparing a molecularly imprinted polymer (MIP) for hydrolysing amide or ester groups, said process comprising the steps of:
(i) preparing a molecular template comprising:
   a tetrahedral chemical moiety which is covalently bound to a pocket forming portion,
(ii) polymerising a monomer and a cross-linking agent in the presence of the molecular template and a porogen; and
(iii) separating the template, or part thereof, from the polymer formed in (ii), to afford the MIP.

In a further aspect the invention provides a process for preparing a molecularly imprinted polymer (MIP) which mimics the catalytic activity of trypsin, said process comprising the steps of:
(i) preparing a molecular template comprising:
   (a) a tetrahedral chemical moiety which is covalently bound to a pocket forming portion; and
   (b) a histidine like portion (hlp) which is covalently bound to a serine like portion (slp), said hlp or slp bearing a free-radical polymerisable group,
(ii) polymerising a monomer having a free-acid group (or protected form thereof) with a cross-linking agent and the molecular template in the presence of a porogen, such that the free-acid group is able to form a hydrogen bond with the hlp; and
(iii) separating the template, or part thereof, from the polymer formed from (ii), to afford the MIP.

In the above aspect of mimicking the activity of trypsin preferably the pocket forming portion comprises an amino or guanidino moiety (or a protected form thereof).

### BRIEF DESCRIPTION OF FIGURES

FIG. 1: Representation of the catalytic mechanism of amide hydrolysis of a serine protease His-Ser-Asp triad.

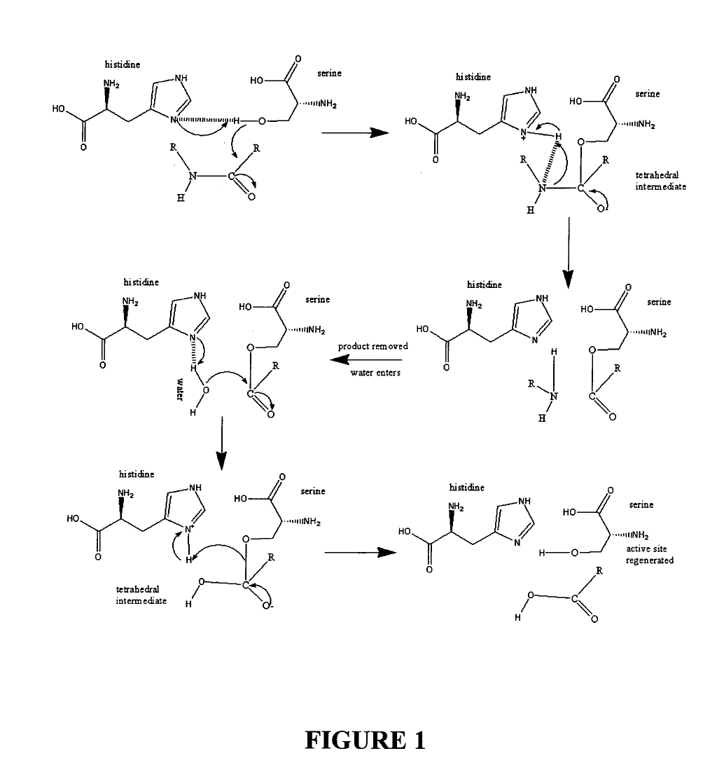

FIG. 2: SEM images of (A) PTSPA-imprinted polymer and (B) PTSPA-non-imprinted polymer. The polymers were prepared with the EDMA cross-linker and using chloroform as porogenic solvent. SEM images were taken with an acceleration voltage of 15 kV and 20,000 times magnification.

FIG. 3: SEM images (A) TSPA-1 imprinted polymer and (B) TSPA-1 non-imprinted polymer that were prepared using 4-VI monomer-to-DVB cross-linker ratio of 1-to-2, (C) TSPA-4 imprinted polymer and (D) TSPA-4 non-imprinted polymer that were prepared using 4-VI-to-DVB cross-linker ratio of 1-to-9. Polymers prepared using acetonitrile as porogenic solvent. SEM images were taken with 20,000 times magnification.

FIG. 4: SEM images of (A) the TSPA-5 imprinted polymer and (B) the TSPA-5 non-imprinted polymer. The polymers were prepared using acetonitrile as porogenic solvent and a 4-VI-to-EDMA cross-linker ratio of 1-to-9. SEM images were taken with 20,000 times magnification.

### DETAILED DESCRIPTION OF THE INVENTION

The term “molecularly imprinted polymer” or “MIP” as used in respect of the present invention, refers to a molecular mold-like polymer structure that has (i) at least one preorganised reactive moiety which is capable of hydrolysing an amide and/or ester group of a substrate bearing same, and (ii) a cavity or “pocket portion” which aligns or accommodates the substrate bearing said amide and/or ester group in an orientation such as to facilitate amide and/or ester hydrolysis.

The MIPs of the present invention may be formed by polymerising a monomer and cross-linking agent in the presence of a molecular template and porogen.

Suitable monomers may be selected from: methylmethacrylate, other alkyl methacrylates (such as, ethylmethacrylate, propylmethacrylate, butylmethacrylate, isobutylmethacrylate, isobutylmethacrylate, etc.), alkylacrylates, ally or aryl acrylates and methacrylates, cyanoacrylate, styrene, methyl styrene, vinyl esters, including vinyl acetate, vinyl chloride, methyl vinyl ketone, vinylidene chloride, acrylamide, methacrylamide, acrylonitrile, methacrylonitrile, 2-acetamido acrylic acid; 2-(acetoxyacetoxy)ethyl methacrylate 1-acetoxy-1,3-butadiene; 2-acetoxy-3-butenenitrile; 4-acetoxystyrene; acrolein; acrolein diethyl acetal; acrolein dimethyl acetal; acrylamide; 2-acrylamidoglycolic acid; 2-acrylamido-2-methyl propane sulfonic acid; acrylic acid; acrylic anhydride; acrylonitrile; acryloyl chloride; (R)-α-acryloxy-β, β′-dimethyl-g-butyrolactone; N-acryloxy succinimide N-acryloxytris(hydroxymethyl)aminomethane; N-acryloly chloride; N-acryloyl pyrrolidinone; N-acryloyl-tris(hydroxymethyl)amino methane; 2-amino ethyl methacrylate; N-(3-aminopropyl)methacrylamide; (o, m, or p)-amino-styrene; t-amyl methacrylate; 2-(1-aziridinyl)ethyl methacrylate; 2,2′-azobis-(2-amidinopropane); 2,2′-azobisisobutyronitrile; 4,4′-azobis-(4-cyanovaleric acid); 1,1′-azobis-(cyclohexanecarbonitrile); 2,2′-azobis-(2,4-dimethylvaleronitrile); 4-benzyloxy-3-methoxystyrene; 2-bromoacrylic acid; 4-bromo-1-butene; 3-bromo-3,3-difluoropropane; 6-bromo-1-hexene; 3-bromo-2-methacrylonitrile; 2-(bromomethyl)acrylic acid; 8-bromo-1-octene; 5-bromo-1-pentene; cis-1-bromo-1-propene; β-bromostyrene; p-bromostyrene; bromotrifluoro ethylene; (±)-3-buten-2-ol; 1,3-butadiene; 1,3-butadiene-1,4-dicarboxylic acid; 3-butenal diethyl acetal; 1-butene; 3-buten-2-ol; 3-butenyl chloroformate; 2-butylacrolein; N-t-butylacrylamide; butyl acrylate; (o, m, p)-bromostyrene; t-butyl acrylate; (R)-carvone; (S)-carvone; (−)-carvyl acetate; c is 3-chloroacrylic acid; 2-chloroacrylonitrile; 2-chloroethyl vinyl ether; 2-chloromethyl-3-trimethylsilyl-1-propene; 3-chloro-1-butene; 3-chloro-2-chloromethyl-1-propene; 3-chloro-2-methyl propene; 2,2-bis(4-chlorophenyl)-1,1-dichloroethylene; 3-chloro-1-phenyl-1-propene; m-chlorostyrene; o-chlorostyrene; p-chlorostyrene; 1-cyanovinyl acetate; 1-cyclopropyl-1-(trimethylsiloxy)ethylene; 2,3-dichloro-1-propene; 2,6-dichlorostyrene; 1,3-dichloropropene; 2,4-diethyl-2,6-heptadienal; 1,9-decadiene; 1-decene; 1,2-dibromoethylene; 1,1-dichloro-2,2-difluoroethylene; 1,1-dichloropropene; 2,6-difluorostyrene; dihydrocarveol; (±)-dihydrocarvone; (−)-dihydrocarvyl acetate; 3,3-dimethylacrylaldehyde; N,N′-dimethylacrylamide; 3,3-dimethylacrylic acid; 3,3-dimethylacryloyl chloride; 2,3-dimethyl-1-butene; 3,3-dimethyl-1-butene; 2-dimethyl aminoethyl methacrylate; 2,4-dimethyl-2,6-heptadien-1-ol; 2,4-dimethyl-2,6-heptadienal; 2,5-dimethyl-1,5-hexadiene; 2,4-dimethyl-1,3-pentadiene; 2,2-dimethyl-4-pentenal; 2,4-dimethylstyrene; 2,5-dimethylstryene; 3,4-dimethylstryene; divinyl benzene; 1,3-divinyltetramethyl disiloxane; 8,13-divinyl-3,7,12,17-tetramethyl-21H,23H-porphine; 8,13-divinyl-3,7,12,17-tetramethyl-21H,23H-propionic acid; 8,13-divinyl-3,7,12,17-tetramethyl-21H,23H-propionic acid disodium salt; 3,9-divinyl-2,4,8,10-tetraoraspiro[5,5]undecane; divinyl tin dichloride; 1-dodecene; 3,4-epoxy-1-butene; 2-ethyl acrolein; ethyl acrylate; 2-ethyl-1-butene; (±)-2-ethylhexyl acrylate; (±)-2-ethylhexyl methacrylate; 2-ethyl-2-(hydroxymethyl)-1,3-propanediol triacrylate; 2-ethyl-2-(hydroxymethyl)-1,3-propanediol trimethacrylate; ethyl vinyl ether; ethyl vinyl ketone; ethyl vinyl sulfone; (1-ethylvinyl)tributyl tin; m-fluorostyrene; o-fluorostyrene; p-luorostyrene; glycol methacrylate (hydroxyethyl methacrylate); 1,6-heptadiene; 1,6-heptadienoic acid; 1,6-heptadien-4-ol; 1-hepten; 1-hexen-3-ol; 1-hexene; hexafluoropropene; 1,6-hexanediol diacrylate; 1-hexadecene; 1,5-hexadien-3,4-diol; 1,4-hexadiene; 1,5-hexadien-3-ol; 1,3,5-hexatriene; 5-hexen-1,2-diol; 5-hexen-1-ol; hydroxypropyl acrylate; 3-hydroxy-3,7,11-trimethyl-1,6,10-dodecatriene; isoprene; 2-isopropenylaniline; isopropenyl chloroformate; 4,4′-isopropylidene dimethacrylate; 3-isopropyl-α,α-dimethylbenzene isocyanate; isopulegol; itaconic acid; itaconalyl chloride; lead (II) acrylate; (±)-Jinalool; linalyl acetate; p-mentha-1,8-diene; p-mentha-6,8-dien-2-ol; methyleneamino acetonitrile; methacrolein; [3-(methacryloylamino)-propyl]trimethylammonium chloride; methacrylamide; methacrylic acid; methacrylic anhydride; methacrylonitrile; methacryloyl chloride; 2-(methacryloyloxy)ethyl acetoacetate; (3-methacryloxypropyl)trimethoxy silane; 2-(methacryloxy)ethyl trimethyl ammonium methylsulfate; 2-methoxy propene (isopropenyl methyl ether); methyl-2-(bromomethyl)acrylate; 5-methyl-5-hexen-2-one; N,N′-methylene bisacrylamide; 2-methylene glutaronitrite; 2-methylene-1,3-propanediol; 3-methyl-1,2-butadiene; 2-methyl-1-butene; 3-methyl-1-butene; 3-methyl-1-buten-1-ol; 2-methyl-1-buten-3-yne; 2-methyl-1,5-heptadiene; 2-methyl-1-heptene; 2-methyl-1-hexene; 3-methyl-1,3-pentadiene; 2-methyl-1,4-pentadiene; (±)-3-methyl-1-pentene; (±)-4-methyl-1-pentene; (±)-3-methyl-1-penten-3-ol; 2-methyl-1-pentene; α-methyl styrene; t-α-methylstyrene; t-β-methylstyrene; 3-methylstyrene; methyl vinyl ether; methyl vinyl ketone; methyl-2-vinyloxirane; 4-methylstyrene; methyl vinyl sulfone; 4-methyl-5-vinylthiazole; myrcene; t-β-nitrostyrene; 3-nitrostyrene; 1-nonadecene; 1,8-nonadiene; 1-octadecene; 1,7-octadiene; 7-octene-1,2-diol; 1-octene; 1-octen-3-ol; 1-pentadecene; 1-pentene; 1-penten-3-ol; t-2,4-pentenoic acid; 1,3-pentadiene; 1,4-pentadiene; 1,4-pentadien-3-ol; 4-penten-1-ol; 4-penten-2-ol; 4-phenyl-1-butene; phenyl vinyl sulfide; phenyl vinyl sulfonate; 2-propene-1-sulfonic acid sodium salt; phenyl vinyl sulfoxide; 1-phenyl-1-(trimethylsiloxy)ethylene; propene; safrole; styrene(vinyl benzene); 4-styrene sulfonic acid sodium salt; styrene sulfonyl chloride; 3-sulfopropyl acrylate potassium salt; 3-sulfopropyl methacrylate sodium salt; tetrachloroethylene; tetracyano ethylene; tetramethyldivinyl siloxane; trans 3-chloroacrylic acid; 2-trifluoromethyl propene; 2-(trifluoromethyl) propenoic acid; 2,4,4′-trimethyl-1-pentene; 3,5-bis(trifluoromethyl)styrene; 2,3-bis(trimethylsiloxy)-1,3-butadiene; 1-undecene; vinyl acetate; vinyl acetic acid; 4-vinyl anisole; 9-vinyl anthracene; vinyl behenate; vinyl benzoate; vinyl benzyl acetate; vinyl benzyl alcohol; 3-vinyl benzyl chloride; 3-(vinyl benzyl)-2-chloroethyl sulfone; 4-(vinyl benzyl)-2-chloroethyl sulfone; N-(p-vinyl benzyl)-N,N′-dimethyl amine; 4-vinyl biphenyl (4-phenyl styrene); vinyl bromide; 2-vinyl butane; vinyl butyl ether; 9-vinyl carbazole; vinyl carbinol; vinyl cetyl ether; vinyl chloroacetate; vinyl chloroformate; vinyl crotanoate; vinyl cyclohexane; 4-vinyl-1-cyclohexene; 4-vinylcyclohexene dioxide; vinyl cyclopentene; vinyl dimethylchlorosilane; vinyl dimethylethoxysilane; vinyl diphenylphosphine; vinyl 2-ethyl hexanoate; vinyl 2-ethylhexyl ether; vinyl ether ketone; vinyl ethylene; vinyl ethylene iron tricarbonyl; vinyl ferrocene; vinyl formate; vinyl hexadecyl ether; vinylidene fluoride; 1-vinyl imidizole; vinyl iodide; vinyl laurate; vinyl magnesium bromide; vinyl mesitylene; vinyl 2-methoxy ethyl ether; vinyl methyl dichlorosilane; vinyl methyl ether; vinyl methyl ketone; 2-vinyl naphthalene; 5-vinyl-2-norbornene; vinyl pelargonate; vinyl phenyl acetate; vinyl phosphonic acid, bis(2-chloroethyl) ester; vinyl propionate; 4-vinyl pyridine; 2-vinyl pyridine; 1-vinyl-2-pyrrolidinone; 2-vinyl quinoline; 1-vinyl silatrane; vinyl sulfone; vinyl sulfone (divinylsulfone); vinyl sulfonic acid sodium salt; o-vinyl toluene; p-vinyl toluene; vinyl triacetoxysilane; vinyl tributyl tin; vinyl trichloride; vinyl trichlorosilane; vinyl trichlorosilane (trichlorovinylsilane); vinyl triethoxysilane; vinyl triethylsilane; vinyl trifluoroacetate; vinyl trimethoxy silane; vinyl trimethyl nonylether; vinyl trimethyl silane; vinyl triphenyphosphonium bromide (triphenyl vinyl phosphonium bromide); vinyl tris-(2-methoxyethoxy)silane; vinyl 2-valerate, and the like.

In relation to the aspect which mimics trypsin-like serine proteases the following monomers are preferred: 2-acetamido acrylic acid; 2-acrylamidoglycolic acid; 2-acrylamido-2-methyl propane sulfonic acid; acrylic acid; 2-bromoacrylic acid; 2-(bromomethyl)acrylic acid; 1,3-butadiene-1,4-dicarboxylic acid; c is 3-chloroacrylic acid; 3,3-dimethylacrylic acid; 1,6-heptadienoic acid; itaconic acid; methacrylic acid; 4-methyl-5-vinylthiazole; 2-propene-1-sulfonic acid sodium salt; 4-styrene sulfonic acid sodium salt; 3-sulfopropyl acrylate potassium salt; 3-sulfopropyl methacrylate sodium salt; trans 3-chloroacrylic acid; 2-(trifluoromethyl) propenoic acid; vinyl acetic acid; vinyl phosphonic acid, and vinyl sulfonic acid sodium salt.

In a further embodiment where the intention is to mimic chymotrypsin-like or elastase-like activity the above preferred monomers would also be desirable together with the additional following monomers: methylmethacrylate, other alkyl methacrylates (such as, ethylmethacrylate, propylmethacrylate, butylmethacrylate, isobutylmethacrylate, WO 2011/014923 PCT/AU2010/000992 isobutylmethacrylate, etc.), alkylacrylates, ally or aryl acrylates and methacrylates, styrene, methyl styrene, vinyl esters, including vinyl acetate, methyl vinyl ketone, 4-acetoxystyrene; acrolein diethyl acetal; acrolein dimethyl acetal; t-amyl methacrylate; 4-benzyloxy-3-methoxystyrene; β-bromostyrene; p-bromostyrene; 3-butenal diethyl acetal; 1-butene; 2-butylacrolein; N-t-butylacrylamide; butyl acrylate; (o, m, p)-bromostyrene; t-butyl acrylate; (R)-carvone; (S)-carvone; (−)-carvyl acetate; 2-chloromethyl-3-trimethylsilyl-1-propene; 3-chloro-1-butene; 3-chloro-2-methyl propene; 3-chloro-1-phenyl-1-propene; m-chlorostyrene; o-chlorostyrene; p-chlorostyrene; 1-cyanovinyl acetate; 2,6-dichlorostyrene; 2,6-difluorostyrene; dihydrocarveol; (±)-dihydrocarvone; (−)-dihydrocarvyl acetate; 2,3-dimethyl-1-butene; 3,3-dimethyl-1-butene; 2-dimethyl aminoethyl methacrylate; 2,4-dimethylstyrene; 2,5-dimethylstryene; 3,4-dimethylstryene; 1-dodecene; ethyl acrylate; 2-ethyl-1-butene; (±)-2-ethylhexyl acrylate; (±)-2-ethylhexyl methacrylate; m-fluorostyrene; o-fluorostyrene; p-fluorostyrene; 1-hexene; 4-methylstyrene; 1-pentene; 2,4,4′-trimethyl-1-pentene; 2-vinyl butane; vinyl propionate; o-vinyl toluene; and p-vinyl toluene.

Acrylate-terminated or otherwise unsaturated urethanes, carbonates, and epoxides may also be used. An example of an unsaturated carbonate is allyl diglycol carbonate (CR-39). Unsaturated epoxides include, but are not limited to, glycidyl acrylate, glycidyl methacrylate, allyl glycidyl ether, and 1,2-epoxy-3-allyl propane.

Preferably, in one embodiment, the monomer is methacrylic acid.

Suitable cross-linking agents may be selected from: di-, tri- and tetrafunctional acrylates or methacrylates, divinylbenzene (DVB), alkylene glycol and polyalkylene glycol diacrylates and methacrylates, including ethylene glycol dimethacrylate (EGDMA or EDMA) and ethylene glycol diacrylate, vinyl or allyl acrylates or methacrylates, divinylbenzene, diallyldiglycol dicarbonate, diallyl maleate, diallyl fumarate, diallyl itaconate, vinyl esters such as divinyl oxalate, divinyl malonate, diallyl succinate, triallyl isocyanurate, the dimethacrylates or diacrylates of bis-phenol A or ethoxylated bis-phenol A, methylene or polymethylene bisacrylamide or bismethacrylamide, including hexamethylene bisacrylamide or hexamethylene bismethacrylamide, di(alkene) tertiary amines, trimethylol propane triacrylate, pentaerythritol tetraacrylate, divinyl ether, divinyl sulfone, diallyl phthalate, triallyl melamine, 2-isocyanatoethyl methacrylate, 2-isocyanatoethylacrylate, 3-isocyanatopropylacrylate, 1-methyl-L-2-isocyanatoethyl methacrylate, 1,1-dimethyl-2-isocyanaotoethyl acrylate, tetraethylene glycol diacrylate, tetraethylene glycol dimethacrylate, triethylene glycol diacrylate, triethylene glycol dimethacrylate, hexanediol dimethacrylate, hexanediol diacrylate, and the like.

Preferably, in one embodiment, the cross-linking agent is EDMA.

The monomer and cross-linking agent may be the same. Preferably however the monomer and cross-linking agent are different.

In an embodiment, the monomer is methacrylic acid and the cross-linking agent is EDMA.

The polymerising step is also conducted in the presence of at least one type of porogen which ensures a porous structure throughout the resultant MIP.

Porogens suitable for use in the process of the present invention include those that promote or facilitate hydrogen binding interactions and those that promote or facilitate hydrophobic interactions. Combinations of these types of porogens may also be used.

Porogens that facilitate hydrogen bond function include acetone, acetonitrile, chloroform, dichloromethane, dimethyl formamide (DMF) and acetate. The porogens may be typically utilised as mixtures with polar solvents such as ethanol, methanol or dimethyl sulfoxide (DMSO).

Porogens that facilitate hydrophobic interactions include aqueous mixtures of acetonitrile, acetone, ethyl acetate, DMF, ethanol, methanol, DMSO or combinations thereof.

The molecular template comprises a tetrahedral chemical moiety which is covalently bound to a pocket forming portion. The present inventors have discovered that template molecules which bear a tetrahedral chemical moiety function as effective mimics of the transition state of serine protease substrates and specifically substrates of trypsin. Preferably this tetrahedral chemical moiety is selected from:

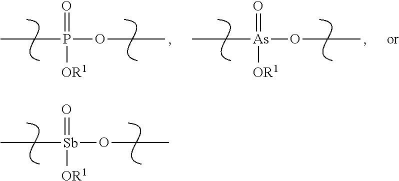

wherein R¹ is selected from hydrogen, or C₁-C₆ alkyl.

Preferably R¹ is a linear C₁-C₆ alkyl group.

In a preferred embodiment the tetrahedral chemical moiety is a tetrahedral phosphonate, and more preferably a phosphonate of formula:

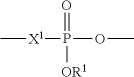

wherein:
R¹ is selected from hydrogen and C₁-C₂ alkyl; and
X¹ is selected from O, S, and optionally substituted alkylene (preferably C₁-C₃ alkylene).

The tetrahedral chemical moiety is covalently bound to the pocket forming portion of the molecular template. The pocket forming portion is suitably designed to allow for the accommodation of a substrate into the MIP. Accordingly, the pocket forming portion may be any suitable molecular scaffold which structurally mimics a desired amide and/or ester bearing substrate or at least the portion of the substrate which bears the amide group.

In relation to the second aspect, when the MIP mimics the catalytic activity of trypsin, the pocket forming portion is a molecular scaffold which structurally mimics the amino acid side chain of lysine or arginine. Accordingly, in a preferred aspect the pocket forming portion comprises an amino or guanidine moiety (or a protected form thereof).

In relation to both the first and second aspects of the present invention, in one embodiment the tetrahedral chemical moiety which is covalently bound to a pocket forming portion is represented by formula:

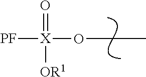

wherein:
X is selected from P, As, and Sb;
R¹ is selected from hydrogen and C₁-C₂ alkyl; and
PF is a pocket forming portion selected from optionally substituted alkyl, optionally protected amino, optionally protected guanidino, N-containing heterocycle, and N-containing heteroaryl.

Preferred optionally substituted alkyl groups for PF include:

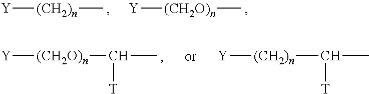

wherein:
n is selected from 0 to 6;
Y is selected from optionally protected amino, optionally protected guanidino, N-containing heterocycle, and N-containing heteroaryl; and
T is selected from optionally substituted C₁-C₃ alkyl, optionally substituted acylamino, optionally substituted oxyacylamino, optionally substituted aminoacyloxy, optionally substituted aminoacyl, optionally substituted oxyacyl, optionally substituted acyloxy, optionally substituted aminoacyloxy, optionally substituted acylamino, optionally substituted acyliminoxy, optionally substituted oxyacylimino, optionally substituted sulfinylamino, optionally substituted sulfonylamino, optionally substituted oxysulfinylamino, optionally substituted oxysulfronylamino and optionally substituted oxyacyloxy.

In an embodiment, n is selected from 0-4.

In a further embodiment, n is 4.

In a further embodiment, Y is amino or guanidino.

In a further embodiment, Y is amino or guanidino and n is 4.

In a further embodiment, Y is a N-containing heterocycle or N-containing heteroaryl which is capable of forming a hydrogen bond/ion pair with the functional monomer.

In another embodiment Y is selected from:

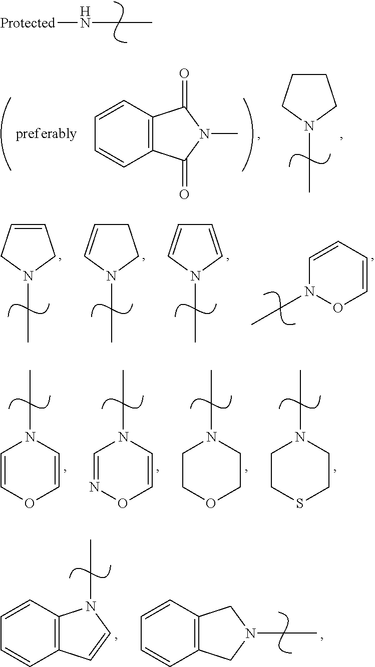

or
substituted derivatives thereof.

In a preferred embodiment the tetrahedral chemical moiety which is covalently bound to a pocket forming portion is represented by formula:

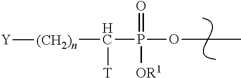

wherein:
n is selected from 0 to 6; (and preferably n is 0-4)
Y is selected from:

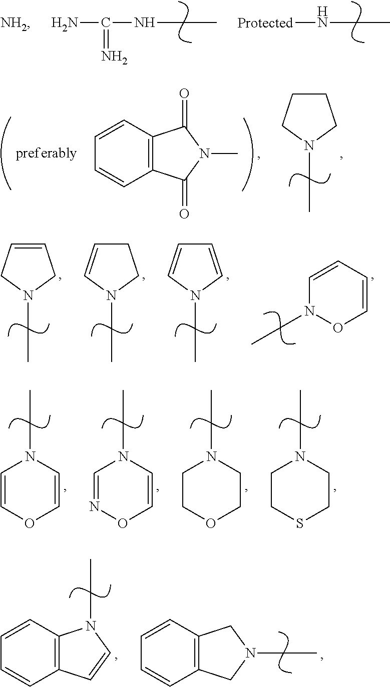

or
a substituted derivative thereof;
R¹ is selected from hydrogen and C₁-C₂ alkyl; and
T is selected from —NHC(X′)O—R², —OC(X′)O—R², —CR³R⁴R⁵, —CR³R⁴C(X′)O—R² and a peptide residue;
R² is selected from optionally substituted aryl, optionally substituted arylalkyl, optionally substituted heteroaryl, and optionally substituted heterocyclyl;
X′ is S or O;
R³ and R⁴ are independently selected from H and C₁-C₃ alkyl; and
R⁵ is selected from optionally substituted aryl or optionally substituted arylalkyl.

In a preferred embodiment:
n is selected from 0 to 4;
Y is selected from

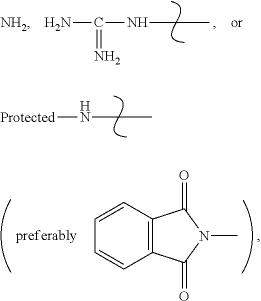

or
substituted derivatives thereof;
R¹ is methyl or ethyl;
T is —NHC(O)O—R²; and
R² is selected from optionally substituted aryl and optionally substituted arylalkyl.

In an even more preferred embodiment the tetrahedral chemical moiety which is covalently bound to a pocket forming portion is represented by formula:

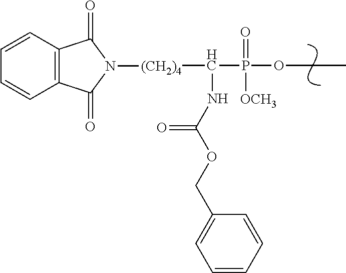

wherein the phenyl and/or phthalimido group may be further independently substituted with from 1 to 4 substituent groups.

Suitable substituent groups may include: C₁-C₃ alkyl, C₁-C₃ alkoxy, halogen, thio, nitro, aryl, aryloxy, and arylalkoxy.

Preferably, in the above embodiment, the phenyl and phthalimido groups are unsubstituted.

In another preferred embodiment, the molecular template comprises:
(a) a tetrahedral chemical moiety which is covalently bound to a pocket forming portion; and
(b) a histidine like portion (hip) which is covalently bound to a serine like portion (sip).

Accordingly, in a preferred embodiment, the molecular template is represented by formula (I)

Y-L-X—O—Z (I)

wherein;
Y is selected from optionally protected amino, optionally protected guanidine, N-containing heterocycle, and N-containing heteroaryl;
L represents a divalent Linking group selected from optionally substituted C₁-C₅ alkylene;
X is a tetrahedral chemical moiety wherein the tetrahedral atom is selected from phosphorus, arsenic, antimony, boron, silicon, sulphur or selenium; and
Z represents a residue of a serine like portion (rslp) which is covalently bound to a histidine like portion (hlp).

Accordingly, in a further aspect the present invention provides novel compounds of formula (I).

In relation to formula (I) compounds one or more of the following definitions may apply:
(a) X is selected from:

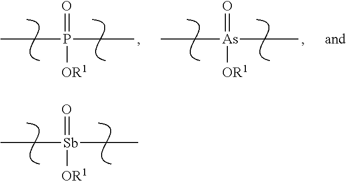

wherein R¹ is selected from hydrogen and C₁-C₂ alkyl;
(b) L is selected from:

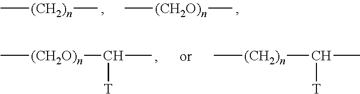

wherein:
   n is selected from 0 to 4; and
   T is selected from optionally substituted C₁-C₃ alkyl, optionally substituted oxyacylamino, optionally substituted aminoacyloxy, optionally substituted aminoacyl, optionally substituted oxyacyl, optionally substituted acyloxy, and optionally substituted oxyacyloxy.
(c) Y is selected from:

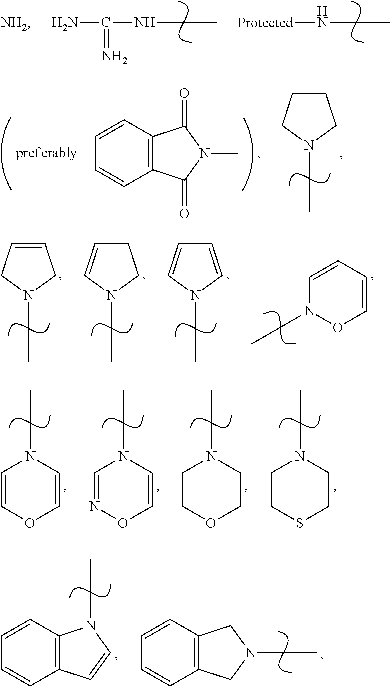

or
substituted derivatives thereof;

One or more of the following further definitions may apply along with any one of (a)-(c):
(d) X is:

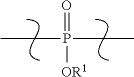

wherein R¹ is selected from hydrogen and C₁-C₂ alkyl;
(e) L is selected from:

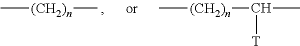

wherein:
   n is selected from 0 to 4; and
   T represents an optionally substituted oxyacylamino;
(f) Y is selected from:

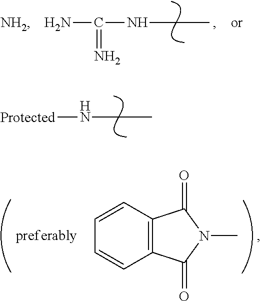

or derivatives thereof.

In relation to (e) above T is preferably —NHC(O)O—R² whereby R² is selected from optionally substituted arylalkyl, optionally substituted alkyl, optionally substituted cycloalkyl, optionally substituted heteroaryl, or optionally substituted heterocyclyl.

In an even more preferred embodiment:

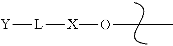

in formula (I) is represented by:

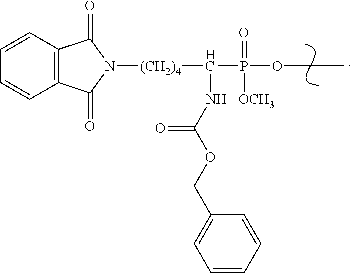

In relation to the above embodiments/definitions the serine like portion (slp) may be represented by any chemical moiety which conveys to the formed MIP a hydroxyl (—OH) group which is able to act as a nucleophile. Furthermore, the histidine like portion (14) may be represented by a chemical moiety which bears a nitrogen atom which is capable of accepting the hydrogen from the —OH group of the slp, thus activating the group to nucleophilic attack.

In an embodiment and with respect to the compounds of formula (I) the slp is represented by the —O—Z moiety which may be selected from:

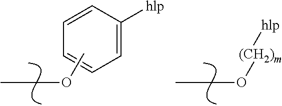

wherein m is an integer selected from 0-4.

Accordingly, from the above one will appreciate that in compounds of formula (I) the O atom attached to the Z forms part of the hydroxy group which is conveyed to the formed MIP which is able to act as a nucleophile. As such reference to a “residue” of a serine like portion (rslp) refers to a serine like portion (sip) excluding this O atom.

The hlp portion may be represented by:

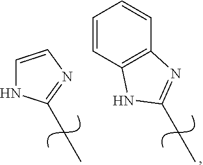

or
a substituted derivative thereof.

Accordingly, in relation to (a)-(f) above the further definition may apply:
(g) —O—Z together may represent:

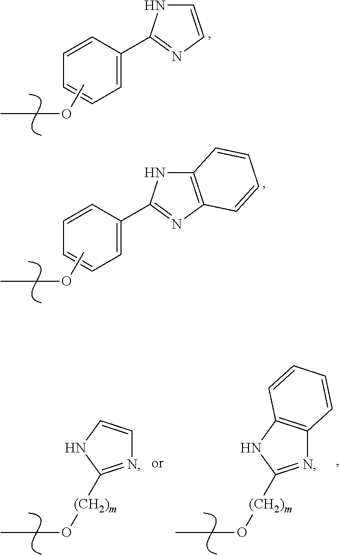

or
a substituted derivative thereof,
wherein m is an integer of 0-4.

In relation to (g) preferably —O—Z together represent:

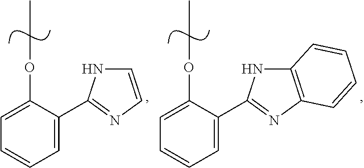

or
a substituted derivative thereof.

In a preferred embodiment, the hlp or slp bears a free-radical polymerisable group. Preferably the polymerisable group is an optionally substituted alkenyl.

Accordingly, in respect of (a)-(f) above the following further definitions may apply:
(h) —O—Z together may represent:

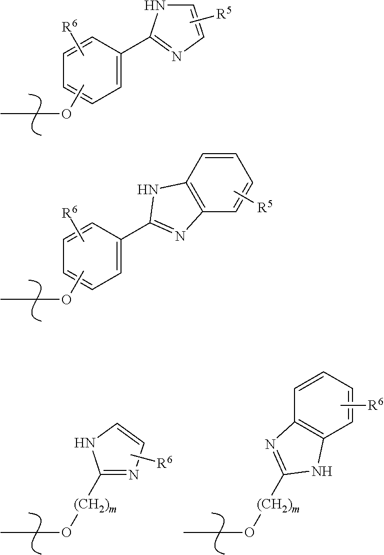

wherein:
   m is an integer of 0-4; and
   one of R⁵ and R⁶ is an optionally substituted alkenyl and the other is hydrogen.

Preferably the R⁶ group is an optionally substituted alkenyl and R⁵ is hydrogen.

In an even more preferred embodiment, R⁶ is ethenyl. Accordingly, in another embodiment the present invention contemplates that:
(i) —O—Z together may represent:

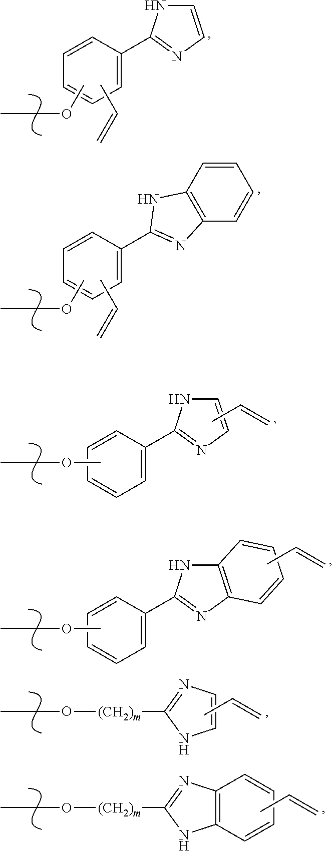

or
a substituted derivative thereof.

Preferably, —O—Z together may represent:
(j)

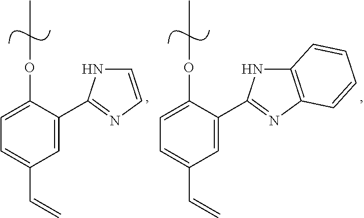

or
a substituted derivative thereof.

Accordingly, from the above it can be observed that in a preferred embodiment of the compounds of formula (I), Z represents a residue of a serine like portion (rslp), which is covalently bound to a histidine like portion (hip) wherein said hlp or slp (or rslp) bears a free-radical polymerisable group.

The template molecules of the present invention may be prepared by synthetic chemistry methodologies known in the art.

On a retrosynthetic analysis, the tetrahedral moiety may be thought of as a key intermediate or reactant building block. For instance, one may commence a synthesis by systematically building up the template from a suitably substituted tetrahedral molecule, for instance, esters of phosphates, arsonates, etc. Accordingly, suitable tetrahedral molecules may include: PO(OR′)₃, AsO(OR′)₃ or SbO(OR′)₃ where R′ may be a phenyl or lower alkyl group.

Various types of phosphate esters may be made by the reaction of phosphorus oxychloride (OPCl₃) with a multitude of alcohols, or by oxidation of various trialkyl phosphates.

For the production of compounds of formula (I), the electrophilic heteroatom (for example, P in a phosphate ester), may be reacted with a suitable nucleophile. Alternatively, standard coupling reactions, for instance under Mitsunobu reaction conditions, may also be employed. As a further alternative suitable deprotection in the presence of a base may lead to the production of a reactive phosphonium intermediate which then may be reacted with a suitably reactive electrophile, for example an alkylhalide, or acylhalide.

During the reactions described above a number of the moieties may need to be protected. Suitable protecting groups are well known in industry and have been described in many references such as Protecting Groups in Organic Synthesis, Greene T W, Wiley-Interscience, New York, 1981.

Other compounds of formula (I) and derivatives thereof can be prepared by the addition, removal or modification of existing substituents. This could be achieved by using standard techniques for functional group inter-conversion that are well known in the industry, such as those described in “Comprehensive organic transformations: a guide to functional group preparations” by Larock R. C., New York, VCH Publishers, Inc. 1989.

Examples of functional group inter-conversions are: —C(O)NR*R** from —CO₂CH₃ by heating with or without catalytic metal cyanide, e.g. NaCN, and HNR*R** in CH₃OH; —OC(O)R from —OH with e.g., ClC(O)R in pyridine; —NC(S)NR*R** from —NHR with an alkylisothiocyanate or thiocyanic acid; —NRC(O)OR* from —NHR with alkyl chloroformate; —NRC(O)NR*R** from —NHR by treatment with an isocyanate, e.g. HN═C═O or RN═C═O; —NRC(O)R* from —NHR by treatment with ClC(O)R* in pyridine; —C(═NR)NR*R** from —C(NR*R**)SR with H₃NR⁺OAc⁻ by heating in alcohol; —C(NR*R**)SR from —C(S)NR*R** with R—I in an inert solvent, e.g. acetone; —C(S)NR*R** (where R* or R** is not hydrogen) from —C(S)NH₂ with HNR*R**; —C(═NCN)—NR*R** from —C(═NR*R**)—SR with NH₂CN by heating in anhydrous alcohol, alternatively from —C(═NH)—NR*R** by treatment with BrCN and NaOEt in EtOH; —NR—C(═NCN)SR from —NHR* by treatment with (RS)₂C═NCN; —NR**SO₂R from —NHR* by treatment with ClSO₂R by heating in pyridine; —NR*C(S)R from —NR*C(O)R by treatment with Lawesson's reagent [2,4-bis(4-methoxyphenyl)-1,3,2,4-dithiadiphosphetane-2,4-disulfide]; —NRSO₂CF₃ from —NHR with triflic anhydride and base, —CH(NH₂)CHO from —CH(NH₂)C(O)OR* with Na(Hg) and HCl/EtOH; —CH₂C(O)OH from —C(O)OH by treatment with SOCl₂ then CH₂N₂ then H₂O/Ag₂O; —C(O)OH from —CH₂C(O)OCH₃ by treatment with PhMgX/HX then acetic anhydride then CrO₃; R—OC(O)R* from RC(O)R* by R**CO₃H; —CCH₂OH from —C(O)OR* with Na/R*OH; —CHCH₂ from —CH₂CH₂OH by the Chugaev reaction; —NH₂ from —C(O)OH by the Curtius reaction; —NH₂ from —C(O)NHOH with TsCl/base then H₂O; —CHC(O)CHR from —CHCHOHCHR by using the Dess-Martin Periodinane regent or CrO₃/aqH₂SO₄/acetone; —C₆H₅CHO from —C₆H₅CH₃ with CrO₂Cl₂; —CHO from —CN with 5 nCl₂/HCl; —CN from —C(O)NHR with PCl₅; —CH₂R from —C(O)R with N₂H₄/KOH.

In the preparation of compounds of formula (I) a preferred intermediate and molecular template is represented by formula (Ia):

Y-L-X—OH (Ia)

wherein variables Y, L, and X are as hereinbefore defined.

In a preferred embodiment the intermediate/template is a compound of formula

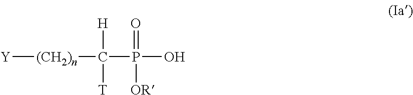

wherein variables Y, T, R′, and n are as hereinbefore defined.

The MIPs of the present invention can be prepared by two distinct approaches which are generally referred to as the covalent and non-covalent molecular imprinting.

In the first approach, the template molecule is covalently bound to a polymerisable group (preferably a free-radical polymerisable group), and after polymerisation, a covalent bond is cleaved to release the template molecule (or part thereof) from the polymeric mold. In the second approach, polymerisable monomers arrange themselves about the template molecule based on non-covalent interactions (such as ionic, steric, electrostatic, and hydrogen bonding interactions), and after polymerisation, the non-covalently bound template (or part thereof) is extracted.

In a preferred embodiment, the monomer is an ethylenically unsaturated carboxylic acid (or protected form thereof) such that the final MIP is endowed with at least one free-carboxylic acid group which is in relatively close proximity to the hlp. In such an arrangement, the free-carboxylic acid group of the monomer mimics the aspartic acid of the trypsin reactive triad.

In another embodiment, however, the template molecule itself may include a suitably positioned carboxylic acid group which is retained in the MIP once the template molecule is separated from the polymeric mold.

Preferably, the polymerising step is conducted under free-radical conditions however one skilled in the art would understand that monomers may be selected that are polymerisable cationically or anionically. In respect of possible free-radical conditions any UV or thermally active free-radical initiator may be employed. Examples of UV and thermal initiators include benzoyl peroxide, acetyl peroxide, lauryl peroxide, azobisisobutyronitrile (AIBN), t-butyl peracetate, cumyl peroxide, t-butyl peroxide, t-butyl hydroperoxide, bis(isopropyl)peroxy-dicarbonate, benzoin methyl ether, 2,2′-azobis(2,4-dimethylvaleronitrile), tertiarybutyl peroctoate, phthalic peroxide, diethoxyacetophenone, and tertiarybutyl peroxypivalate, diethoxyacetophenone, 1-hydroxycyclohexyl phenyl ketone, 2,2-dimethyoxy-2-phenyl-acetophenone, and phenothiazine, and diisopropylxanthogen disulfide.

The quality of recognition sites within MIPs of the present invention is a direct consequence of the nature and extent of the monomer-template interactions formed at the polymerisation stage. For this reason the preparation of MIPs of the present invention must take into account de novo certain specifications in order to obtain MIPs with enhanced catalytic activity. One such consideration is the determination of the preferred molar ratio between the template molecule and the monomer. In the non-covalent imprinting process, the number of stable complexes formed between the functional monomer and the template molecule prior to the polymerization is usually quite low. Therefore, the addition of an excess amount of monomers relative to template molecule in the non-covalent imprinting procedure is preferred in order to shift the reaction equilibrium towards the formation of a stable complex between the template and the functional monomers. Accordingly, in a preferred embodiment, the template:monomer molar ratio is 1:10.

However, the solubility of template molecule in porogenic solvents often limits the use of an excess amount of template molecule. In a non-covalent imprinting process, the preferred solvent to monomer (functional and cross-linking monomers) ratio to produce MIPs in the block polymer format is between 5:5 to 7:3. Therefore, the amount of template in solutions of a particular solvent to monomers ratio will be determined based on the maximum temple solubility. On the other hand, in covalent imprinting approach, the template is chemically bound to the polymerizable functional monomer. Therefore, the ratio of template to monomer in the covalent imprinting procedure is 1:1.

Also, one would appreciate that the physical nature of the MIPs (e.g. rigidity, etc.) will be dependent on the nature and quantity of the cross-linker. In one embodiment, the molar ratio range of monomer to cross-linker is about 1:2-1:10. The final and desired monomer to cross-linker ratio for a particular imprinting system is determined based on the morphological properties of the resultant polymers such as porosity, surface area, pore sizes, pore volume, etc, and their selectivity and loading capacity factors towards the template molecule as well. The determination of appropriate monomer to cross-linker ratio also partly relies on their solubilities in a particular porogenic solvent.

In an embodiment it is preferred to select a monomer:cross-linker ratio which enables the production of the MIPs as beads. The majority of work in the molecular imprinting field has relied on the production of polymers in macroporous block format, which are subsequently crushed, ground and sieved, either manually or mechanically. Very small particles are subsequently removed by differential sedimentation after suspension in a solvent. Moreover, grinding and sieving is a slow process, and produces irregular particles with rather limited control over particle size and shape. For these reasons, this is not an appropriate and preferred process for larger scale production. In contrast, direct production of imprinted polymer bead format is rapid and gives an almost quantitative yield of useable particles. Beads are also much more physically robust and are less prone to fragmentation and fines production during handling than sharp-edged crushed fragments. Further, production of beads offers some operational advantages, such as the ability to scale up UV initiated polymerisations, and to recover valuable template molecules for recycling due to the ease of particle recovery and washing. Beads are prepared by precipitation polymerization procedure at high dilution of porogen to monomer ratio, i.e. >19:1. Beads are also prepared by suspension polymerization in fluorocarbon liquids that are immiscible with water such as graft copolymers with a perfluorosulphonamidoethyl acrylate backbone and methoxypolyethylene glycol.

Separation of the template from a covalent MIP can be achieved by any means known to be suitable to those in the art. The means include, but are not limited to, acid hydrolysis, base hydrolysis, reduction (using NaBH₄ or LiAlH₄), washing with a weak acid (to remove metal co-ordination bonds) and thermal cleavage to remove a reversible urethane bond.

Accordingly in a further aspect the invention provides MIPs which are prepared by the processes described above.

In an embodiment the MIPs are characterised by cross-linked monomeric units comprising cavities which include:
(i) at least one hydroxyl moiety;
(ii) at least one imidazole moiety; and
(iii) at least one carboxyl moiety;
   on the surface of the cavities.

The at least one hydroxyl moiety may be selected from:

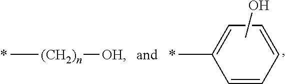

wherein n independently represents 0-4.

The at least one imidazole moiety may be selected from:

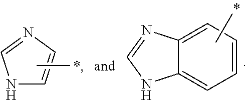

The at least one carboxyl moiety may be selected from:

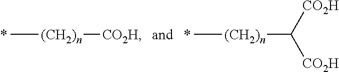

wherein each n independently represents 0-4.

Where * represents the attachment point on the surface of the cavity.

In a preferred embodiment the at least one hydroxyl moiety and at least one imidazole moiety are covalently bound, and are preferably represented by the formula (II):

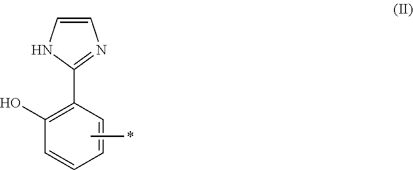

In a more preferred embodiment the at least one hydroxyl moiety and at least one imidazole moiety is represented by the formula (IIa):

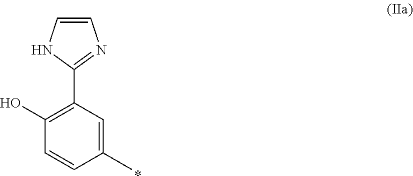

In a further embodiment the at least one hydroxyl moiety and at least one imidazole moiety is selected from (II) or (IIa) and the carboxyl moiety is spatially oriented as to affect a hydrogen bond interaction with the imidazole moiety.

### CHEMICAL DEFINITIONS

“Alkyl” refers to monovalent alkyl groups which may be straight chained or branched and preferably have from 1 to 10 carbon atoms or more preferably 1 to 6 carbon atoms. Examples of such alkyl groups include methyl, ethyl, n-propyl, iso-propyl, n-butyl, iso-butyl, n-hexyl, and the like.

“Alkylene” refers to divalent alkyl groups preferably having from 1 to 10 carbon atoms and more preferably 1 to 6 carbon atoms. Examples of such alkylene groups include methylene (—CH₂—), ethylene (—CH₂CH₂—), and the propylene isomers (e.g., —CH₂CH₂CH₂— and —CH(CH₃)CH₂—), and the like.

“Aryl” refers to an unsaturated aromatic carbocyclic group having a single ring (e.g. phenyl) or multiple condensed rings (e.g. naphthyl or anthryl), preferably having from 6 to 14 carbon atoms. Examples of aryl groups include phenyl, naphthyl and the like.

“Aryloxy” refers to the group aryl-O— wherein the aryl group is as described above.

“Arylalkyl” refers to -alkylene-aryl groups preferably having from 1 to 10 carbon atoms in the alkylene moiety and from 6 to 10 carbon atoms in the aryl moiety. Such arylalkyl groups are exemplified by benzyl, phenethyl and the like.

“Arylalkoxy” refers to the group arylalkyl-O— wherein the arylalkyl group are as described above. Such arylalkoxy groups are exemplified by benzyloxy and the like.

“Alkoxy” refers to the group alkyl-O— where the alkyl group is as described above. Examples include, methoxy, ethoxy, n-propoxy, iso-propoxy, n-butoxy, tert-butoxy, sec-butoxy, n-pentoxy, n-hexoxy, 1,2-dimethylbutoxy, and the like.

“Alkenyl” refers to a monovalent alkenyl group which may be straight chained or branched and preferably have from 2 to 10 carbon atoms and more preferably 2 to 6 carbon atoms and have at least 1 and preferably from 1-2, carbon to carbon, double bonds. Examples include ethenyl (—CH═CH₂), n-propenyl (—CH₂CH═CH₂), iso-propenyl (—C(CH₃)═CH₂), but-2-enyl (—CH₂CH═CHCH₃), and the like.

“Acyl” refers to groups H—C(O)—, alkyl-C(O)—, cycloalkyl-C(O)—, aryl-C(O)—, heteroaryl-C(O)— and heterocyclyl-C(O)—, where alkyl, cycloalkyl, aryl, heteroaryl and heterocyclyl are as described herein.

“Oxyacyl” refers to groups alkyl-OC(O)—, cycloalkyl-OC(O)—, aryl-OC(O)—, heteroaryl-OC(O)—, and heterocyclyl-OC(O)—, where alkyl, cycloalkyl, aryl, heteroaryl and heterocyclyl are as described herein.

“Amino” refers to the group —NR″R″ where each R″ is independently hydrogen, alkyl, cycloalkyl, aryl, heteroaryl, and heterocyclyl and where each of alkyl, cycloalkyl, aryl, heteroaryl and heterocyclyl is as described herein.

“Aminoacyl” refers to the group —C(O)NR″R″ where each R″ is independently hydrogen, alkyl, cycloalkyl, aryl, heteroaryl, and heterocyclyl and where each of alkyl, cycloalkyl, aryl, heteroaryl and heterocyclyl is as described herein.

“Acylamino” refers to the group —NR″C(O)R″ where each R″ is independently hydrogen, alkyl, cycloalkyl, aryl, heteroaryl and heterocyclyl and where each of alkyl, cycloalkyl, aryl, heteroaryl, and heterocyclyl are as described herein.

“Acyloxy” refers to the groups —OC(O)-alkyl, —OC(O)-aryl, —C(O)O-heteroaryl, and —C(O)O-heterocyclyl where alkyl, aryl, heteroaryl and heterocyclyl are as described herein.

“Aminoacyloxy” refers to the groups —OC(O)NR″-alkyl, —OC(O)NR″-aryl, —OC(O)NR″-heteroaryl, and —OC(O)NR″-heterocyclyl where R″ is independently hydrogen, alkyl, cycloalkyl, aryl, heteroaryl, and heterocyclyl and where each of alkyl, cycloalkyl, aryl, heteroaryl and heterocyclyl is as described herein.

“Oxyacylamino” refers to the groups —NR″C(O)O-alkyl, —NR″C(O)O-aryl, —NR″C(O)O-heteroaryl, and NR″C(O)O-heterocyclyl where R″ is independently hydrogen, alkyl, cycloalkyl, aryl, heteroaryl, and heterocyclyl and where each of alkyl, cycloalkyl, aryl, heteroaryl and heterocyclyl is as described herein.

“Oxyacyloxy” refers to the groups —OC(O)O-alkyl, —O—C(O)O-aryl, —OC(O)O-heteroaryl, and —OC(O)O-heterocyclyl where alkyl, cycloalkyl, aryl, heteroaryl, and heterocyclyl are as described herein.

“Acylimino” refers to the groups —C(NR″)—R″ where each R″ is independently hydrogen, alkyl, cycloalkyl, aryl, heteroaryl and heterocyclyl and where each of alkyl, cycloalkyl, aryl, heteroaryl, and heterocyclyl are as described herein.

“Acyliminoxy” refers to the groups —O—C(NR″)—R″ where each R″ is independently hydrogen, alkyl, cycloalkyl, aryl, heteroaryl and heterocyclyl and where each of alkyl, cycloalkyl, aryl, heteroaryl, and heterocyclyl are as described herein.

“Oxyacylimino” refers to the groups —C(NR″)—OR″ where each R″ is independently hydrogen, alkyl, cycloalkyl, aryl, heteroaryl and heterocyclyl and where each of alkyl, cycloalkyl, aryl, heteroaryl, and heterocyclyl are as described herein.

“Cycloalkyl” refers to cyclic alkyl groups having a single cyclic ring or multiple condensed rings, preferably incorporating 3 to 11 carbon atoms. Such cycloalkyl groups include, by way of example, single ring structures such as cyclopropyl, cyclobutyl, cyclopentyl, cyclohexyl, cyclooctyl, and the like, or multiple ring structures such as adamantanyl, indanyl, 1,2,3,4-tetrahydronapthalenyl and the like.

“Halo” or “halogen” refers to fluoro, chloro, bromo and iodo.

“Heteroaryl” refers to a monovalent aromatic heterocyclic group which fulfils the Hückel criteria for aromaticity (i.e. contains 4n+2π electrons) and preferably has from 2 to 10 carbon atoms and 1 to 4 heteroatoms selected from oxygen, nitrogen, selenium, and sulfur within the ring (and includes oxides of sulfur, selenium and nitrogen). Such heteroaryl groups can have a single ring (e.g. pyridyl, pyrrolyl or N-oxides thereof or furyl) or multiple condensed rings (e.g. indolizinyl, benzoimidazolyl, coumarinyl, quinolinyl, isoquinolinyl or benzothienyl). It will be understood that where, for instance, R₂ or R′ is an optionally substituted heteroaryl which has one or more ring heteroatoms, the heteroaryl group can be connected to the core molecule of the compounds of the present invention, through a C—C or C-heteroatom bond, in particular a C—N bond.

“Heterocyclyl” refers to a monovalent saturated or unsaturated group having a single ring or multiple condensed rings, preferably from 1 to 8 carbon atoms and from 1 to 4 hetero atoms selected from nitrogen, sulfur, oxygen, selenium or phosphorous within the ring. The most preferred heteroatom is nitrogen. It will be understood that where, for instance, R₂ or R′ is an optionally substituted heterocyclyl which has one or more ring heteroatoms, the heterocyclyl group can be connected to the core molecule of the compounds of the present invention, through a C—C or C-heteroatom bond, in particular a C—N bond.

Examples of heterocyclyl and heteroaryl groups include, but are not limited to, oxazole, pyrrole, imidazole, pyrazole, pyridine, pyrazine, pyrimidine, pyridazine, indolizine, isoindole, indole, indazole, purine, quinolizine, isoquinoline, quinoline, phthalazine, naphthylpyridine, quinoxaline, quinazoline, cinnoline, pteridine, carbazole, carboline, phenanthridine, acridine, phenanthroline, isothiazole, phenazine, isoxazole, isothiazole, phenoxazine, phenothiazine, imidazolidine, imidazoline, piperidine, piperazine, indoline, phthalimide, 1,2,3,4-tetrahydroisoquinoline, 4,5,6,7-tetrahydrobenzo[b]thiophene, thiazole, thiadiazoles, oxadiazole, oxatriazole, tetrazole, thiazolidine, thiophene, benzo[b]thiophene, morpholino, piperidinyl, pyrrolidine, tetrahydrofuranyl, triazole, and the like.

“Thio” refers to groups alkyl-S—, cycloalkyl-S—, aryl-S—, heteroaryl-S—, and heterocyclyl-S—, where alkyl, cycloalkyl, aryl, heteroaryl and heterocyclyl are as described herein.

“Sulfinylamino” refers to groups alkyl-S(O)—NR″—, cycloalkyl-S(O)—NR″—, aryl-S(O)—NR″—, heteroaryl-S(O)—NR″—, and heterocyclyl-S(O)—NR″—, where R″ is independently hydrogen, alkyl, cycloalkyl, aryl, heteroaryl, and heterocyclyl and where each of alkyl, cycloalkyl, aryl, heteroaryl and heterocyclyl is as described herein.

“Sulfonylamino” refers to groups alkyl-S(O)₂—NR″—, cycloalkyl-S(O)₂—NR″—, aryl-S(O)₂—NR″—, heteroaryl-S(O)₂—NR″—, and heterocyclyl-S(O)₂—NR″—, where R″ is independently hydrogen, alkyl, cycloalkyl, aryl, heteroaryl, and heterocyclyl and where each of alkyl, cycloalkyl, aryl, heteroaryl and heterocyclyl is as described herein.

“Oxysulfinylamino” refers to groups alkylO-S(O)—NR″—, cycloalkylO-S(O)—NR″—, arylO—S(O)—NR″—, heteroarylO-S(O)—NR″—, and heterocyclylO-S(O)—NR″—, where R″ is independently hydrogen, alkyl, cycloalkyl, aryl, heteroaryl, and heterocyclyl and where each of alkyl, cycloalkyl, aryl, heteroaryl and heterocyclyl is as described herein.

“Oxysulfonylamino” refers to groups alkylO-S(O)₂—NR″—, cycloalkylO-S(O)₂—NR″—, arylO—S(O)₂—NR″—, heteroarylO-S(O)₂—NR″—, and heterocyclylO-S(O)₂—NR″—, where R″ is independently hydrogen, alkyl, cycloalkyl, aryl, heteroaryl, and heterocyclyl and where each of alkyl, cycloalkyl, aryl, heteroaryl and heterocyclyl is as described herein.

In this specification “optionally substituted” is taken to mean that a group may or may not be further substituted or fused (so as to form a condensed polycyclic group) with one or more groups selected from hydroxyl, acyl, alkyl, alkoxy, alkenyl, alkenyloxy, alkynyl, alkynyloxy, amino, aminoacyl, thio, arylalkyl, arylalkoxy, aryl, aryloxy, carboxyl, acylamino, cyano, halogen, nitro, phosphono, sulfo, phosphorylamino, phosphinyl, heteroaryl, heteroaryloxy, heterocyclyl, heterocyclyloxy, oxyacyl, oxime, oxime ether, hydrazone, oxyacylamino, oxysulfonylamino, aminoacyloxy, trihalomethyl, trialkylsilyl, pentafluoroethyl, trifluoromethoxy, difluoromethoxy, trifluoromethanethio, trifluoroethenyl, mono- and di-alkylamino, mono- and di-(substituted alkyl)amino, mono- and di-arylamino, mono- and di-heteroarylamino, mono- and di-heterocyclyl amino, and unsymmetric di-substituted amines having different substituents selected from alkyl, aryl, heteroaryl and heterocyclyl, and the like, and may also include a bond to a solid support material, (for example, substituted onto a polymer resin). For instance, an “optionally substituted amino” group may include amino acid and peptide residues. In the case of optionally substituted alkoxy, the term “optionally substituted” may indicate that one or more saturated carbon atoms may be substituted for a heteroatom or heterogroup such as O, S, NH and the like. For example an optionally substituted alkoxy group could be represented by a group such as —O—CH₂CH₂—O—CH₂CH₂OH or polyethyleneglycols of other lengths.

The invention will now be described in the following Examples. The Examples are not to be construed as limiting the invention in any way.

### EXAMPLES

### 1) Synthesis of Templates

### A) Reportion of [Cbz-Lys(Pht)^{P}(OMe)(Ph-Im)] Template (1)

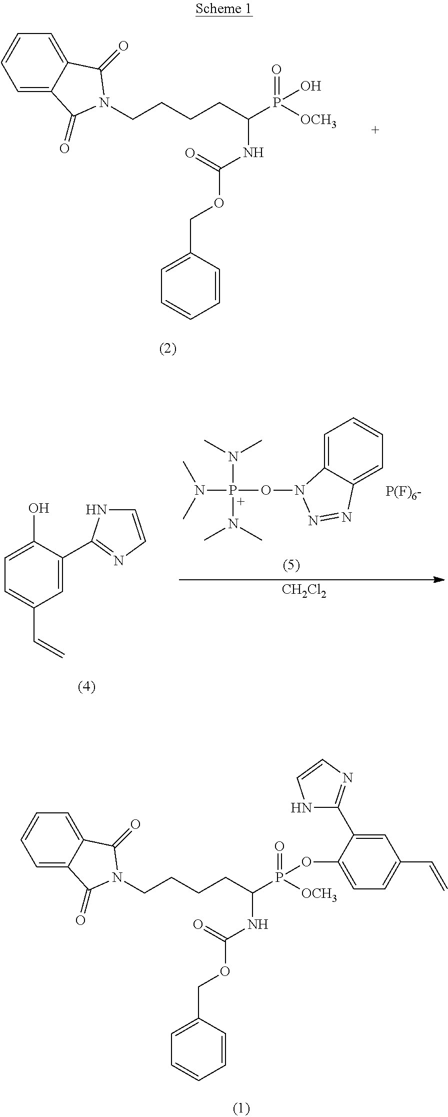

### (i) Synthesis of Cbz-Lys(Pht)^{P}(OMe)(OH) (2)

To obtain the desired target (1) compound, the primary step was the synthesis of the diphenyl-(1-(N-benzyloxycarbonylamino)-5-phthalimido)pentylphosphonate [Cbz-Lys(Pht)^{P}(OPh)₂] (12), which was achieved, as illustrated in Scheme 2. The preparation of Cbz-Lys(Pht)^{P}(OMe)(OH) (2) was achieved in a two-step synthesis with transesterification followed by partial monohydrolysis of the Cbz-Lys(Pht)^{P}(OPh)₂ (12) compound. The synthesis used the commercially available 5-amino-1-pentanol (6) and phthalic anhydride (7) as starting materials.

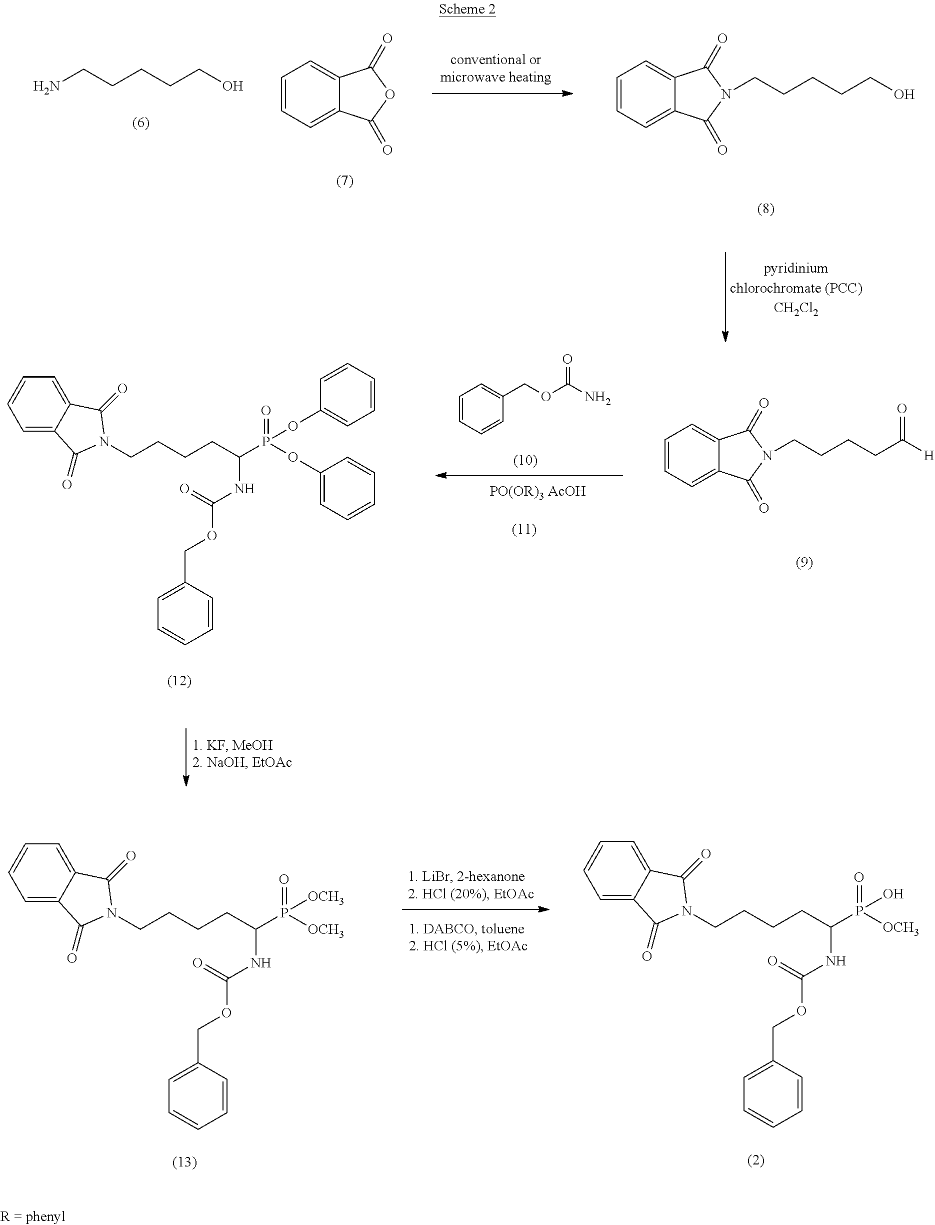

Compound (8) was synthesised by heating the starting materials (6) and (7) in microwave at 160° C. for 5 min resulting in 100% yield of the expected product (8) in high purity. After compound (8) was oxidised to its respective aldehyde derivative (9) with PCC, the production of Cbz-Lys(Pht)^{P}(OPh)₂ (12) was achieved using benzyl carbamate (10) triphenyl phosphite (11) in acetic acid (AcOH).

The transesterification of Cbz-Lys(Pht)^{P}(OPh)₂ (12) to its dimethyl phosphonate ester (13) was performed in the presence of potassium fluoride (KF) and methanol. This procedure involved adding the reagents and stirring at 23° C. overnight. After solvent evaporation and workup, the off-white crystals (13) were recrystallised from ethyl acetate and hexane, producing the desired product as white crystals in 88% yield. In the final step, the selective partial hydrolysis of (13) was achieved using lithium bromide (LiBr) in 2-butanone, produced the product (2) in 52% yield. However, the use of the mildly basic 1,4-diazabicyclo-[2.2.2.] octane (DABCO) for this selective partial hydrolysis enabled the reaction to proceed to produce (2) in 67% yield and high purity. As an alternative microwave-based synthetic approach, effective mono-hydrolysis of (13) was also achieved. This method not only reduced the reaction time extensively (from overnight at reflux using heat block to 30 min with microwave heating), but also improved product yield to 75%. Moreover, the use of DABCO in this procedure was advantageous, as it did not undergo any other side reactions involving the other protecting groups, as otherwise could be occurred if strong basic reagents were used (the phthalimido group is not compatible when refluxing with NaOH).

### (ii) Synthesis of the Polymerisable Group (4)

The synthesis of the 2-(2′-hydroxy-5′-ethenylphenyl)imidazole (4) that included the mimics of the serine (hydroxy) and histidine (imidazole) residues was achieved by new procedures, based in part on known synthetic reactions (6). The desired hygroscopic compound (4) produced in 4-steps synthesis using p-bromosalicylaldehyde and glyoxal(trimertetrahydrate) as starting materials was obtained as a light beige solid.

### (iii) Synthesis of the [Cbz-Lys(Pht)^{P}(OMe)(Ph-Im)] Template (1)

Different approaches and coupling agents, including diethyl azodicarboxylate (DEAD) with triphenylphosphine salt referred to as a Mitsunobu reaction (7-9), were used in the synthesis of the template (1). However, the coupling reaction performed using BOP (5) also afforded the desired product. The reaction was performed by stirring 1-equivalent addition of Cbz-Lys(Pht)^{P}(OMe)(OH) (2), 2-(2′-hydroxy-5′-ethenylphenyl)imidazole (4) and BOP (5) with 2-equivalents of triethylamine (TEA) in anhydrous dichloromethane (CH₂Cl₂) under nitrogen at 23° C. The coupling procedure is represented in Scheme 3.

An important aspect of the synthesis of (1) was shown to be the need for successive addition of the reagents. First the Cbz-Lys(Pht)^{P}(OMe)(OH) (2) was suspended in anhydrous CH₂Cl₂ at room temperature. To this, TEA was added in order to deprotonate the acid moiety of Cbz-Lys(Pht)^{P}(OMe)(OH) (2), producing a clear homogeneous solution (14). After adding BOP (5), the solution was stirred at room temperature for 15 min to allow the dissociation of the benzotriazolyl (15) ion from the BOP fragment, and consequently the phosphonium intermediate (16) to be achieved. Subsequently, when the 2-(2′-hydroxy-5′-ethenylphenyl)imidazole (4) dissolved in CH₂Cl₂ was added to the solution, the hexamethylphosphoramide (17) would subside from the phosphonium intermediate (16), while (4) esterified to produce the desired Cbz-Lys(Pht)^{P}(OMe)(Ph-Im) (1).

The progress of the reaction was monitored by HPLC, LC-ESI-MS and ESI-MS, which showed the desired Cbz-Lys(Pht)^{P}(OMe)(Ph-Im) (1) product, with the benzotriazolyl (15) ion and hexamethylphosphoramide (17) by-products with ink values as 629.2, 135.1 and 180.2 [M+H]⁺, respectively. Based on the HPLC analysis the reaction was terminated after 46 h, when no further change in the peak intensity was observed. The reaction carried out by this procedure was very effective, as the product conversion was detected within 1 h of reaction as assessed by HPLC and ESI-MS. Based on HR-MS and NMR assignment, the preparation of Cbz-Lys(Pht)^{P}(OMe) (Ph-Im) (1) in this study was confirmed. Since the compound Cbz-Lys(Pht)^{P}(OMe)(Ph-Im) (1) was found to be hygroscopic and unstable, it was used immediately in the next step of the polymerisation.

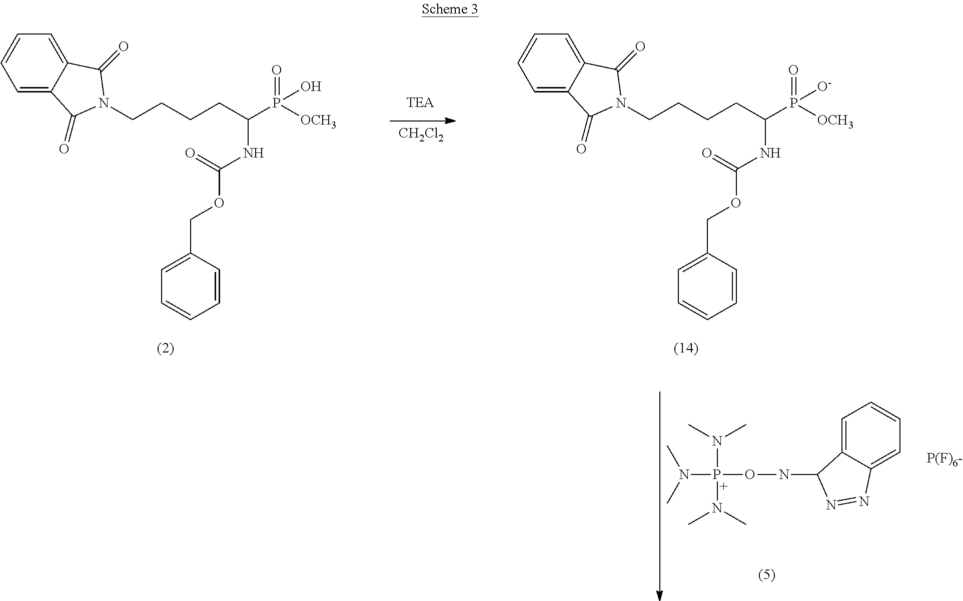

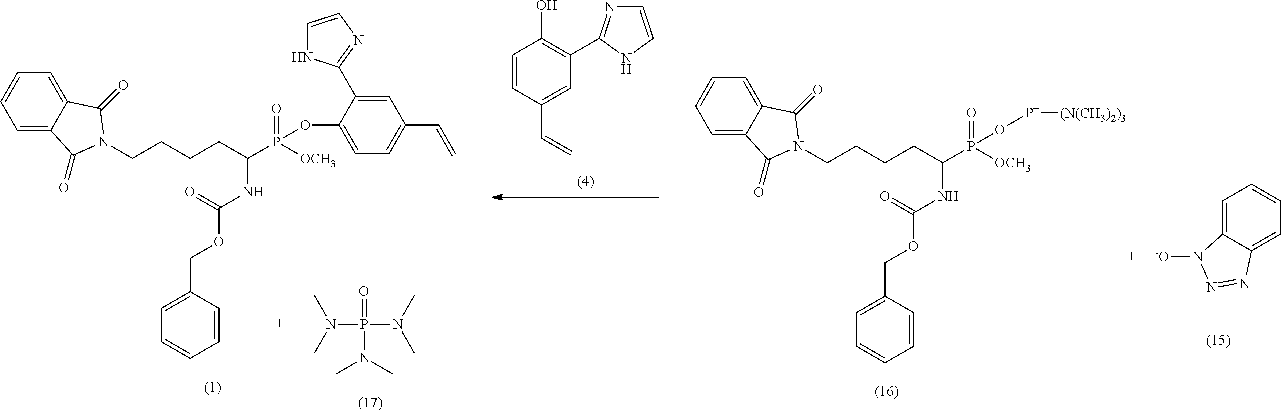

### (iv) Synthesis of [Cbz-Lys(Pht)-OH] (3)

The synthesis of Cbz-Lys(Pht)-OH (3), Scheme 4, was achieved with the amino protection method described for the preparation of the 5-phthalimido-1-pentanol (8). In this experiment, the commercially available (1-(N-benzyloxycarbonylamino)-5-amino)pentyl-carboxylic acid (18) and the phthalic anhydride (7) were mixed and heated at 150° C. for 5 min using a microwave instrument. The amorphous product Cbz-Lys(Pht)-OH (3) was obtained in 100% yield based on the elemental analysis and the NMR spectra.

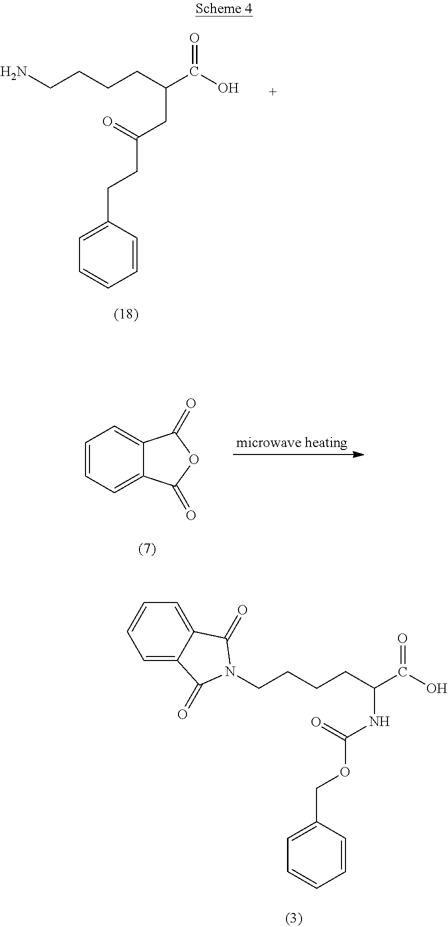

### 2) Synthesis of Polymers

The preparation of the polymers was achieved by both covalent and non-covalent imprinting procedures. In the covalent imprinting procedure, [Cbz-Lys(Pht)^{P}(OMe)(Ph-Im) (1) was used as a polymerisable template molecule, whilst Cbz-Lys(Pht)^{P}(OMe)(OH) (2) was used as the non-polymerisable template molecule in the non-covalent imprinting procedure. For the polymers prepared by the non-covalent procedure, a variety of different imprinting techniques were examined in order to produce catalytically efficient polymers.

Furthermore, to evaluate the effectiveness of the transition state analogues (TSAs) as templates for production of catalytically enhanced polymers, a ground state analogue (GSA) polymers was also synthesised, using the Cbz-Lys(Pht)-OH (3) compound as a template. Applying similar polymerisation techniques as used for the imprinted polymers, non-imprinted polymers without the presence of templates were prepared to be used as control polymers in the catalytic assessment of the imprinted polymers. Physical characterisation of the polymers in terms of morphology, surface area and porosity were investigated to evaluate the consequences of the use of specific imprinting templates, cross-linkers and porogens on the functionality and morphology of the resulting polymers.

### (i) Synthesis of the Polymerisable Transition State Phosphonate Analogue-Molecularly Imprinted Polymer (PTSPA-Imprinted Polymer) (22) Using the Template Cbz-Lys(Pht)^{P}(OMe)(Ph-Im) (1)

The synthesis of the PTSPA-imprinted polymer (22) was based on the catalytic triad (Asp-His-Ser) found in the enzyme trypsin. The preparation was performed by the covalent imprinting method, through a hydrogen bonded ion-pairing interaction between the polymerisable template Cbz-Lys(Pht)^{P}(OMe)(Ph-Im) (1) and the monomer methacrylic acid (MAA) (19), as shown in Scheme 5 (the zig zag lines represent the polymer chain unit).

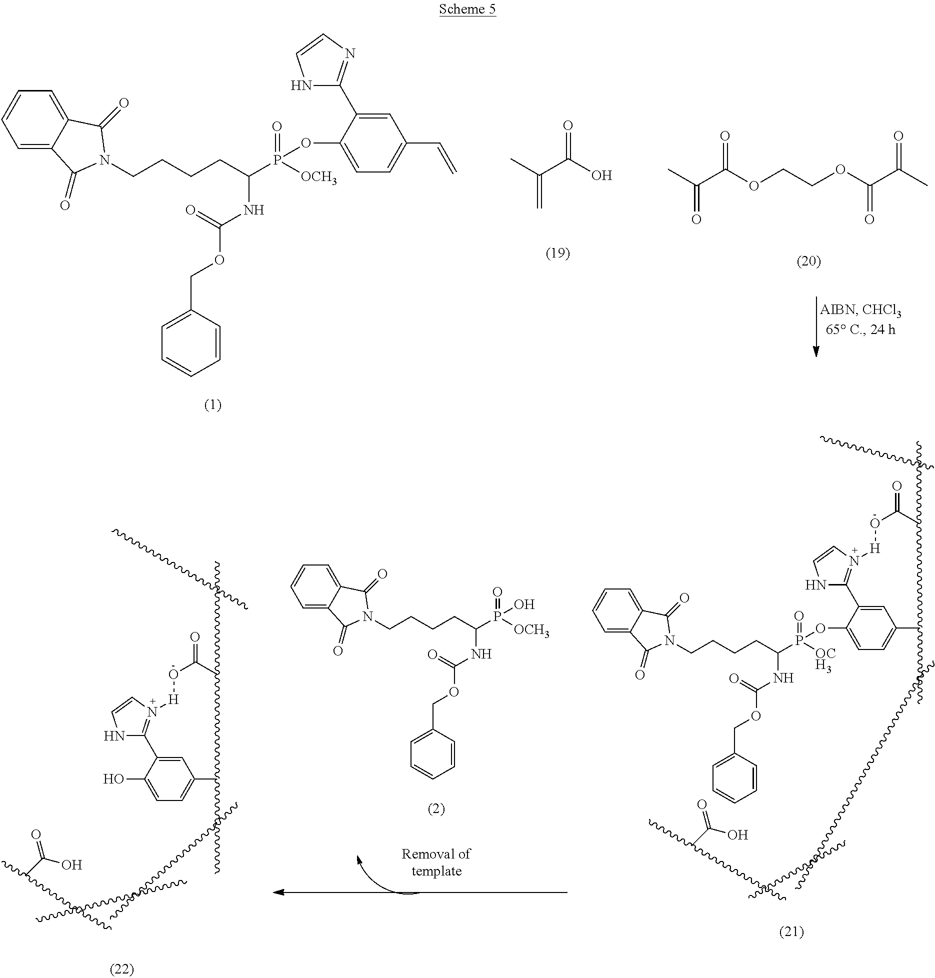

The polymerisation was carried out by adding the polymerisable template Cbz-Lys(Pht)^{P}(OMe)(Ph-Im) (1) to MAA (19) as a functional monomer and EDMA (20) as a cross-linker in chloroform (CHCl₃). After adding the initiator 2,2′-azoisobutyronitrile (AIBN), free radical polymerisation was initiated at 65° C. using a heat-block parallel synthesiser. Within 1 h of the reaction, small aggregates of polymer were formed, which progressed to a block monolithic polymer within 2 h. The reaction was continued for 24 h to ensure completion of the polymerisation. The imprinted polymer (21) was then crushed using mortar and pestle, followed by sieving of the resulting polymer particles. Particle sizes between 30-90 microns were obtained, and since the imprinting was carried out utilising the covalent imprinting technique, the polymer was subjected to extreme extraction conditions in order to cleave the esteric bond of phosphonate moiety of the PTSPA-imprinted polymer as Cbz-Lys(Pht)^{P}(OMe) (OH) (2). The extraction techniques included suspending the imprinted polymer in 100 mL of CHCl₃/CH₃OH (1:1, v/v) and stirring at 23° C. overnight, followed by soxhlet extraction in methanol for 24 h. In the subsequent extraction procedure the polymer was treated with 100 mL of 1 M NaOH/CH₃OH (1:1, v/v) with stirring at 60° C. for 24 h. The polymer was then washed with Milli-Q water until a neutral pH was obtained, followed by a rinse with CH₃OH, and air-dried. The PTSPA-imprinted polymer (22) prepared by this procedure contained all of the active amino acid mimics at a specific orientation within the polymer cavity, as shown in Scheme 5.

### (ii) Synthesis of the PTSPA-Non-Imprinted Polymer (PTSPA-Non-Imprinted Polymer) (26) Using N-benzoyl-2-(2′-benzoxy-5′-ethenylphenyl)imidazole (23) as a ‘Control’ Functional Template

Utilising the PTSPA-imprinted polymer (22) polymerisation technique, the preparation of the corresponding PTSPA-non-imprinted polymer (26) was achieved using N-benzoyl-2-(2′-benzoxy-5′-ethenyl phenyl)imidazole (23) as a ‘control’ functional template (i.e., no tetrahedral chemical moiety in template). The synthesis of the PTSPA-non-imprinted polymer was achieved as shown in Scheme 6.

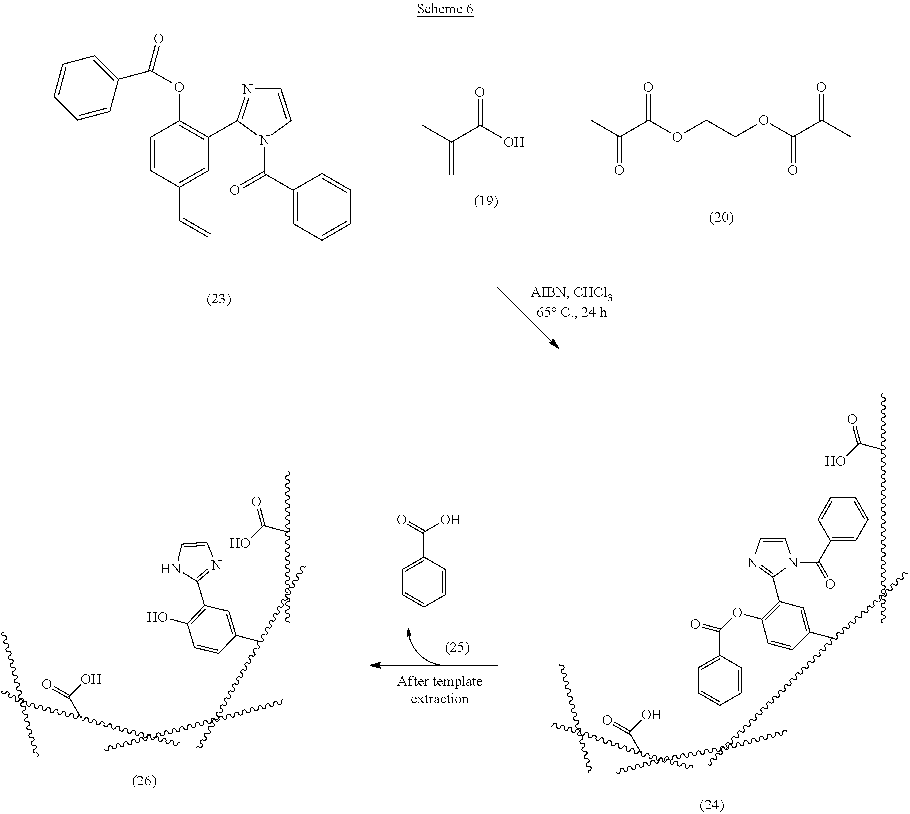

After imprinting, the block polymer (24) was crushed, ground, sieved and chemically treated to cleave the benzoyl group to produce the control PTSPA-non-imprinted polymer (26). The extraction process for this non-imprinted polymer was performed using similar technique as used for the PTSPA-imprinted polymer (21). Compound (23) was used as a control template for the preparation of the PTSPA-non-imprinted polymer (24), since it generated similar active groups (Asp-His-Ser) as found in the PTSPA-imprinted polymer (22). The imprinting effect that was established within the PTSPA-imprinted polymer (22) can specifically be determined during hydrolytic assay of the PTSPA-imprinted polymer (22) and -non-imprinted polymer (26).

### (iii) Synthesis of the Transition State Phosphonate Analogue-Molecularly Imprinted Polymer (TSPA-Imprinted Polymer) (30) Using the Template Cbz-Lys(Pht)^{P}(OMe)(OH) (2)

The synthesis of the TSPA-imprinted polymers (30) was performed utilising a non-covalent polymerisation approach. The template-monomer interaction during the imprinting process was assumed to be dominated by the hydrogen bonded ion-pairing interaction between the phosphoryl group of the template Cbz-Lys(Pht)^{P}(OMe)(OH) (2) and the nitrogen atom of the monomer 4-vinylimidazole (4-VI) (27), as outlined in Scheme 7. In this polymerisation, the cross-linker DVB (28) was initially used.

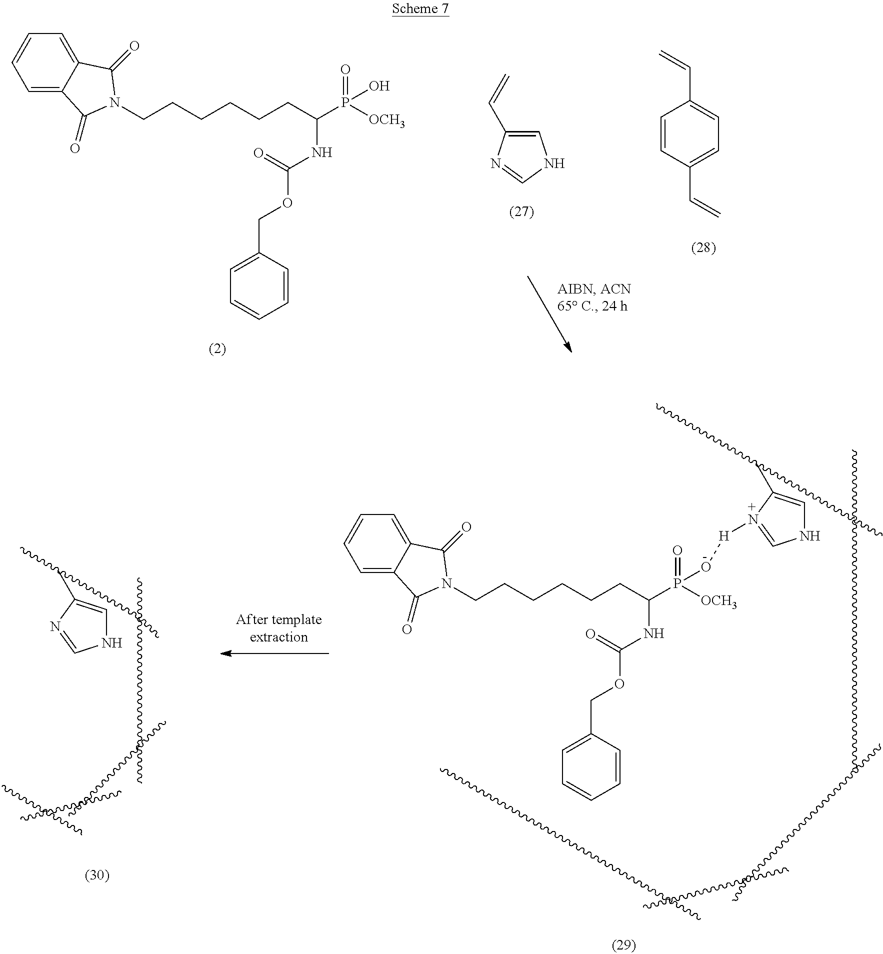

The imprinting process was carried out by adding the template Cbz-Lys(Pht)^{P}(OMe)(OH) (2) in acetonitrile (ACN) and stirring at 23° C. under nitrogen. Upon the addition of the monomer 4-VI (27), the suspended template Cbz-Lys(Pht)^{P}(OMe)(OH) (2) started dissolving, and a homogeneous solution was gradually formed. After overnight polymerisation at 65° C., the polymer particles obtained were washed with ACN, phosphate buffer (pH 10) and CH₃OH to remove the Cbz-Lys(Pht)^{P}(OMe)(OH) (2) template. Using the same imprinting technique, the corresponding TSPA-non-imprinted polymers were also prepared without the presence of the template molecule.

### (iv) Synthesis of the Ground State Carboxylic Acid Analogue-Molecularly Imprinted Polymer (GSCA-Imprinted Polymer) (32)

The GSCA-imprinted polymer (32) was prepared using EDMA (28) as cross-linker and 4-VI (27) as monomer, as the Scheme 8 depicts. The preparation of the GSCA-imprinted polymer (32) was carried out using similar imprinting techniques and ratios as used for the preparation of TSPA-5 imprinted polymers, as outlined in Table 1. Template extraction from this imprinted polymer (31) to produce the GSCA-imprinted polymer (32) was performed using similar extraction procedures as used for the TSPA-imprinted polymers.

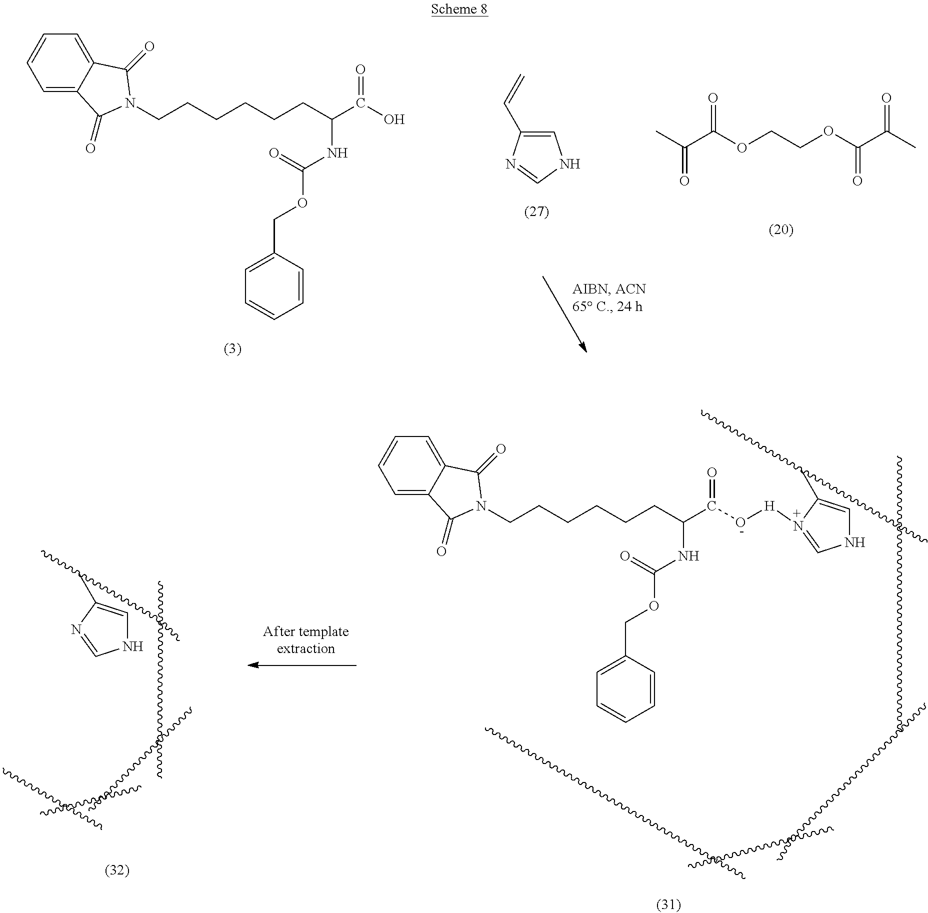

### Effect of Monomer/Cross-Linker Ratios

To study the effect of the cross-linker in the hydrolytic and the selectivity activities of the resulting polymers, various polymers were prepared by altering the composition of the cross-linker DVB (28) in the polymerisation process, as the listed ratios indicate in Table 1.

TABLE 1
The preparation of different TSPA polymers using a range of
ratios of the cross-linker (*CL) DVB to 4-VI (27) monomer.

| | | | | | Polymers |
|---|---|---|---|---|---|
| | Monomer | Template | *CL | Ratio | Con- |
| Entry | (mmol) | (mmol) | (mmol) | Monomer:CL | sistency |
| TSPA-1 | 1.50 | 0.15 | 3.00 | 1:2 | beads |
| TSPA-2 | 1.50 | 0.15 | 4.60 | 1:3 | beads |
| TSPA-3 | 1.50 | 0.15 | 7.50 | 1:5 | soft |
| | | | | | monolith |
| TSPA-4 | 1.50 | 0.15 | 13.50 | 1:9 | rigid |
| | | | | | monolith |
| **TSPA-5 | 1.50 | 0.15 | 13.50 | 1:9 | rigid |
| | | | | | monolith |
| | | | | | (softer |
| | | | | | than |
| | | | | | TSPA-4) |

**TSPA-5 was prepared using an EDMA cross-linker.

To study the effect of different cross-linkers in the hydrolytic and catalytic activities of the imprinted polymers, a TSPA-imprinted polymer was also synthesised using EDMA (20) as a cross-linker. To achieve the desired imprinted polymer technology, utilisation of an excess cross-linker in the polymerisation procedures was employed to lead to polymers with rigid physical properties. As a result, the physical property of the polymer in terms of stiffness was hypothesised to increase proportionally with the increasing quantity of the cross-linking agent used in the polymerisation process. In the present study, such physical differences among the resulting polymers have been documented. For instance, when a smaller amount of the cross-linker DVB (28) was used for the preparation of the TSPA-1 and -2 polymers, the resulting polymers were obtained as beads. This method is desirable, since it circumvented polymer milling that could lead to active site deformation. On the other hand, when the amount of the cross-linker DVB was increased such as for TSPA-3 and -4, the resulting polymers were obtained in a more compact or coalescing form, that required grinding.

It can also be noted that although the TSPA-3 polymers (imprinted and non-imprinted) were obtained as a block monolith, they were found to be less rigid in comparison to the TSPA-4 polymers. This was accredited to the lower amount of the cross-linker used. In terms of physical consistency of the resulting polymers, the use of EDMA (20) resulted in polymers (i.e. TSPA-5) with less rigidity than the use of DVB (28) (i.e. TSPA-4). Imprinted polymers produced with a certain degree of flexibility are desirable, since accessibility of the extracting solvents for efficient template removal can be facilitated. Furthermore, the permeation of analyte molecules in the polymer matrix during rebinding can be enhanced. Thus, the TSPA-5 imprinted polymer with its enhanced flexibility (less rigid than TSPA-4 when grinding) when prepared utilising EDMA (20) had the attributes of a more easily accessible catalyst than the TSPA-4 imprinted polymer, which was prepared using DVB (28) as a cross-linker.

### Extraction and Quantification of Templates

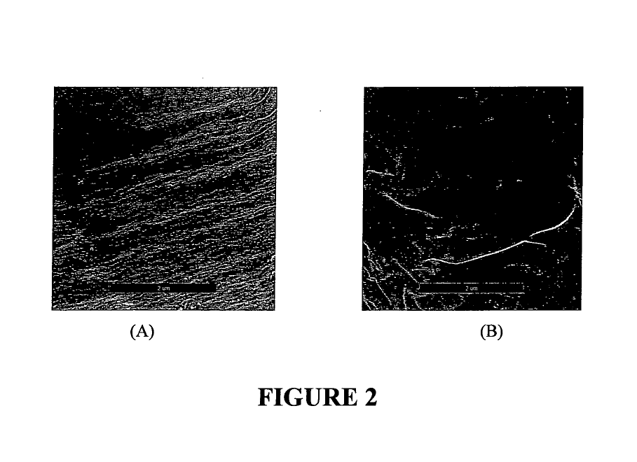

In order to determine the amount of templates extracted from the PTSPA-, TSPA- and GSCA-imprinted polymers, standard calibration curves were established using different concentrations of Cbz-Lys(Pht)^{P}(OMe)(OH) (2) and Cbz-Lys(Pht)-OH (3), as FIG. 2 shows. Standard samples of the template Cbz-Lys(Pht)^{P}(OMe)(OH) (2) and Cbz-Lys(Pht)-OH (3) were prepared using ACN/CH₃OH (9:1, v/v), and analysis was performed by high-performance liquid chromatography (HPLC). Since a high ratio of monomer to the template molecule was used in the synthesis of the imprinted polymers, it was assumed that the templates were quantitatively imprinted.

Template Extracted from the PTSPA-Imprinted Polymer

The percentages of extracted templates from the imprinted polymers are shown in Table 2. As the data show, >94% template removal was achieved for the PTSPA-imprinted polymer. The remaining proportion, such as 6% of template from PTSPA-imprinted polymer, suggests that a small ratio of the template was still bound to or completely embedded in the imprinted polymer and could not be removed under the template extraction methods applied. Effective template cleavage from PTSPA-imprinted polymer prepared by an ester linkage using a covalent imprinting approach was performed by aqueous base (NaOH) treatment of the imprinted polymer, with the highest template removal (>86%) achieved when the polymer was treated with NaOH/CH₃OH (1 M, 1:1, v/v).

TABLE 2
Extracted amounts of templates from various PTSPA-,
TSPA- and GSCA- imprinted polymers.

| Imprinted | Imprinted | Extracted template | Extracted template |
|---|---|---|---|
| polymer | template (mmol) | in (mmol) | in (%) of imprinted |
| *PTSPA | 1.270 | 1.200 | 94 |
| TSPA-1 | 0.150 | 0.122 | 81 |
| TSPA-2 | 0.150 | 0.115 | 77 |
| TSPA-3 | 0.150 | 0.089 | 59 |
| TSPA-4 | 0.150 | 0.083 | 55 |
| *TSPA-5 | 0.150 | 0.097 | 65 |
| *GSCA | 0.150 | 0.113 | 75 |

Extraction from PTSPA-imprinted polymer used CHCl₃/CH₃OH at 23° C., reflux in CH₃OH followed by NaOH (1M)/CH₃OH at 60° C. TSPA- and GSCA- imprinted polymers were extracted using ACN, phosphate buffer (pH 10) and CH₃OH at 23° C.
*EDMA prepared polymers.

Apart from the successful removal of the templates, the use of NaOH was also valuable as it facilitated the cleavage of the template appropriately at the ester-like bond of phosphonate moiety without affecting any other bonds. For instance, under acidic condition, the benzyloxycarbonyl (Cbz) group could easily be cleaved off, making the analysis and quantification of the cleaved template more difficult. Further analysis of the extracted cleaved template from the PTSPA-imprinted polymer with ESI-MS also proved the successful cleavage of the template at the expected bond, as the cleaved phosphonate moiety Cbz-Lys(Pht)^{P}(OMe)(OH) (2) was detected as m/z=459.2 [M−H].

Template Extraction from TSPA-Imprinted Polymers

Template extraction from the TSPA-imprinted polymers was also performed by various solvent treatments of the imprinted polymers. From the TSPA-imprinted polymer series, the maximum template removal obtained was 81 and 77% from the TSPA-1 and TSPA-2 imprinted polymers, respectively. When the DVB (28) quantity in TSPA-4 imprinted polymer increased by 4.5-fold in respect to the TSPA-1 imprinted polymer, the amount of the extracted template decreased to 55%. This reduction directly corresponded to the higher amount of the cross-linker used in the preparation of the polymer, as the physical properties of polymers were influenced by the amount of the cross-linker used during the polymerisation process.

The amount of template removed from the TSPA-imprinted polymers was also found to be dependent on the type of the solvents used in the extraction process. For instance, the amount of the template extracted from the TSPA-imprinted polymers was higher when methanol was used as an extracting solvent in comparison to either acetonitrile or phosphate buffer. One reason for the efficacy of methanol to remove more of the template molecule was the surprisingly higher swelling (opening of cavities) of the imprinted polymers in methanol, which enables the template to diffuse out of the polymer matrix effectively. Since the solubility of the template Cbz-Lys(Pht)^{P}(OMe)-(OH)] (2) in methanol was higher than in acetonitrile, this property may also explain the higher proportion of template removal from the TSPA-imprinted polymers by methanol. It is interesting to note that although the phosphate buffer used as a template extracting solvent was efficient to dissolve the template molecule, its ability to extract the template from the imprinted polymers was found to be less effective. The quantity of the template removed from the imprinted polymers prepared with the cross-linker EDMA (TSPA-5 imprinted polymer) was found to be higher in comparison to the amount removed from the DVB prepared TSPA-4 imprinted polymer. One reason for this difference could be due to differences in hydrophobicity of these polymers, with the cross-linker EDMA leading to better good wettability and rapid mass transfer. Furthermore, polymers prepared by the cross-linker EDMA showed higher swelling ability in comparison to polymers prepared by DVB cross-linker. As a consequence, the accessibility to the imprinted sites of the polymer to the solvent was higher.

Template Extraction from GSCA-Imprinted Polymers

In the case of the GSCA-imprinted polymer, ˜75% of the template was removed. Although the GSCA-imprinted polymer was prepared using a similar cross-linker composition and the same template extraction technique as used for the TSPA-5 imprinted polymer, the amount of the template extracted from the GSCA-imprinted polymer was 10% higher. Apart from the quantity of cross-linker used in the preparation of these imprinted polymers, the amount of template extract will be affected by the nature of chemical bond formed between the template and the polymer functionalities. The association constant between the template and the functional monomer plays a major role in determining the amount of the template extracted from the polymer. Phosphonic acids are significantly more acidic than their carboxylic acid counterparts. For this reason, the association constant of the phosphonic acid moiety of [Cbz-Lys(Pht)^{P}(OMe)(OH)] (2) and the monomer 4-VI (27) in the TSPA-imprinted polymer will be higher than the association constant of the carboxylic acid based Cbz-Lys (Pht)-OH (3) template for the 4-VI (27) monomer in the GSCA-imprinted polymer. The higher acidity of the phosphoryl moiety of [Cbz-Lys(Pht)^{P}(OMe)(OH)] (2) promoted stronger hydrogen bonded ion-pair interaction with the basic 4-VI (27) in comparison to the carboxylic acid moiety of Cbz-Lys(Pht)-OH (3) that formed in the GSCA-imprinted polymer could thus explain the higher percentage of template molecule removal from the GSCA-imprinted polymer in comparison to the TSPA-5 imprinted polymer.

### Characterisation of Polymers Using BET Surface Area and Porosimetry Analysis

The characterisation of the imprinted polymers was achieved by BET enables determination of the surface area and porosity. Imprinted polymers can be classified as macroporous polymers. The term macroporous was used to underline the fact that the polymers are porous, but not to imply detailed morphological properties in terms of pore size. Porous materials can, however, be categorised according to the characteristics of their pores as macro-, meso-, and microporous with pore size diameters ranging from >50 nm, 2-50 nm to <2 nm, respectively (11). Surface areas obtained for the prepared imprinted and non-imprinted polymers were found in the range of 134-308 and 179-301 m²/g, respectively, with an exception for the TSPA-4 polymers. Based on the size classification as explained above, the polymers were predominantly mesoporous. From the surface areas and pore volumes, a number of novel characteristics of the prepared polymers were found, as discussed below.

### The Effect of the Templates on the Morphological Properties of the Polymers

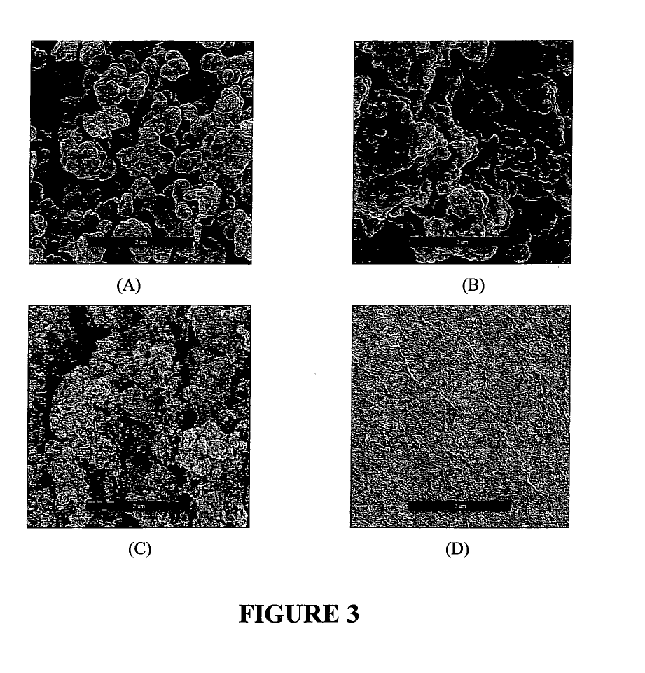

Based on the surface areas determination using BET analysis, the non-imprinted polymers prepared utilising EDMA (20) as a cross-linker were found to have a slightly higher surface area in comparison to their corresponding imprinted polymers. This result was reversed for the DVB based synthesised polymers, with the imprinted polymers showing higher surface areas than the corresponding non-imprinted polymers. In terms of pore volume, no distinctive differences between the imprinted polymers and non-imprinted polymers were found, as illustrated in Table 3 and FIG. 3.

TABLE 3
Surface areas and pore volumes of various imprinted polymers
and non-imprinted polymers obtained by BET analysis

| | | | Pore |
|---|---|---|---|
| | Monomer:*CL | Surface area | volume |
| Polymer | ratio | (m²/g) | (cm³/g) |
| PTSPA-imprinted polymer | 1:9** | 288.28 | 0.45 |
| PTSPA-non-imprinted polymer | 1:9** | 308.96 | 0.48 |
| TSPA-1 imprinted polymer | 1:2 | 221.55 | 0.58 |
| TSPA-1 non-imprinted polymer | 1:2 | 216.91 | 0.59 |
| TSPA-2 imprinted polymer | 1:3 | 220.51 | 0.57 |
| TSPA-2 non-imprinted polymer | 1:3 | 211.45 | 0.59 |
| TSPA-3 imprinted polymer | 1:5 | 179.16 | 0.26 |
| TSPA-3 non-imprinted polymer | 1:5 | 134.05 | 0.19 |
| TSPA-4 imprinted polymer | 1:9 | 24.02 | 0.02 |
| TSPA-4 non-imprinted polymer | 1:9 | 19.32 | 0.03 |
| TSPA-5 imprinted polymer | 1:9** | 287.79 | 0.51 |
| TSPA-5 imprinted polymer | 1:9** | 300.73 | 0.51 |
| GSCA-imprinted polymer | 1:9** | 300.92 | 0.58 |

*CL = cross-linker and
**= EDMA prepared polymers.

### The Effect of the Cross-Linker on the Morphological Properties of the Polymers

Beside the reaction temperature and the amount and type of porogens, the most effective variable to control the surface area and porosity of the imprinted polymers was the amount of the cross-linker used in the polymerisation process. The polymers prepared with the cross-linker EDMA (PTSPA, TSPA-5 and GSCA) documented that the amount of the cross-linking agent greatly affected the surface morphology with physical property having a higher surface area per gram of polymer in comparison to any of the polymers prepared using the cross-linker DVB. While the amount of EDMA used in the preparation of the PTSPA, TSPA-5 and GSCA polymers was significantly higher than the amount of DVB used in the preparation of the TSPA-1 and 2 polymers, the surface areas obtained for EDMA based polymers (i.e. PTSPA, TSPA 5 and GSCA) were found to be higher. Since the rigidity of the polymer was increased with the increasing amount of the cross-linker, both the surface area and pore volume can thus be more rationally altered.

With regard to the effect of the amount of cross-linker in the preparation of the TSPA polymers, the results showed that both the surface area and the pore volume decreased with increasing content of DVB in the TSPA-polymer preparation, as values for TSPA-1, TSPA-2, TSPA-3 and TSPA-4 show in FIG. 3 and Table 3. Therefore, the smaller the amount of the DVB used then the larger were the pore volumes and the higher the surface area of the derived polymers.

Furthermore, a relationship between the surface area and pore volume with that of the amount of template extracted from the TSPA based polymers was discovered. For instance, from polymers with a high surface area and pore volume, which were prepared utilising a low content of DVB (i.e. TSPA-1 and TSPA-2 imprinted polymers), a higher percentage of template could be removed in comparison to the imprinted polymer prepared with high content of DVB (i.e. TSPA-4 imprinted polymer) which possessed a lower surface area and a lower pore volume. For polymers prepared with EDMA (PTSPA, TSPA-5 and GSCA-imprinted polymer), a high portion of template removal was achieved. These EDMA based imprinted polymers were also shown to have a higher pore volume and large surface area. Thus, the higher surface areas obtained, in particular for the EDMA based imprinted polymers leads to a high proportion of template removal from these imprinted polymers due to a better accessibility to the imprinted sites by the extracting solvents.

### The Effect of the Type of Porogen on the Morphological Properties of the Polymers

No major pore volume differences between the chloroform-based polymers (PTSPA polymers) or ACN based prepared polymers (TSPA-5 polymers) were found.

### Characterisation of Polymers by SEM Analysis

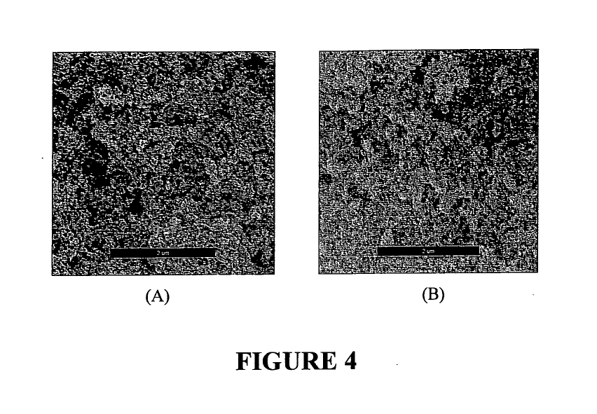

Electron microscopy in the SEM mode is a powerful procedure capable of producing high resolution images of the surface features of a sample. Based on the assessments of the SEM images, distinctive morphological differences of the polymers prepared as part of this invention were noted. As the SEM images in FIG. 4 show, the PTSPA-imprinted polymer seemed to have a rough surface compared to the respective non-imprinted polymer, which exhibited a relatively smoother surface. This difference between the polymers can be ascribed to the imprinting effect with the template.

In the case of the TSPA polymers, the SEM images revealed that the polymers were morphologically different to the PTSPA polymers. The surfaces of the PTSPA polymers appeared morphologically denser and smoother, whilst the TSPA polymers appeared to be composed of clustered or coagulated globular particles, as shown in FIGS. 5 and 6. A distinctive difference of the TSPA polymers was the increased polymer compactness with increasing DVB content in the polymers. As described above, increasing the cross-linker content has shown to decrease the surface areas of the TSPA polymers. This effect can be ascribed to the enhancement in the aggregation of the resulting polymer particles. From the SEM images in FIG. 5 it can be seen that the morphology of both the imprinted polymers and the non-imprinted polymers in terms of aggregation and compactness seem to increase when the DVB cross-linker content was increased. Therefore both, the BET and SEM findings were in agreement with respect to the impact of the various ratios of the cross-linker DVB in the different TSPA polymers.

With regard to the effect of the cross-linkers on the physical properties of the polymers, distinctive morphological differences in the SEM images were observed for TSPA-4 and TSPA-5 polymers that were prepared with DVB and EDMA cross-linkers, respectively. The TSPA-5 polymers appeared to be more porous than the TSPA-4 polymers as the SEM images in FIGS. 5 (III and IV) and 6 show. The polymers prepared with EDMA herein were less clustered and less dense, unlike the DVB based polymers. The cross-linker DVB is clearly much more hydrophobic in nature than the cross-linker EDMA. For this reason, the synthesised polymers were obtained with various degrees of swelling. The influence of the porogen on the morphology of the polymers prepared using the solvents ACN and hexane produce bead-like structures, whereas chlorinated solvents resulted in amorphous polymeric materials for both types of polymers (PTSPA and TSPA), e.g. the PTSPA polymer prepared with chloroform was obtained in an amorphous consistency, whereas the TSPA polymers, which were prepared with ACN as a solvent had bead-like characteristics.

### 3) Evaluation of Catalytic Activities of the Imprinted Polymers

The catalytic reaction performed by enzymes has hitherto been replicated using small chemical molecules as catalysts. Nitrophenyl esters were employed as substrates in the investigation with the new polymeric catalysis of the disclosed MIPS. The choice of the p-nitrophenyl ester substrates was due to its simplicity of identification and quantification of the expected product, p-nitrophenol (PNP). The hydrolytic activity assessment for the catalytic imprinted polymers was carried out using HPLC to detect the PNP.

An initial investigation was aimed to establish whether the synthesised imprinted polymers were able to hydrolyse a target p-nitrophenyl ester substrate. Furthermore, in an attempt to gain insights into the influence of the type and quantity of the cross-linkers on the hydrolytic efficiencies of the imprinted polymers, further hydrolytic activity studies were performed with imprinted polymers prepared by incorporating different types of cross-linkers. The hydrolytic assessment of the novel imprinted polymers, the PTSPA- and the TSPA-imprinted polymers, and the comparison with the hydrolytic activity of their corresponding non-imprinted polymers (as controls) was established using N-benzyloxycarbonyl-L-lysine p-nitrophenyl hydrochloride (Cbz-L-Lys-ONp.HCl) (33) as a substrate as Scheme 9 shows. The evaluation and confirmation of the expected product PNP (35) after incubating the substrate with various imprinted polymers or non-imprinted polymers, was achieved by HPLC and liquid-chromatography mass spectrometry (LC-MS), under the following criteria:
the ability of the polymers to capture the target substrate Cbz-L-Lys-ONp.HCl (33);
the potential to cleave (hydrolyse) the substrate (33), and
the ability to release the end products as shown in Scheme 9.

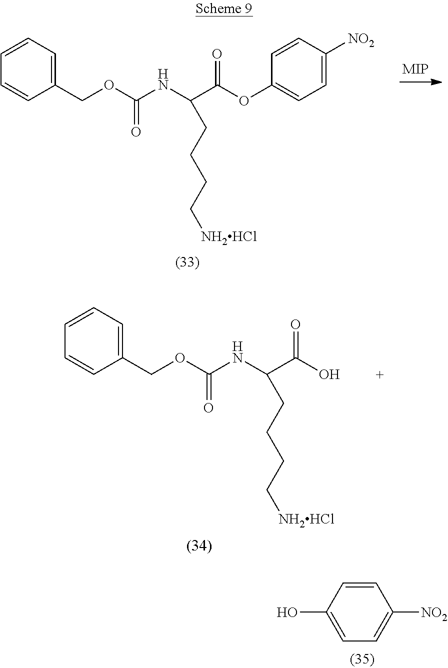

### Instrumentation

Although UV-visible spectrophotometry usually gives instant results in the analysis of a particular sample, a HPLC assay has certain advantages where sensitivity and the ability to analyse samples of microlitre volumes are necessary. However, a sample analysis performed by HPLC usually requires various prerequisites in order to increase the quality of separation and identification. A major factor that requires careful consideration in the sample analysis by the HPLC is the suitability of the eluting solvents and columns for the particular compounds to be analysed. Furthermore, elution of all analytes within a short time frame with good resolution is also critically important, in particular where time based identification and quantitative analysis of reactions are the main objectives. Since the assessment of the hydrolysis reaction was based on a time-course experiment, rapid elution with good resolution of the sample peaks was crucial and thus, the following HPLC operating conditions and parameters were found to be efficient and appropriate:

### General Procedure for the Evaluation of Hydrolytic Activity

Prior to adding the substrate Cbz-L-Lys-ONp.HCl (33) solution to the polymer (imprinted polymer or non imprinted polymers), the polymer particles were pre-conditioned (equilibrated) with acetonitrile for two reasons. The first reason was to remove any air pockets thus allowing full access of the substrate to the polymer network. The second reason was to remove any fine particles that might be present. After incubating the substrate Cbz-L-Lys-ONp.HCl (33) that was dissolved in 5 mL of ACN/CH₃OH (4.8:0.2, v/v) with the polymers, aliquots of the samples (100 μL) were then removed at different time intervals, subjected to centrifugation (Biofuge Heraeus, 10,000 rpm, 5 minutes) and hydrolysis assessment was carried out by injecting 10 μL of the supernatant into the HPLC. Since PNP (35) was one of the expected products in this study, it was used as a ‘reporter’. In most hydrolytic assays of ester substrates involving catalytic imprinted polymers, the phenol product has usually been chosen for detection monitoring rather than the acidic product. This is because PNP is a good leaving group (13), and thus it is expected to be released from the catalytic imprinted polymers without imposing any product inhibition (14). This conclusion was also confirmed in the present study, as the only cleaved product detected was PNP (35).

### Identification and Characterisation of Cleaved Product

As examples of hydrolytic activity evaluations based on HPLC chromatograms in FIG. 7 indicate, the product PNP (35) cleaved from the substrate Cbz-L-Lys-ONp.HCl (33) by the PTSPA polymers (imprinted polymers or non-imprinted polymers) was detected with the same retention time (2.69 min) as the reference PNP. This proved that the mobile phase and HPLC parameters used in this study were effective in the elution of the ‘reporter’ PNP (35) and the substrate Cbz-L-Lys-ONp.HCl (33) with satisfactory peak separation retention times, respectively. In terms of hydrolysis activity, the PTSPA-imprinted polymers showed a remarkable hydrolytic efficacy in comparison to the corresponding PTSPA-non-imprinted polymers.

As can be seen from the chromatographic profiles shown in FIG. 7, a large amount of substrate depletion occurred when the substrate was incubated with the PTSPA-imprinted polymers in comparison to that produced with the PTSPA-non-imprinted polymers. This result confirms that the cavities created within PTSPA-imprinted polymers accommodated the substrate Cbz-L-Lys-ONp.HCl (33) with exceptional fit, for the subsequent hydrolysis achieved successfully.

Although the non-imprinted polymers were prepared without a template present, chance events during the polymer assembly can bring a few of the functional groups into the necessary three-dimensional arrangement required for catalysis activity. A low level of substrate cleavage was thus noticed with the non-imprinted polymers (FIG. 7, N). Due to the chemical nature of the polymeric materials, non-specific adsorption sites will always be presented in the non-imprinted materials. In these cases, polymerisation is a random and kinetic process that occurs when the polymerising agents are added together. During the course of polymerisation to form the macromolecular architecture of the polymer, some of the functional groups in the monomer are brought together and may form unique structural arrangements. Since there is no control over the different ways in which the polymer chains arrange, many potential binding sites with various degrees of accessibility within the polymer matrix may form. The association constants of these binding sites within the non-imprinted polymers will vary with a few of these binding sites positioned in a way suitable for substrate cleavage. However, since these sites are non-specific for a particular analyte, non-imprinted polymers can bind and cleave substrates without being selective (i.e. shapes and sizes). The product PNP obtained by non-imprinted polymers is therefore the result of non-specific polymerisation with the hydrolytic activity governed by chance, due to the presence of some non-specific functional groups whose structural arrangement has happened allow binding and some cleaving of the substrate (33). This arrangement however leads to polymers having different kinetic properties (i.e. binding affinity and rate constants).

Apart from chromatographic evidence, further identification of the released PNP was also provided by comparison of the relevant UV spectra. As the UV spectra in FIG. 8 show, a good correlation between the spectra of the released product PNP (35) and the standard PNP analyte was achieved. Hydrolysis of Cbz-L-Lys-ONp.HCl (33) with the imprinted polymers was achieved success-fully. In a related hydrolytic activity evaluation conducted with the LC-MS, successful hydrolytic cleavage of the substrate Cbz-L-Lys-ONp.HCl (33) with the PTSPA-imprinted polymers was found. As the total ion chromatogram (TIC) in FIG. 9a (I) shows, the product PNP (35) and the remaining substrate Cbz-L-Lys-ONp.HCl (33) were detected. From the chromatogram (I) it can be seen that the substrate and cleaved PNP eluted at 8.25 and 8.60 min, respectively. The product PNP eluted with similar time window with that of the reference PNP (8.38 min), as shown in chromatogram (II).

The corresponding MS spectra of the TIC peaks also showed the expected molecular masses of 138.15 [M−H]⁻ and 402.26 [M+H]⁺ for both, the product PNP (35) and the remaining substrate Cbz-L-Lys-ONp.HCl (33), respectively, as shown in FIG. 9b (I) and (II). Furthermore, UV spectrum of the cleaved PNP (III) is obtained with similar constituent as the reference PNP (IV). Thus, from these analyses, the identity of the released product PNP (35) with the reference PNP based on retention time, MS and UV spectral results has been ascertained, and the capability of the PTSPA-imprinted polymers to hydrolyse the substrate Cbz-L-Lys-ONp.HCl (33) demonstrated successfully.

### Evaluation of the Imprinting Effect of the PTSPA-Imprinted Polymers

The hydrolytic activity assessment was performed at different time intervals (between 15 s and 30 min), after the substrate was incubated with different imprinted polymers and non-imprinted polymers. A typical example of the hydrolytic activity evaluation is shown in FIG. 10. The amount of released PNP (35) when the substrate Cbz-L-Lys-ONp.HCl (33) was incubated with the PTSPA-imprinted polymers is evidently higher than the amount obtained with the PTSPA-non-imprinted polymers.

From FIG. 10, it is evident that the conversion of the substrate to product achieved by the PTSPA-imprinted polymers was very rapid, with the majority of the cleaved product PNP (35) obtained within 15 s of imprinted polymer-substrate interaction. In contrast, for the PTSPA-non-imprinted polymers, only minor hydrolytic activity was detected even when the incubation time was extended to 30 min. Therefore, the rapid and the remarkable catalytic efficiency obtained for the PTSPA-imprinted polymers has unequivocally demonstrated the benefit of the compound (I) as a suitable template in the synthesis of the PTSPA-imprinted polymers.

Although the hydrolytic reaction was monitored for 30 min, the amount of additional PNP (35) produced by the imprinted polymers after the initial 15 s was minor, as the plateau in the graph shows. A possible reason for this could be the saturation of accessible active sites in the imprinted polymers, with most of the sites already occupied in the first 15 s of incubation. Hence, a saturation of the imprinted polymers was reached with very rapid kinetics. Such effects can be attributed to the fast saturation of the PTSPA-imprinted polymer in this study.

The observed hydrolytic activity of the imprinted polymers (both PTSPA and TSPA) showed a catalytic process comparable to the native proteolytic enzyme. Reactions performed by proteolytic enzymes are known to be very rapid when hydrolysing the target substrate. Additionally, when the amount of the initially released product was plotted against the reaction time, a straight line, which is referred to as an initial outburst, was obtained during the initial reaction. When the enzymes reach a stable catalytic rate also known as a steady-state rate, the shape of the graph becomes rectangular hyperbolic. This is observed in the plot obtained for the product PNP (35) in FIG. 10. Thus, the imprinted polymers were proficient in producing typical catalytic features that are observed for trypsin. From the data, it was possible to determine the rate of catalysis, the amount of released product and also the affinity of the imprinted polymers for the substrate.

### Michaelis-Menten Kinetics Used for Data Interpretation

As a major part of enzymology, the rate of chemical reactions, performed by enzymes, can be determined from the kinetics, by using a Michaelis-Menten plot. Since the imprinted polymers as exemplars of the new approach, based on transition state analogues as templates, were prepared to imitate the enzymatic activity of trypsin, it was necessary to apply the Michaelis-Menten plot to derive the related kinetic parameters for the released product PNP (35), and to characterise the imprinted polymers' binding efficiency for the substrate Cbz-L-Lys-ONp.HCl (33). From the Michaelis-Menten plot, the overall catalytic activities of the imprinted polymers can be determined using the following kinetics parameters:
the maximum catalytic rate (Vₘₐₓ) refers to the maximum rate of hydrolysis of a substrate compound by the polymer, and is expressed in μmol/mL/min;
the Michaelis-Menten constant (Kₘ) represents the concentration of the substrate when the Vₘₐₓ value is half maximal. Thus, under this condition (Vₘₐₓ/2), half of the catalyst is complexed with substrate and the observed reaction rate is half of the maximum possible rate. The affinity of a receptor to substrate is commonly described by association or binding constant (Kₐ). By correlating Kₘ with Kₐ, the affinity of the catalyst for substrate can be determined. By definition, the dissociation constant (K_{d}) is the analogue for Kₘ (15). Kₐ is the reverse process of K_{d}, and is expressed as 1/K_{d}. Since K_{d} is approximately similar to Kₘ, the same rule can be applied (Kₐ=1/Kₘ). Although a lower Kₘ value denotes a higher binding affinity, it is important to note that, it is distinctively different from Kₐ, since Kₘ is also a measure of how well the enzyme performs its reaction after ES has formed. Kinetic constants that indicate how fast a catalyst interacts with the substrate can be described by kₒₙ for Kₐ and k_{off} for K_{d}. Since Kₐ is kₒₙ/k_{off}, a high Kₐ indicates fast polymer-substrate interaction;
the turnover number (k_{cat}) represents the maximum number of the substrate molecules converted into product per time unit per unit polymer, which will be expressed in μmol/mL/min/mg of polymer in this study, and finally
the efficiency (k_{cat}/Kₘ) of the polymer to carry out the hydrolysis reaction and allows to determine how rapidly the polymer performs its catalytic activity. The k_{cat}/Kₘ also denotes the overall specificity or preference of the imprinted polymer for different substrates.

### Kinetics of Hydrolysis by the PTSPA and TSPA-Imprinted Polymers

In order to quantify the amount of released PNP product during incubation of Cbz-L-Lys-ONp.HCl (33) with different imprinted polymers and non-imprinted polymers in an appropriate measuring unit (i.e. μmol/mL), a standard calibration curve as shown in FIG. 11 was plotted using a PNP standard. Spontaneous hydrolysis of the substrate Cbz-L-Lys-ONp.HCl (33) in the absence of any polymer was neglected in this investigation, since in most cases no formation of the product PNP (35) was detected, even after an extended time (i.e. >100 days).

### Catalytic Activity of the PTSPA-Imprinted Polymer

The catalytic activities of all polymers were investigated using 4 different concentrations (1, 2, 3 and 4 μmol/mL) of the substrate Cbz-L-Lys-ONp.HCl (33). Michaelis-Menten plots constructed for the released product PNP (35) after hydrolysis of (33) with the PTSPA-imprinted polymers and non-imprinted polymers are shown in FIG. 12. From the plots the catalytic rate of the PTSPA imprinted polymers is notably higher compared to the PTSPA non-imprinted polymers at both 23° C. (I) and 37° C. (II). Thus, this result is an indication that functional cavities created within this imprinted polymers were highly competent in hydrolysing the substrate Cbz-L-Lys-ONp.HCl (33).

The kinetic values obtained for the PTSPA polymers are shown in Table 4. From these data, the efficacy of the PTSPA-imprinted polymer in the hydrolysis of the substrate Cbz-L-Lys-ONp.HCl (33) at both temperatures was evidently better than the comparative non-imprinted polymer as indicated by Vₘₐₓ, Kₘ, Kₐ, k_{cat} and k_{cat}/Kₘ values. At 23° C., the Vₘₐₓ value for the PTSPA-imprinted polymer was more than 14-fold higher than the PTSPA-non-imprinted polymer. Furthermore, the 5-fold higher Kₐ (high binding affinity) of the PTSPA-imprinted polymer compared to the PTSPA-non-imprinted polymer ascertained that the binding cavities within the PTSPA-imprinted polymer were far more capable of binding the substrate. In a parallel catalytic activity analysis at 37° C., similar catalytic trends were found, as the Vₘₐₓ of the PTSPA-imprinted polymer was obtained in 9-fold higher and Kₐ 3-fold higher than the corresponding non-imprinted polymer. It is apparent from Kₘ values that the imprinted polymer-substrate equilibration and hence high Kₐ was reached at a noticeably lower substrate concentration. Therefore, the binding strength of this imprinted polymer to the substrate molecule was significantly higher than the non-imprinted polymer. Moreover, high Kₐ and hence high kₒₙ achieved by this imprinted polymer verifies the competency of this polymer in binding the substrate at a faster rate compared to its non-imprinted polymer.

TABLE 4
Kinetic evaluation of the hydrolysis of Cbz-L-Lys-ONp.HCl (33)
with PTSPA-imprinted polymer and non-imprinted polymer at
23° C. and 37° C.

| | | | | k_{cat} × | k_{cat}/Kₘ × |
|---|---|---|---|---|---|
| | Vₘₐₓ | | | 10⁻³ | 10⁻³ (μmol/ |
| | (μmol/ | Kₘ | Kₐ | mL/min/ | (min/mg |
| | mL/ | (μmol/ | (μmol/ | mg of | of |
| Polymers | min) | mL) | mL)⁻¹ | polymer) | polymer) |
| PTSPA-imprinted | 2.92 | 0.59 | 1.70 | 58.40 | 98.98 |
| 23° C. | | | | | |
| PTSPA-non- | 0.20 | 3.00 | 0.33 | 4.00 | 1.33 |
| imprinted 23 | | | | | |
| PTSPA-imprinted | 3.63 | 0.73 | 1.37 | 72.60 | 99.45 |
| 37° C. | | | | | |
| PTSPA-non- | 0.40 | 2.21 | 0.45 | 8.00 | 3.62 |
| imprinted 37 | | | | | |

Note:
As described above, the maximum catalytic rate (Vₘₐₓ) is reached when the enzyme is fully saturated with the substrate. The plots and calculated kinetic values in this study are obtained using a subroutine of the software program GraphPad Prism. For a number of polymers, some values of the Vₘₐₓ specified in the tables are reached at substrate concentrations that fall outside the plotted [S] values. Hence, all the values in the tables were obtained from curve fitting procedures, since these values are far more accurate for the kinetic property characterisation of the polymers than any graphically determined values.

The k_{cat} values directly correlated with the values of Vₘₐₓ, since the aptitude of the polymers to convert the substrate to product is based on the values of Vₘₐₓ per amount of polymers used in the hydrolysis study. As a result, the product turnover (k_{cat}) ability of the PTSPA-imprinted polymer at both, 23° C. and 37° C. was more than 14- and 9-fold higher than the non-imprinted polymer, respectively.

The k_{cat}/Kₘ of the PTSPA-imprinted polymer was obtained 74-fold higher than the non-imprinted polymer at 23° C., whereas this value was 27-fold higher (PTSPA-imprinted polymer over -non-imprinted polymer) when the reaction was performed at 37° C. These results are an additional confirmation illustrating the exceptional catalytic efficiency of these new classes of imprinted polymers to convert the substrate into the desired products. Catalysis activity involving enzymes is known to be affected when reactions are carried out under different temperature conditions. Based on this principle, the performance of hydrolysis activity with the polymers at 37° C., however, shown to reduce the catalysis ability of the imprinted polymer, as verified from the ratio (PTSPA-imprinted polymer/PTSPA-non-imprinted polymer) of Vₘₐₓ in FIG. 13. The catalytic rate at 23° C. was more than 1.6-fold larger than at 37° C. Hence, this result suggested that the use of heat might have distorted some of the functional binding groups in the active sites.

From the perspective of hydrolytic efficiency evaluated by the ratio (PTSPA-imprinted polymer/PTSPA-non-imprinted polymer) of k_{cat}/Kₘ, the hydrolytic performance of the PTSPA-imprinted polymer at 23° C. was also found to be 2.7 times more effective than at 37° C. Thus, based on these catalytic rate evaluations, the hydrolytic activity assessment with the remaining polymers was performed at 23° C. One of the Green Chemistry principles states that the performance of a reaction at ambient temperature is an important criterion for minimisation of energy-related environmental and economical impacts (16). Hence, the surprising ability of the PTSPA-imprinted polymer to perform better at 23° C. signifies the potential of this imprinted polymer to be considered as an energy-efficient catalyst.

### Catalytic Activity of Various TSPA-Imprinted Polymers

As illustrated above, the synthesis of various TSPA polymers were achieved using different compositions of pre-polymerisation mixtures of the cross-linker DVB (28) with the monomer 4-VI (27). In this hydrolytic assay involving various TSPA polymers, Michaelis-Menten plots (FIG. 14) also showed higher catalytic rate for the TSPA-imprinted polymers in comparison to their corresponding non-imprinted polymers, with the exception of the TSPA-1 imprinted polymer.

TABLE 5
Kinetic evaluation of the hydrolysis reaction based on the released
product PNP obtained with various imprinted polymers and their
non-imprinted polymers prepared with various ratios of 4-VI (27)-to-
DVB (28) being 1-to-2 for TSPA-1, 1-to-3 for TSPA-2; 1-to-5 for
TSPA-3 and 1-to-9 for TSPA-4 polymers.

| | | | | k_{cat} × 10⁻³ | k_{cat}/Kₘ × |
|---|---|---|---|---|---|
| | Vₘₐₓ | | | (μmol/ | 10⁻³ |
| | (μmol/ | Kₘ | Kₐ | mL/min/ | (min/mg |
| | mL/ | (μmol/ | (μmol/ | mg of | of |
| Polymer | min) | mL) | mL)⁻¹ | polymer) | polymer) |
| TSPA-1 imprinted | 2.86 | 0.71 | 1.14 | 57.20 | 80.56 |
| polymer | | | | | |
| TSPA-1 non- | 2.53 | 0.52 | 1.92 | 50.60 | 97.31 |
| imprinted | | | | | |
| TSPA-2 imprinted | 3.83 | 0.39 | 2.56 | 76.60 | 196.41 |
| polymer | | | | | |
| TSPA-2 non- | 2.66 | 1.08 | 0.92 | 65.20 | 60.37 |
| imprinted | | | | | |
| TSPA-3 imprinted | 5.24 | 1.89 | 0.53 | 104.80 | 55.45 |
| polymer | | | | | |
| TSPA-3 non- | 2.46 | 0.87 | 1.15 | 49.20 | 56.55 |
| imprinted | | | | | |
| TSPA-4 imprinted | 2.63 | 0.18 | 5.56 | 52.60 | 292.22 |
| polymer | | | | | |
| TSPA-4 non- | 0.53 | 0.12 | 8.33 | 10.60 | 88.33 |
| imprinted | | | | | |

Various kinetic parameters were also determined, which enabled to evaluate the higher catalytic rate capability of the TSPA-imprinted polymers in comparison to their corresponding non-imprinted polymers. As shown in both, Table 5 and in FIG. 15, it was evident that the catalytic rate (Vₘₐₓ) of the TSPA-imprinted polymers over their corresponding non-imprinted polymers was improved proportionally with the increasing ratio of DVB (28) to 4-VI (27) monomer used in the synthesis of the imprinted polymers.

The Kₐ values involving substrate binding receptors are dependent on how effective a receptor binds to the substrate. Some receptors may require a high substrate concentration in order to reach their maximum complex formation or to be fully saturated with the substrate. In this study, the maximum reaction velocities with varying Kₘ values was dependent on the substrate concentration for the catalysis reaction for the polymers involving TSPA-1, -3 and -4, with the binding efficiency of the polymer for the substrate molecule different to what may occur in the free solution state. Based on the Kₐ values, the TSPA-non-imprinted polymers have been shown to have a higher substrate binding tendency at low substrate concentration (low Kₘ values) in the following order TSPA-3>TSPA-1>TSPA-4 compared to their corresponding imprinted polymers. Moreover, the high Kₐ values also indicate that the substrate binding rates (kₒₙ) of these non-imprinted polymers were faster than their imprinted polymers. In the case of reaction rates, the non-imprinted polymers, however, significantly were less effective than to any of their corresponding imprinted polymers as Vₘₐₓ or k_{cat} values evaluated. These results therefore signify that the sites in the non-imprinted polymers might have high substrate binding affinities, but due to their lack of specific substrate cleaving sites, it is impossible for these polymers to convert the substrate to product as effectively as the imprinted polymers. In contrast, for the corresponding imprinted polymers to be fully complexed with the substrate molecule or reach saturation, a relatively high substrate concentration was required. This consequently made their Kₘ values higher.

As evident from the results the catalytic activity of the TSPA based polymers was improved when the cross-linker (DVB) (28) to monomer, 4-VI (27), ratio was increased in the polymerisation process. As described above, the quantities of DVB (28) used in the TSPA-3 and TSPA-4 polymers relative to the quantities used for the TSPA-1 and TSPA-2 polymers were higher. At the same time the catalytic rates were also improved as the Vₘₐₓ values for TSPA-3 and TSPA-4 imprinted polymer were 2.13- and 4.96-fold higher, respectively, than their corresponding non-imprinted polymers. Hence, these values indicate that binding sites created in the TSPA-3 and -4 non-imprinted polymers were considerably different from those formed in the comparative imprinted polymers.

Even though considerable catalytic rate improvements in terms of Vₘₐₓ occurred with the TSPA-3 and TSPA-4 imprinted polymers over their respective non-imprinted polymers (FIG. 15), these values were lower in comparison to values obtained by the PTSPA-imprinted polymer. Although both the PTSPA- and TSPA-imprinted polymers were prepared with imidazole moieties incorporated as a functional group, the structural feature and functionalities of catalytic groups presented in cavities of the TSPA and PTSPA imprinted polymers are different.

The superior catalytic activity of the PTSPA-imprinted polymer can be rationalized in terms of a number of factors. For example, the presence of all the necessary functional moieties mimic those of trypsin (i.e. Asp, His and Ser) in a predetermined arrangement and in the right orientation in the polymer cavity can be attributed as the reason for the PTSPA-imprinted polymer's exceptional high catalytic activity in comparison to TSPA-imprinted polymers, which only contain a single active group (i.e. imidazole). The hydrolytic activity of the PTSPA-imprinted polymer is therefore more closely related to the catalytic mechanism of the natural enzyme trypsin. The other possibility for the enhanced catalytic activity of the PTSPA-imprinted polymer could be the high number of catalytically active sites present after the template was extracted. As the template extract values show above, the quantity of template removed from the PTSPA-imprinted polymer was higher than compared to the amount removed from any of the TSPA-imprinted polymers. This result therefore is an indication that the number of cavity sites generated in the PTSPA-imprinted polymer was higher, pointing the enhanced catalytic potential of this imprinted polymer. The surface area and pore volume of the PTSPA-imprinted polymer was also higher than those in TSPA-3 and -4 imprinted polymers. Thus, the number of the accessible binding sites in the PTSPA-imprinted polymer was higher. Lastly, the type of the cross-linker could also have an effect in the high catalytic activity of this imprinted polymer. Although the PTSPA and TSPA-imprinted polymers were different in terms of functionality of monomers and polymerisation procedures, the use of EDMA (20) as a cross-linker in the synthesis of the PTSPA-imprinted polymer could probably be another reason for the optimal catalytic activity of the PTSPA-imprinted polymer. Therefore, by employing EDMA, the production of a PTSPA-imprinted polymer can be achieved with better substrate accessibility to the active binding sites resulting in an excellent hydrolytic performance. The influence of all of these attributes could not have been anticipated from the prior art.

### Influence of EDMA on the Catalytic Activity of TSPA-Imprinted Polymer

A key factor in the optimisation of the overall performance of the imprinted polymer is the appropriate selection of the type of the cross-linking agents used in imprinted polymer preparation. The preparation of the TSPA-5 polymers utilising EDMA (20) as a cross-linker was carried out using a similar monomer-to-cross-linker ratio (1-to-9) as used for the preparation of the DVB (28) based TSPA-4 polymers. The Michaelis-Menten plots and kinetic data for both, the TSPA-4 and TSPA-5 polymers, are represented in FIG. 16 and Table 6, respectively.

Kinetic values (Vₘₐₓ or k_{cat}) in Table 6, show that the catalytic rate of the TSPA-5 imprinted polymer is 13.4-fold higher than the corresponding non-imprinted polymer. Based on these results, the TSPA-5 imprinted polymer is the most catalytically proficient polymer from the TSPA-imprinted polymer series. For example, the Vₘₐₓ ratio (imprinted polymer/non-imprinted polymer) of the TSPA-5 is 2.7-fold larger than the comparative TSPA-4 polymer, as shown in FIG. 17.

Similarly to most TSPA-imprinted polymers, the TSPA-5 imprinted polymer was also shown to be saturated at a considerably higher substrate concentration than its corresponding non-imprinted polymer, as assessed from Kₘ and Kₐ values. Despite its strong binding affinity, it is apparent that the TSPA-5 non-imprinted polymer was ineffective in substrate to product conversion. Thus, this result is also a major factor verifying the importance of specific cleaving sites in the polymer for efficient catalysis to occur.

TABLE 6
Kinetic evaluation of the hydrolysis reaction based on the released
product PNP (35) obtained when the substrate Cbz-L-Lys-ONp.HCl
(33) was incubated with the TSPA-4 and TSPA-5 polymers, which
were prepared with a monomer-to cross-linker ratio of 1-to-9 using
DVB (28) and EDMA (20) cross-linkers, respectively.

| | | | | k_{cat} × 10⁻³ | k_{cat}/Kₘ × |
|---|---|---|---|---|---|
| | Vₘₐₓ | | | (μmol/ | 10⁻³ |
| | (μmol/ | Kₘ | Kₐ | mL/min/ | (min/mg |
| | mL/ | (μmol/ | (μmol/ | mg of | of |
| Polymer | min) | mL) | mL)⁻¹ | polymer) | polymer) |
| TSPA-4 imprinted | 2.63 | 0.18 | 5.56 | 52.60 | 292.22 |
| polymer | | | | | |
| TSPA-4 non- | 0.53 | 0.12 | 8.33 | 10.60 | 88.33 |
| imprinted | | | | | |
| TSPA-5 imprinted | 2.42 | 4.29 | 0.23 | 48.40 | 11.28 |
| polymer | | | | | |
| TSPA-5 non- | 0.18 | 1.21 | 0.83 | 3.60 | 2.97 |
| imprinted | | | | | |

Although the Kₘ value for the TSPA-5 imprinted polymer was more than 3-fold higher than for the TSPA-5 non-imprinted polymer, its k_{cat}/Kₘ value was 3.8-fold higher. Hence, this result is more evidence of the catalytic competence of this imprinted polymer. The higher catalytic rate (Vₘₐₓ) of the TSPA-5 imprinted polymer over the TSPA-4 can directly be attributed to the use of EDMA (20) as a

cross-linking agent. Utilisation of the cross-linker DVB (28) in the synthesis of imprinted polymers is advantageous, since it is a chemically stable and non-hydrolysable reagent. However in terms of polymer flexibility, enhanced catalytic activity achieved by TSPA-5 imprinted polymer in this study can be assigned to the use of EDMA cross-linker, which produced this imprinted polymer with:
better flexibility, and hence increased the efficiency of substrate mass transfer rate within the polymer;
well-defined catalytic sites or structurally better arranged functional binding cavities. This can further be proven by comparing the Vₘₐₓ values of the TSPA-4 and −5 polymers. As values in Table 6 show, a significantly lower Vₘₐₓ value for the TSPA-5 non-imprinted polymer was achieved in comparison to the TSPA-4 non-imprinted polymer. Hence, this verifies that cleaving of the substrate with the TSPA-5 polymer occurred was favoured and achieved by the specific sites, which were produced by the template molecules.
higher surface area per gram of polymer. As has been described earlier, high surface area per unit of polymer improves the accessibility of the polymers. From the BET assays, distinctive physical property differences between TSPA-4 and TSPA-5 polymers were evident, with the TSPA-5 polymer possessing both, higher surface area and pore volume per gram of polymer. Thus, this feature is also a major factor for TSPA-5 imprinted polymer exhibiting better catalytic performance, and finally
a higher number of binding sites in the TSPA-5 compared to the TSPA-4 imprinted polymer, due to large quantity of template removal. This consequently increased the quantity of available active cleaving sites in this imprinted polymer.

Although the catalytic activity of the TSPA-5 imprinted polymer in comparison to its non-imprinted polymer was improved by utilisation of the cross-linker EDMA (TSPA-5 imprinted polymer), the catalytic activity data in this study clearly demonstrated that the PTSPA-imprinted polymer was a better polymeric catalyst. Thus, it can be concluded that apart from the presence of all functional groups in its cavities, the superior catalytic capability of the PTSPA-imprinted polymer in comparison to the TSPA-imprinted polymers can further be attributed to the novel imprinting procedures used in the synthesis of the PTSPA-imprinted polymer. The covalent polymerisation technique thus appears to result in cavities with more uniform (homogeneous) binding sites in comparison to multiple or heterogeneous sites achieved by the non-covalent polymerisation procedure. Thus, cavities generated by the covalent polymerisation approach may in this instance be more suitable for catalysis. In this work, higher catalytic rates obtained with the PTSPA-imprinted polymer prepared with the covalent imprinting technique were in agreement with these claims.

Effect of the Porosity and Surface Area of the Polymers in their Hydrolytic and Catalytic Performance

As the BET data indicated, no significant differences in either the surface areas or porosities between the imprinted polymers and their corresponding non-imprinted polymers were found. Therefore, this result illustrated that the catalytic activities of the imprinted polymers obtained clearly were a result of the imprinting effect of the template rather than the morphological properties per se of the imprinted polymers and non-imprinted polymers. However, by comparing the effects of the type and amount of the cross-linker with the catalytic activity of the resulting polymers, a good correlation was obtained. For instance, EDMA (20) based imprinted polymers (PTSPA and TSPA-5 polymers), which have higher surface areas and higher pore volumes per gram of polymers were found to relate to their better catalytic performances in comparison to DVB (28) prepared polymers. This indicated that having high surface area or large pore volume per particle of polymer enhances the number of active sites in the polymer accessible to the substrate. As a result, the amount of substrate cleaved by these imprinted polymers was increased. In the case of the DVB prepared polymers, surface areas and porosities were found to be lower, in particular for the TSPA-4 polymer, which was prepared with a higher percentage of DVB. However, the TSPA-4 imprinted polymer as evaluated from Vₘₐₓ values, was a better catalyst in comparison to the TSPA-imprinted polymers, which were prepared with lower amounts of DVB (i.e. TSPA-1 or 2) and also possess high surface area and porosity. Therefore, the physical property differences between the polymers have shown the impact of the cross-linkers in the catalytic activity of the resulting imprinted polymers. The porosity effect that was altered by the amount of DVB used in the preparation of the TSPA polymers, in particularly in relation to the TSPA-non-imprinted polymers was demonstrated. With increasing DVB, the porosity of the TSPA-non-imprinted polymers (i.e. TSPA-4 non-imprinted polymer) was reduced. As a result, the accessibility of this TSPA-4 non-imprinted polymer to the non-specific binding sites was reduced.

### Evaluation of TSA Templates in Catalytic Rate Enhancement of a Imprinted Polymer

TSA templates as structural models for the synthesis of templates have been exploited for the preparation of catalytic imprinted polymers described in this Invention Disclosure. The unique and surprising catalytic aptitude of the TSA organophosphorus template-based imprinted polymers is believed to be a direct consequence of the manner in which the imprinted polymers were synthesised. In the studies described in this Invention Disclosure, the structural configuration of the TSA template has been found to be more correlated to the tetrahedral TS of the substrate than the TSA template related to the GS of the substrate. Therefore, the necessity of a geometrically tetrahedral TS template for the synthesis of catalytic imprinted polymers has been documented, and the preparation of comparative imprinted polymers with a geometrically planar template achieved. For this reason the synthesis of the GSCA-imprinted polymer was performed utilising a geometrically planar template (3), and EDMA as a cross-linker. The choice of EDMA was made due to its ability to produce imprinted polymers with better catalytic activity as demonstrated by the hydrolytic activity of the TSPA-5 imprinted polymer. The hydrolysis of the substrate Cbz-L-Lys-ONp.HCl (33) with the GSCA-imprinted polymer was performed using similar hydrolytic procedures to those used for the hydrolytic activity studies of the PTSPA and TSPA-imprinted polymers.

The graph in FIG. 18 shows a typical Michaelis-Menten plot, with a lower catalytic rate for the GSCA-imprinted polymer in comparison to the TSPA-5 imprinted polymer, although the GSCA-imprinted polymer had more available active sites than the TSPA-5 imprinted polymer, as evidenced by the template removal studies (see Table 2). As data in Table 7 show, the maximum catalytic rate (Vₘₐₓ) of the TSPA-5 imprinted polymer was found to be more than 5-fold higher than that of the GSCA-imprinted polymer. Thus, this result is strong evidence that cavity sites created by a tetrahedral TS entity using an organophosphorus based template were the major reason for the high catalytic rate of the TSPA-5 imprinted polymer. In terms of k_{cat}/Kₘ, the TSPA-5 imprinted polymer was less efficient (1.18-fold lower than the GSCA-imprinted polymer) due to a relatively high Kₘ value obtained for the TSPA-5 imprinted polymer compared to the GSCA-imprinted polymer. However, based on the Vₘₐₓ result, this study has proven the importance of the TSA (i.e. the template (2)) as a template for the preparation of a catalytically effective imprinted polymer.

The results obtained show the importance of the phosphonate based templates for creating cavities with complimentary TS geometry, in the production of catalytically effective imprinted polymers. The excellent catalytic efficiency documented for the TSPA-5 imprinted polymer using the TSA method of the tetrahedral phosphonate compound is due to the structural dissimilarity of the phosphonate template either to the carbonyl moiety in the substrate or in the products. In contrast the planar carboxylic acid template has a structural geometry similarity to the substrate Cbz-L-Lys-ONp.HCl (33), and the small Vₘₐₓ obtained for the GSCA-imprinted polymer may have been the result of some hydrolytic inhibition during the catalytic process. It is worth emphasizing that both, the TSPA-5 and GSCA-imprinted polymers have a similar surface area and porosity per unit of polymer as described in Section 2. Therefore, the catalytic activities obtained by these polymers are a direct consequence of the structural cavities created in the imprinted polymers rather than the differences in the physical properties of the imprinted polymers.

TABLE 7
Kinetics data of the hydrolysis reaction based on the released
PNP products comparing the planar GSCA and the TSA
based TSPA-5 imprinted polymers.

| | | | | k_{cat} × 10⁻³ | k_{cat}/Kₘ × |
|---|---|---|---|---|---|
| | Vₘₐₓ | | | (μmol/ | 10⁻³ |
| | (μmol/ | Kₘ | Kₐ | mL/min/ | (min/mg |
| | mL/ | (μmol/ | (μmol/ | mg of | of |
| Imprinted polymer | min) | mL) | mL)⁻¹ | polymer) | polymer) |
| GSCA-imprinted | 0.46 | 0.69 | 1.45 | 9.20 | 13.33 |
| polymer | | | | | |
| TSPA-5 imprinted | 2.42 | 4.29 | 0.23 | 48.40 | 11.28 |
| polymer | | | | | |

### 4) Evaluation of the Selectivity of the Imprinted Polymers

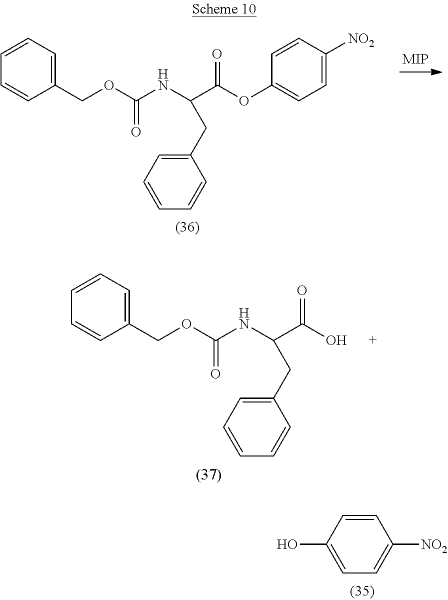

For this investigation, N-(benzyloxycarbonyl)-D-phenyl-alanine p-nitrophenyl (Cbz-D-Phe-ONp) (36) was used as a non-target substrate, which could potentially be hydrolysed as shown in Scheme 10.

Substrates like Cbz-D-Phe-ONp (36) can easily be hydrolysed by the enzyme chymotrypsin in the bulk liquid state due to the selectivity of this enzyme for the phenyl based residues. Therefore, the use of the substrate Cbz-D-Phe-ONp (36) allowed the extent of the substrate selectivity of the imprinted polymers, to be documented. The hydrolytic assessment of the substrate (36) was performed following a similar hydrolytic procedure to that used in the hydrolysis of the substrate Cbz-L-Lys-ONp.HCl (33), as described in the experimental section.

### Identification and Characterisation of Cleaved Product

As the chromatogram profiles in FIG. 19 (III and IV) indicate, the quantity of cleaved PNP (35) after incubating the non-target substrate Cbz-D-Phe-ONp (36) with the PTSPA-imprinted polymer was obviously minor in comparison to the TSPA-imprinted polymers 15 (e.g. TSPA-2 imprinted polymer FIG. 19 (IV)).

Even though the substrate was incubated with the PTSPA-imprinted polymer for 30 min, no major amount of cleaved PNP (35) was detected FIG. 19 (III). Hence, this result denotes that the cavity sites formed within the PTSPA-imprinted polymer were highly specific, with 15 remarkably substrate selectivity, whilst the number of sites suitable for non-target substrate (36) accommodation and cleavage were extremely few.

### Kinetic Evaluation of the Hydrolysis Reaction

The catalytic activities of the imprinted polymers for the non-target substrate Cbz-D-Phe-ONp (36) are represented in typical Michaelis-Menten plots as depicted in FIG. 20. From these plots it is apparent that the catalytic rate obtained for the PTSPA-imprinted polymer was negligible in comparison to the TSPA-imprinted polymers. Thus, this result denoted that the catalytic aptitude of the PTSPA-imprinted polymer for this non-target substrate (36) was ineffective. This result is also further confirmed by the related kinetic parameters as shown in Table 8.

As the data in Table 8 illustrate, the Vₘₐₓ and k_{cat} value of the PTSPA-imprinted polymer to hydrolyse the non-target substrate Cbz-D-Phe-ONp (36) was only 0.02 mmol/mL/min and 0.4×10⁻³ mmol/mL/min/mg, respectively. Furthermore, from Kₘ value it is clear that the saturation of this imprinted polymer with the substrate (36) occurred at a higher substrate concentration. Despite the substrate concentration used in the hydrolysis study, the binding affinity of this imprinted polymer was very low as can be determined from Kₐ value. Hence, these results are pivotal evidence of the weak binding affinity of the PTSPA-imprinted polymer for this substrate. Moreover, the k_{cat}/Kₘ amount (0.13×10⁻³ min/mg of polymer) obtained for PTSPA-imprinted polymer is a major factor verifying the weak efficiency of the imprinted polymer for this substrate.

In a parallel catalysis study involving the TSPA-imprinted polymers, diverse kinetic values, which enable characterisation of the catalytic properties of these imprinted polymers for the non-target substrate were obtained. From the plots in FIG. 20 and kinetic values in Table 8, the catalytic rate of the TSPA-3 imprinted polymer amongst the TSPA-imprinted polymers is the lowest, signifying the weak catalytic efficacy of this imprinted polymer for the substrate Cbz-D-Phe-ONp (36). The Vₘₐₓ and k_{cat}/Kₘ values of the TSPA-3 imprinted polymer were 1.81- and 1.40-fold lower, respectively, than that

TABLE 8
Kinetic evaluation of catalytic activity based on the released product
PNP (35), when the PTSPA, TSPA-2, TSPA-3 and TSPA-4
imprinted polymers were incubated with the non-target substrate
Cbz-D-Phe-ONp (36).

| | | | | k_{cat} × | |
|---|---|---|---|---|---|
| | | | | 10⁻³ | k_{cat}/Kₘ × |
| | Vₘₐₓ | | Kₐ | (μmol/mL/ | 10⁻³ |
| Imprinted | (μmol/mL/ | Kₘ | (μmol/ | min/mg of | (min/mg |
| polymer | min) | (μmol/mL) | mL)⁻¹ | polymer) | of polymer) |
| PTSPA | 0.02 | 3.00 | 0.33 | 0.40 | 0.13 |
| TSPA-2 | 0.47 | 2.29 | 0.44 | 9.40 | 4.11 |
| TSPA-3 | 0.26 | 1.77 | 0.56 | 5.20 | 2.94 |
| TSPA-4 | 0.65 | 1.61 | 0.62 | 13.00 | 8.07 |

achieved for TSPA-2 imprinted polymer. The lower catalytic rate of the TSPA-3 imprinted polymer for the non-target substrate compared to the TSPA-2 imprinted polymer is attributed to the use of excess DVB in its preparation (1.67 times higher than the amount used in the synthesis of the TSPA-2 imprinted polymer), pointing structural integrity of the binding sites. It is interesting to note that despite its low catalytic rate values, the TSPA-3 imprinted polymer has a high Kₐ value at a relatively lower substrate concentration (as can be determined from low Kₘ value) in comparison to the TSPA-2 imprinted polymer. For the TSPA-3 imprinted polymer to be saturated at a lower substrate concentration than the TSPA-2 imprinted polymer, its binding association with the non-target substrate must have been stronger. For this to occur, the structural arrangements of the non-specific binding sites in the TSPA-3 imprinted polymer must have been formed in a way more suitable for substrate (36) binding than cleaving, unlike the TSPA-2 imprinted polymer. The high Kₘ value obtained for the TSPA-2 imprinted polymer indicated that the saturation of this imprinted polymer with this substrate, and hence maximum Kₐ occurred at higher substrate concentration than the other imprinted polymers.

In another kinetic analysis involving the TSPA-4 imprinted polymer a different result was found. Although this imprinted polymer was prepared with excess cross-linker in comparison to the TSPA-2 and -3 imprinted polymers, an astonishingly high catalytic rate (Vₘₐₓ) with high binding affinity at low substrate concentration was obtained. As values in Table 8 show, the Vₘₐₓ value for TSPA-4 imprinted polymer was obtained in 1.38- and 2.50-fold higher, respectively, than the TSPA-2 and TSPA-3 imprinted polymers. Moreover, its very low Kₘ value (1.61 μmol/mL) in combination with its high k_{cat} value made the resulting efficiency (k_{cat}/Kₘ) of the TSPA-4 imprinted polymer obtained at the highest value (8.07×10⁻³ min/mg of polymer) amongst all evaluated imprinted polymers. As has been elucidated previously, the utilisation of a higher amount of the cross-linker relative to the monomer in the synthesis of the imprinted polymer is expected to produce highly defined cavities within the imprinted polymer. Thus, considering the amount of cross-linker used in the synthesis of the TSPA-4 imprinted polymer, its catalytic activity for the non-target substrate Cbz-D-Phe-ONp (36) was anticipated to be lower in comparison to the TSPA-2 and -3 imprinted polymers. Thus, this result indicated that despite the use of a high percentage of the cross-linker, the numbers of non-specific sites available for substrate (36) cleavage in this TSPA-4 imprinted polymer were higher than those in the TSPA-2 and TSPA-3 imprinted polymers.

In further studies involving the hydrolysis of the non-target substrate (36) with polymers prepared with different types of cross-linkers, notable catalytic activity differences were also found. This assessment compared the catalytic rates of the TSPA-4 and the TSPA-5 imprinted polymers, which were prepared using the cross-linkers DVB (28) and (EDMA) (20), respectively. As illustrated above, these imprinted polymers were prepared with the same cross-linker-to-monomer molar ratio (9-to-1). However, in terms of catalytic rate, as shown in FIG. 21 and from the data in Table 9, the TSPA-5 imprinted polymer had a less catalytic efficacy for this non-target substrate in comparison to the TSPA-4 imprinted polymer, as both Vₘₐₓ and k_{cat} values of the TSPA-5 imprinted polymer were 28-fold lower. Furthermore, the catalytic efficiency of this imprinted polymer for this substrate (36) was 8.5-fold lower than the comparative TSPA-4 imprinted polymer, as assessed from the k_{cat}/Kₘ values.

TABLE 9
Kinetic evaluation of catalytic activity based on the released product
PNP (35), when TSPA-4 and -5 imprinted polymers were incubated
with the non-target substrate Cbz-D-Phe-ONp (36). TSPA-5 was
prepared using EDMA cross-linker.

| | | | | k_{cat} × | |
|---|---|---|---|---|---|
| | | | | 10⁻³ | k_{cat}/Kₘ × |
| | Vₘₐₓ | Kₘ | | (μmol/mL/ | 10⁻³ |
| Imprinted | (μmol/ | (μmol/ | Kₐ | min/mg of | (min/mg |
| polymer | mL/min) | mL) | (μmol/mL)⁻¹ | polymer) | of polymer) |
| TSPA-4 | 0.65 | 1.61 | 0.62 | 13.00 | 8.07 |
| TSPA-5 | 0.53 | 11.18 | 0.09 | 10.60 | 0.95 |

Despite the use of different TSPA-imprinted polymers in this hydrolysis study, it was established that the PTSPA-imprinted polymer was the most catalytically ineffective polymer for the non-target substrate (36) in comparison to any of the TSPA-imprinted polymers, as illustrated by the various kinetic values. As FIG. 22 shows, the catalytic rate of the PTSPA-imprinted polymer was smaller for this substrate (36) with a Vₘₐₓ value 13-fold lower even when contrasted to the catalytically least effective TSPA-3 imprinted polymer, from the series of TSPA-imprinted polymers. Thus, this result is strong evidence that the functional binding cavities generated in the PTSPA-imprinted polymer were less compatible in accommodating and subsequently hydrolysing a non-target substrate.

From this study, it is evident that the catalytic activity of the imprinted polymers for a structurally different non-target substrate (36) was different. However, in order to

determine the selectivity of the imprinted polymers, their characterisation in terms of catalytic rates and efficiency was crucial. This analysis was achieved by comparing various kinetic values obtained for the target lysine based substrate (33) with that of the non-target phenylalanine based substrate (36).

### Evaluation of the Catalytic Selectivity of the Imprinted Polymers

The selectivity assessment based on the Michaelis-Menten plots (FIG. 23) showed a distinctive high catalytic rate, and with catalytic preference of the imprinted polymers for target substrate Cbz-L-Lys-ONp.HCl (33) in comparison to the non-target substrate Cbz-D-Phe-ONp (36). Thus, cavities created within these imprinted polymers were highly selective substrate with structural complementarity to the size and shape of the target substrate (33), for the resulting high catalytic rates to be achieved effectively.

Based on the ratio of Vₘₐₓ values of the target lysine and the non-target phenylalanine substrate (Cbz-L-Lys-ONp.HCl (33)/Cbz-D-Phe-ONp (36)) as shown in Table 10 and in FIG. 24, the selectivity of the PTSPA-imprinted polymer in comparison to the TSPA-imprinted polymers was larger. As emphasised above, the catalytic turnover rate (k_{cat}) assessment of the imprinted polymers was based on the values of Vₘₐₓ per amount of the polymer used. As a result, the turnover rate of the PTSPA-imprinted polymer to convert the target substrate Cbz-L-Lys-ONp.HCl (33) to the expected product PNP (35) was 146-fold higher than that for the substrate Cbz-D-Phe-ONp (36). Furthermore, the 761-fold higher catalytic efficiency of the PTSPA-imprinted polymer for the target substrate as assessed from the k_{cat}/Kₘ value has not only proven the remarkable specificity of this imprinted polymer but also its extremely rapid catalytic efficacy for the target substrate (33) in preference over the non-target substrate (36).

The binding affinity of the PTSPA-imprinted polymer for the target substrate was shown to be significantly stronger (Kₐ=5.15 higher) compared to the non-target substrate. Moreover, the lower Kₘ (Kₘ=5 times lower) value indicated that the saturation of the PTSPA-imprinted polymer with the target substrate occurred at a relatively lower concentration than with the non-target substrate. Hence, this imprinted polymer was more effective at catalysing the target substrate.

From the TSPA polymers, the TSPA-3 imprinted polymer was found to be the most substrate-selective catalyst. As values in Table 10 specified, the catalytic rate (Vₘₐₓ) of the TSPA-3 for the target substrate (33) was 20-fold higher than the non-target substrate (36), proving the high preference of this imprinted polymer for the target substrate. Based on similar analyses, the catalytic rates (selectivity) of the TSPA-2, TSPA-4 and TSPA-5 imprinted polymers for the target substrate were 8.15-, 4.05- and 4.57-fold higher, respectively, than for the non-target substrate (36). Although the TSPA-imprinted polymers showed a considerable preference for the target substrate as assessed from selectivity efficiency (K_{cat}/Kₘ) values, these values, however, varied when compared to the corresponding Vₘₐₓ values. For instance, based on the Vₘₐₓ value, the TSPA-3 imprinted polymer was the most selective imprinted polymer. However, according to the K_{cat}/Kₘ value, this imprinted polymer was the least selective for the target substrate. One reason for this could be the varying values of the Kₘ obtained and used when calculating the selectivity efficiency (K_{cat}/Kₘ). Therefore, it may be preferable to illustrate the selectivity of the TSPA-imprinted polymers using only one parameter, preferentially the Vₘₐₓ, since its values does not depend on Kₘ data.

TABLE 10
Kinetic evaluation of substrate selectivity ratio (Lys/Phe*) based on
the released product PNP (35), when the PTSPA, TSPA-2, TSPA-3,
TSPA-4 and TSPA-5 imprinted polymers were incubated with the
substrates Cbz-L-Lys-ONp.HCl (33) or Cbz-D-Phe-ONp (36).

| Imprinted | *Substrate | | | | |
|---|---|---|---|---|---|
| polymer | selectivity | Vₘₐₓ | Kₘ | Kₐ | k_{cat}/Kₘ |
| PTSPA | Lys/Phe | 146.00 | 0.20 | 5.15 | 761.14 |
| TSPA-2 | Lys/Phe | 8.15 | 0.17 | 5.82 | 47.79 |
| TSPA-3 | Lys/Phe | 20.15 | 0.93 | 0.95 | 18.86 |
| TSPA-4 | Lys/Phe | 4.05 | 6.25 | 8.97 | 36.21 |
| TSPA-5 | Lys/Phe | 4.57 | 0.38 | 2.56 | 91.40 |

*Lys = Cbz-L-Lys-ONp.HCl (33), Phe = Cbz-D-Phe-ONp (36).

As noted above, the catalytic activities of the TSPA-imprinted polymers in comparison to the corresponding non-imprinted polymers were found to increase proportionally with the amount of the cross-linker DVB (28) used in the synthesis of the imprinted polymers. In this selectivity analysis, however, the Vₘₐₓ values indicated that the amount of the cross-linker DVB used in the polymerisation procedure needed to be kept at a certain amount, in order for the TSPA-imprinted polymer to have a maximum selectivity for the target substrate (33). The utilisation of a higher content of DVB in the synthesis of a imprinted polymer resulted in a imprinted polymer with considerably higher catalytic rate activity when hydrolysing the non-target substrate (36), and hence reduced its substrate selectivity.

The improved selectivity of the TSPA-5 imprinted polymer in comparison to the TSPA-4 imprinted polymer can be directly attributed to the use of the cross-linker EDMA. As discussed earlier, the substrate accessibility to an imprinted polymer that possesses higher surface area per gram of polymer is expected to be higher. However, in this study despite having a higher surface area in comparison to the TSPA-imprinted polymers in particular to the TSPA-3 and -4 imprinted polymers, the specificity of the PTSPA-imprinted polymer prepared with the cross-linker EDMA was found to be higher. Hence, this result indicated that, even though the accessibility of the functional binding sites of the PTSPA-imprinted polymer was high, its catalytic effect for the non-target substrate (36) was extremely small. Similarly, the TSPA-5 imprinted polymer prepared with the cross-linker EDMA had a higher surface area and better substrate specificity in comparison to the comparative TSPA-4 imprinted polymer, as Vₘₐₓ and K_{cat}/Kₘ values indicated. The remarkable selectivity exhibited, particularly by the PTSPA-imprinted polymers indicated that cavities created within these imprinted polymers were well-defined to accommodate only a substrate that is structurally compatible to cavity size and shape of the imprinted polymers. The enhanced selectivity of the PTSPA imprinted polymer and TSPA-5 imprinted polymer can to a large part be attributed to the use of the cross-linker EDMA.

Although, the TSPA-3 imprinted polymer showed the highest selectivity of all the TSPA-imprinted polymers, its substrate discrimination ability was more than 7- and 16-fold lower than the PTSPA-imprinted polymer, as judged from Vₘₐₓ and K_{cat}/Kₘ values, respectively. Hence, lower substrate selectivity achieved for the TSPA-imprinted polymers was an indication that the TSAP-imprinted polymers were more amenable in capturing and accommodating the non-target substrate Cbz-D-Phe-ONp (36) for subsequent release of the product PNP (35).

The TSPA-imprinted polymers were prepared utilising an excess amount of the functional monomer with respect to the template. Hence, it could be one major factor contributing to the low selectivity of the TSPA-imprinted polymers caused by the presence of non-selective binding sites. Therefore, the key reason for the exceptionally high selectivity of the PTSPA-imprinted polymer was held to be the establishment of better binding sites in the polymer matrix, which was achieved through a covalent imprinting approach. Based on this estimation, it is obvious that the numbers of specific binding sites produced within TSPA-imprinted polymers were extremely low. This may therefore be one reason for weaker catalytic activities of the TSPA-imprinted polymers in comparison to the PTSPA-imprinted polymer.

### 5) Experimental-Templates Synthesis

### General Procedures

Melting points were recorded using a SMP3 (Midland, ON, Canada) melting point apparatus.

Microwave oven samples were synthesised using a Smith Synthesiser or Biotage Milestone Microsynth HPR3600 (Uppsala, Sweden) microwaves. Reactions were performed in sealed quartz vessels.

Nuclear Magnetic Resonance (NMR) spectroscopy samples were analysed using AC 200, DPX 300 and DRX 400 Bruker Biospin P/L (Sydney, Australia) spectrometers. All ¹H NMR spectra were recorded at operating frequencies of 200, 300 or 400 MHz, and results have been processed using the XWINNMR 3.5 software. The spectra were generally run as deuterochloroform (CDCl₃) solutions with tetramethylsilane (TMS) as the internal standard (0.00 p.p.m.), unless otherwise stated. Each resonance was reported relative to the reference peak (chemical shift (6)) measured in p.p.m., multiplicity, coupling constants (J Hz), and number of protons. The assignments of multiplicities were according to the following convention: are denoted as (s) singlet, (d) doublet, (t) triplet, (q) quartet, or multiplet (m); and prefixed with (b) broad where appropriate. ¹³C NMR spectra were recorded at operating frequencies 50, 75 and 100 MHz. The ³¹P NMR spectra were recorded at operating frequency 121 MHz and referenced to phosphoric acid (H₃PO₄, 80%) as external standard.

Analytical high-performance liquid chromatography (HPLC) was carried out with an Agilent 1100 Series (Agilent Technologies, Waldbronn, Germany) high-performance liquid chromatography instrument, equipped with an Agilent 1100 DAD Detector (with measuring absorbance at 220, 300 and 375 nm). Flow rates and system temperature for sample analysis were at 1 mL/min and 25° C., respectively. Sample analysis was performed using a Zorbax RP C-18 column with 4.6×150 mm inner diameter (i.d.) and a Luna Phenyl-Hexyl (Phenomenex, 5 μm), 4.6×150 mm i.d. columns. All system control and data acquisition was performed with the Agilent 2D ChemStation software.

Low-resolution electrospray mass spectra (ESI-MS) were recorded in positive or negative mode. Electron impact ionisation (EI) spectra (m/z) were recorded on a Hewlett Packard Trio-1 spectrometer and detector (Palo alto, CA, USA). The micromass platform MS was operated at 200° C. with cone voltage 35 eV. M⁺ or M⁻ denote the molecular ion.

Accurate mass or high resolution-mass spectrometry measurements (HR-MS) were performed in methanol (CH₃OH) and recorded on either a Bruker BioApex 4.7 Tesla FT-ICR (Billerica, Mass., USA) instrument fitted with an analytical electrospray source at high resolution and calibrated using sodium iodide clusters or an Agilent G1969A LC-TOF system with reference mass correction and a Agilent 1100 Series LC.

Analytical liquid chromatography-mass spectrometry (LC-MS) was conducted on a Gilson (Middleton, Wis., USA) instrument equipped with a Gilson 215/819 injector module, 306 gradient pumps, and an Agilent 1100 diode array detector. Molecules were detected with UV irradiation between 200-500 nm and Micromass (Manchester, UK) ZMD mass spectrometer. The inlet flow to the source was restricted with a flow splitter (100 μL/min) and the entire instrument was controlled by the Mass Lynx v3.5 software (Micromass).

Gas Chromatography-Mass spectrometry (GC-MS) was performed using an Agilent 6890 GC (Agilent Technologies, Waldbronn, Germany), MSD-Agilent 5973, auto injector-7683 with a capillary column type HP-5MS (30 m×250 μm×0.25 μm), in the split mode.

Microanalyses were performed by the Campbell Microanalytical Laboratory, University of Otago (Dunedin, New Zealand).

Infrared spectra (IR) were recorded on a Bruker Equinox 55 (Billerica, Mass., USA) as neat. The infrared was recorded in wave numbers (cm⁻¹) with the intensity of the absorption (vₘₐₓ) specified as s (strong), m (medium) or w (weak) and prefixed b (broad) where appropriate.

Thin layer chromatography (TLC) was performed on silica gel 60 F-254 (Merck, Darmstadt, Germany) plates with detection by UV light. The detection of compounds was UV light at 254 nm.

Flash column chromatography was performed using Merck silica gel (Merck, Darmstadt, Germany) 60, 0.063-0.200 mm (230-240 mesh). Eluent mixtures are expressed as volume-to-volume ratios (v/v).

Kugelrohr distillation was carried out using a Büchi GKR-50 bulb to bulb apparatus attached to a high vacuum pump.

### Solvents and Reagents

All solvents were reagent grade and used as purchased. Where anhydrous solvents were required, standard purification and drying techniques were applied. Tetrahydrofuran (THF) was distilled over benzophenone and sodium wire under nitrogen and stored over 4 Å molecular sieves. Dichloromethane (CH₂Cl₂) and toluene were distilled from calcium hydride and stored over 4 Å molecular sieves. CH₃OH was stored over 4 Å molecular sieves. Triethylamine (TEA) was stored over 4 Å molecular sieves. Diethyl ether (Et₂O) was stored over sodium wire and distilled from fresh sodium wire and benzophenone prior to use.

### Synthesis of 5-phthalimido-1-pentanol (8)

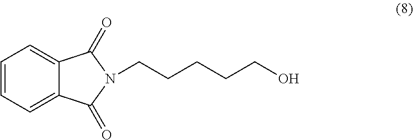

5-Amino-1-pentanol (1.00 g, 9.7 mmol) was mixed with phthalic anhydride (1.44 g, 9.7 mmol) and irradiated for 5 min at 150° C. in a microwave oven. The reaction mixture was dried in vacuo to afford the product 5-phthalimido-1-pentanol (8) as a yellow viscous oil (2.26 g, 100%).

¹H NMR (300 MHz, CDCl₃): δ 1.36-1.47 (m, 2H, H3), 1.58-1.80 (m, 4H, H2 and H4), 3.63 (t, J=6.5 Hz, 2H, H1), 3.69 (t, J=7.2 Hz, 2H, H5), 7.69-7.73 (m, 2H, Pht), 7.82-7.85 (m, 2H, Pht).

¹³C NMR (50 MHz, CDCl₃): δ 18.50 (C3), 24.18 (C4), 34.27 (C2), 31.89 (C5), 56.18 (C1), 117.14, 125.99, 127.96 (Pht), 165.32 (CO).

HR-MS (ESI⁺) Found: m/z 234.1129; C₁₃H₁₆NO₃ (M+H)⁺ requires 234.1130 and found m/z 256.0950; C₁₃H₁₅NO₃Na (M+Na)⁺ requires 256.0950.

### Synthesis of 5-phthalimido-1-pentanal (9)

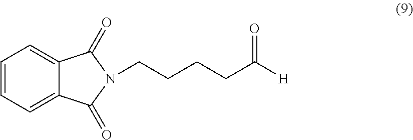

Method 1

In a 100 mL round-bottom flask fitted with a reflux condenser, pyridinium chlorochromate (PCC) (1.85 g, 8.6 mmol) was suspended in anhydrous CH₂Cl₂ (12 mL). 5-Phthalimido-1-pentanol (8) (1.00 g, 4.3 mmol) in anhydrous CH₂Cl₂ (3 mL) was added in one portion to the stirred yellow mixture of PCC and stirred at 23° C. for 1.5 h. After adding dry ethyl ether (12 mL) to the mixture, the chromium salt was precipitated as a black tart gum, and the insoluble residue was washed with Et₂O (2×10 mL). The Et₂O solutions were combined and then passed over a short pad of silica-gel using dry Et₂O as an eluent. The solvent was evaporated by rotary evaporator at reduced pressure and 5-phthalimido-1-pentanal (9) was obtained as a colourless viscous oil (0.36 g, 36%).

¹H NMR (300 MHz, CDCl₃): δ 1.66-1.79 (m, 4H, H3 and H4), J=6.3 Hz, 2H, H2), 3.74 (t, J=7.8 Hz, 2H, H5), 7.70-7.76 (m, 2H, Pht), 7.82-7.88 (m, 2H, Pht), 9.78 (s, 1H, CHO).

Method 2

In a 100 mL round-bottom flask fitted with a reflux condenser, PCC (1.85 g, 8.6 mmol) was suspended in anhydrous CH₂Cl₂ (12 mL) 5-Phthalimido-1-pentanol (8) (1.00 g, 4.3 mmol) in anhydrous CH₂Cl₂ (3 mL) was added in one portion to the stirred yellow mixture of PCC and heated at reflux for 1.5 h. After adding dry ethyl ether (12 mL) to the mixture, the chromium salt was precipitated as a black tart gum, and the insoluble residue was washed with Et₂O (2×10 mL). The Et₂O solutions were combined and then passed over a short pad of silica-gel using dry Et₂O as an eluent. The solvent was evaporated and 5-phthalimido-1-pentanal (9) was obtained as a colourless viscous oil (0.46 g, 46%).

¹H NMR (300 MHz, CDCl₃): δ 1.65-1.76 (m, 4H, H3 and H4), 2.48 (t, J=6.3 Hz, 2H, H2), 3.68 (t, J=7.8 Hz, 2H, H5), 7.67-7.71 (m, 2H, Pht), 7.80-7.96 (m, 2H, Pht), 9.73 (s, 1H, CHO).

¹³C NMR (50 MHz, CDCl₃): δ 18.58 (C3), 24.10 (C4), 34.43 (C5), 40.41 (C2), 127.26, 136.86, 138.92 (Pht), 168.43 (CO), 201.90 (C1).

MS (ESI⁺) m/z 232.1 (M+H)⁺.

### Synthesis of diphenyl-(1-(N-benzyloxycarbonylamino)-5-phthalimido)pentylphosphonate (12)

Acetic acid (4 mL) was added to a mixture of (9) (0.35 g, 1.5 mmol), triphenyl phosphite (0.31 g, 1.0 mmol) and benzyl carbamate (0.15 g, 1.0 mmol). The solution was stirred at 85-90° C. for 1 h. The solvent and by-product (as a phenol) were then removed using a rotary evaporator in a boiling water bath. The reddish-brown oily residue was dissolved in CH₃OH and left overnight at −20° C. The diphenyl-(1-(N-benzyloxycarbonylamino)-5-phthalimido)pentylphosphonate (12) was obtained as a white solid and was collected by filtration (0.24 g, 40%).

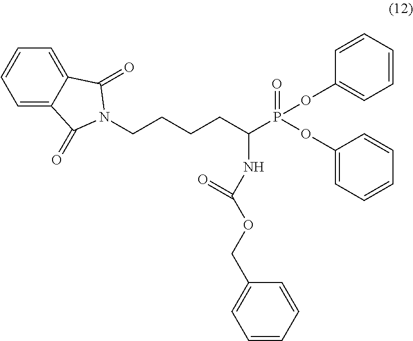

TLC R_{f}=0.8 CHCl₃/CH₃OH (9:1, v/v).

M.p. 111-114° C.

¹H NMR (200 MHz, CDCl₃): δ 1.42-1.97 (m, 6H, H2-H4), 3.62 (t, J 7.8 Hz, 2H, H5), 4.33-4.54 (m, 1H, H1), 4.95-5.24 (m, 3H, CH₂ and NH of Cbz), 7.04-7.30 (m, 15H, Ar—H), 7.63-7.69 (m, 2H, Pht), 7.74-7.84 (m, 2H, Pht).

³¹P NMR (121.5 MHz, CDCl₃): δ 17.91 (s).

MS (ESI⁺) m/z 599.3 (M+H)⁺.

### Synthesis of dimethyl-(1-(N-benzyloxycarbonylamino)-5-phthalimido)pentylphosphon-ate (13)

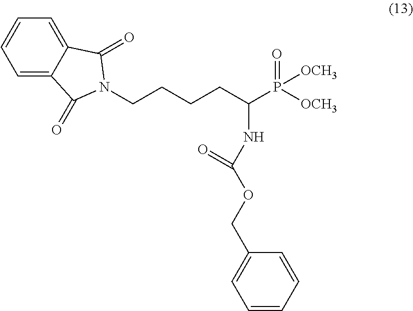

Potassium fluoride (KF) (1.52 g, 26.2 mmol) was added to a solution of (6) (1.57 g, 2.6 mmol) in CHCl₃ (10 mL) and CH₃OH (58 mL). The clear solution was stirred overnight at 23° C. After solvent evaporation, the pale-yellow solid residual was dissolved in ethyl acetate (25 mL) and washed with NaOH (1 M) to remove the phenol by-product. The sample was then washed with brine and dried over magnesium sulphate (MgSO₄). After solvent evaporation, a viscous yellow oil product was collected. The crude product was crystallised from ethyl acetate/hexane (1:1, v/v) to give the pure dimethyl-(1-(N-(benzyloxycarbonylamino)-5-phthalimido)pentylphosphonate (13) as a white solid (1.10 g, 88%).

TLC R_{f}=0.46 CHCl₃/CH₃OH (9:1, v/v).

M.p. 92-95° C.

IR:νₘₐₓ (neat, cm⁻¹): 3258 w (NH), 1701 s (CO), 1400-1600 s (aromatics) and 1190 m (PO).

¹H NMR (200 MHz, CDCl₃): δ 1.39-1.97 (m, 6H, H2-H4), 3.58-3.71 (m, 8H, PO(CH₃)₂), 4.00-4.09 (m, 1H, H1), 4.95-5.06 (m, 2H, CH₂ of Cbz), 5.20 (d, 1H, NH), 7.32 (bs, 5H, Ar—H), 7.60-7.63 (m, 2H, Pht), 7.73-7.76 (m, 2H, Pht).

¹³C NMR (100 MHz, CDCl₃); δ 22.87 (d, ²J_{CP} 32.8 Hz, C2), 27.94, (C3), 29.20 (C4), 37.35 (C5), 47.12 (d, ¹J_{CP} 156.3 Hz, C1), 53.08 (d, ²J_{CP} 7.1 Hz, OCH₃), 53.21 (d, ²J_{CP} 7.1 Hz, OCH₃), 67.22 (CH₂—Ar), 123.23, 128.05, 128.21, 128.54, 132.18, 133.91, (Ar and Pht), 156.08 (d, ²J_{CP} 5.5 Hz, COO of Pht), 168.43 (CO of Cbz).

³¹P NMR (121.5 MHz, CDCl₃): δ 27.57 (s).

MS (ESI⁺) m/z 475.2 (M+H)⁺ and 497.2 (M+Na)⁺.

HR-MS (ESI⁺) Found: m/z 475.1634; C₂₃H₂₈N₂O₇P (M+H)⁺ requires 475.1634 and m/z 497.1436; C₂₃H₂₇N₂O₇PNa (M+Na)⁺ requires 497.1454.

Microanalysis Calc. for C₂₃H₂₇N₂O₇P: C, 58.23; H, 5.74; N, 5.90%. Found: C, 58.38, H, 5.48, N, 5.93%.

### Synthesis of methyl-(1-(N-benzyloxycarbonylamino)-5-phthalimido)pentylphosphonate (2)

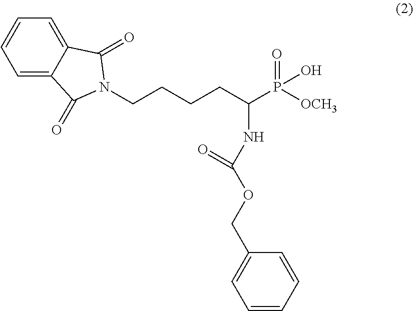

Method 1

Dimethyl-(1-(N-(benzyloxycarbonylamino)-5-phthalimido)pentylphosphonate (13) (0.1 g, 0.21 mmol) was dissolved in 4-butanone (0.5 mL). To the solution, lithium bromide (LiBr) (0.02 g, 0.2 mmol) was added together. The mixture was stirred at reflux and a white solid product was formed within 10 min. The reaction was left to reflux for 1 h and the solvent was evaporated and the residual white lithium salt was washed with Et₂O. After suspension of the salt in CH₂Cl₂ (2 mL), HCl (1 M) was added dropwise to adjust the pH to 1. To the yellow solution, sodium chloride (NaCl) (0.08 g) was added followed by extraction using ethyl acetate. After drying the organic phase over MgSO₄, the solvent was evaporated, and the crude methyl-(1-(N-benzyloxycarbonylamino)-5-phthalimido)pentyl phosphonate (2) was obtained as a white solid (0.051 g, 50%).

M.p. 161-164° C.

¹H NMR (200 MHz, CDCl₃ with drops of CD₃OD): δ 1.39-1.71 (m, 6H, H2-H4), 3.58-3.70 (m, 5H, H5 and P—(OCH₃)), 4.7-4.10 (m, 1H, H1), 5.01-5.09 (m, 3H, OCH and NH of Cbz), 7.28 (bs, 5H, Ar), 7.63-7.66 (m, 2H, Pht), 7.77-7.79 (m, 2H, Pht). MS (ESI⁺) m/z 461.3 (M+H)⁺ and 483.2 (M+Na)⁺.

Method 2

To a solution of 1,4-diazabicyclo[2.2.2]octane (DABCO) (0.08 g, 0.7 mmol) in 5 mL of acetone/toluene (1:1, v/v), dimethyl-(1-(N-(benzyloxycarbonylamino)-5-phthalimido)pentylphosphonate (13) (0.20 g, 0.4 mmol) was added and the mixture was heat at reflux for 5 h. After solvent evaporation, the yellow viscous oil was extracted from 5% HCl (2×10 mL) using ethyl acetate. The organic layer was washed with water followed by brine and dried over MgSO₄. After solvent evaporation a white solid product was obtained. The pure methyl-(1-(N-benzyloxycarbonylamino)-5-phthalimido)pentylphosphonate (2) was obtained after washing the white solid product with ethyl acetate and hexane (1:1, v/v) (0.13 g, 67%).

M.p. 160-163° C.

¹H-NMR (200 MHz, CDCl₃ with drops of CD₃OD): δ 1.42-1.87 (m, 6H, H2-H4), 3.63-3.77 (m, 5H, H5 and P—(OCH₃)), 4.08-4.11 (m, 1H, H1), 5.01-5.34 (m, 3H, OCH₂ and NH of Cbz), 7.68 (s, 5H, Ar), 7.60-7.68 (m, 2H, Pht), 7.78-7.81 (m, 2H, Pht).

MS (ES⁺) m/z 461.2 (M+H)⁺ and 483.2 (M+Na)⁺.

Method 3

To a solution of DABCO (0.04 g, 0.4 mmol) in 5 mL of acetone/toluene (1:1, v/v), dimethyl-(1-(N-(benzyloxycarbonylamino)-5-phthalimido)pentylphosphonate (13) (0.1 g, 0.2 mmol) was added and the mixture was irradiated between 120-125° C. for 10 min using microwave. After solvent evaporation, the yellow viscous oil was extracted from 5% HCl (2×5 mL) using ethyl acetate. The organic layer was washed with water followed by brine and dried over MgSO₄. After solvent evaporation a white solid product was obtained. The pure methyl-(1-(N-benzyloxycarbonylamino)-5-phthalimido)pentyl-phosphonate (2) was obtained by washing the white solid with ethyl acetate and hexane (1:1, v/v). (0.07 g, 75%).

TLC R_{f}=0.77 CHCl₃/CH₃OH (9:1, v/v).

M.p. 160-163° C.

IR νₘₐₓ (neat, cm⁻¹): 3225 bs (OH) and 3033 w (NH), 1769 s (CO), 1608 m (NH—CO), 1400-1600 s (aromatics) and 1026 m (PO).

¹H NMR (400 MHz, CDCl₃ with drops of CD₃OD): δ 1.34-1.79 (m, 6H, H2-H4), 3.57-3.63 (m, 5H, H5 and P—(OCH₃), 3.87-3.94 (m, 1H, H1), 4.89-5.06 (m, 3H, OCH₂ and NH of Cbz), 7.24 (bs, 5H, Ar—H), 7.60-7.62 (m, 2H, Pht), 7.72-7.74 (m, 2H, Pht).

¹³C-NMR (75 MHz, CDCl₃ with CD₃OD); δ 22.96 (d, ²J_{CP} 13.2 Hz, C2), 27.87 (C3), 28.92 (C4), 37.45 (C4), 47.44 (d, ¹J_{CP} 176.1 Hz, C1), 52.44 (d, ²J_{CP} 6.7 Hz, OCH₃), 66.97 (CH₂—Ar), 123.18, 127.76, 128.03, 128.40, 132.97, 134.07, 136.34 (Ar and Pht), 156.79 (d, ²J_{CP} 5.8 Hz, COO), 168.69 (CO).

³¹P NMR (121.5 MHz, CDCl₃): δ 27.57 (s).

MS (ESI⁺) m/z 461.2 (M+H)⁺ and 483.2 (M+Na)⁺.

HR-MS (ESI⁺) Found: m/z 461.1474; C₂₂H₂₆N₂O₇P (M+H)⁺ requires 461.1478 and 483.1288; C₂₂H₂₅N₂O₇PNa (M+Na)⁺ requires 483.1297.

Microanalysis Calc. for C₂₂H₂₅N₂O₇P: C, 57.39; H, 5.47; N, 6.08%. Found: C, 57.56, H, 5.64, N, 6.10%.

### Synthesis of 4-vinylimidazole (27)

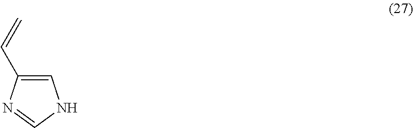

Urocanic acid (0.25 g, 1.81 mmol) was heated between 220-225° C. using a bulb-to-bulb (Kugelrohr) distillation apparatus. The distillation was performed at low-vacuum pressure. The expected 4-vinyl-imidazole (27) product was distilled in the receiver as viscous oil that slowly crystallised upon cooling to give as a white crystal (0.08 g, 47%).

M.P. 81-84° C.

¹H NMR (400 MHz, DMSO): δ 4.99 (d, J=10.8 Hz, 1H, vinyl), 5.58 (d, J=17.5 Hz, 1H, vinyl), 6.56 (dd, J=10.8 Hz and 17.5 Hz, 1H, vinyl) 7.20 (s, 1H, H5), 7.60 (s, 1H, H2), 3.75 (bs, 1H, H1).

ESI (EI⁺) m/z 95.9 (M+H)⁺.

### Synthesis of methyl, 2-(2′-imidazolyl)-4-ethenylphenyl (1-(N-benzyloxycarbonylamino)-5-phthalimido)pentylphosphonate (1)

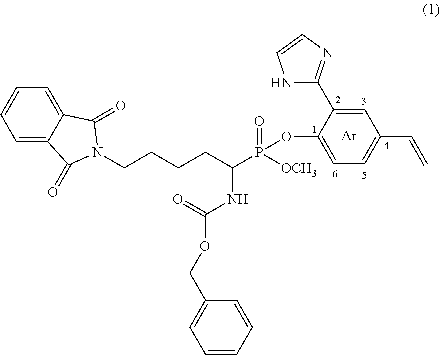

To methyl-(1-(N-benzyloxycarbonyl-amino)-5-phthalimido)pentylphosphonate (2) (0.18 g, 0.38 mmol) in anhydrous CH₂Cl₂ (6 mL), TEA (110 μL, 1.22 mmol) was added under nitrogen. To this mixture, benzotriazole-1-yl-oxy-tris(dimethylamino)phosphoniumhexafluorophosphate (BOP) (0.14 g, 0.38 mmol) was added and the reaction mixture was stirred at 23° C. for 10 min. After dissolving the polymerisable group of 2-(2′-hydroxy-5′-ethenylphenyl)imidazole (4) (0.07 g, 0.38 mmol) in dry CH₂Cl₂ (1 mL), the yellow solution was added to the above mixture and stirred. The reaction progress was monitored by HPLC. Within 1 h of reaction, a significant conversion of product was detected by HPLC. The sample was also analysed by ESI-MS and the expected product along with the by-product (hexamethylphosphoramide), were detected MS (EI⁺) m/z 629.5 (M+H)⁺, (M+Na)⁺ 651.4 and 180.2 (hexamethylphosphoramide+H)⁺, respectively. The reaction was left to proceed for a total period of 46 h followed by washing the mixture with brine, saturated aqueous sodium bicarbonate solution and 1 M HCl solutions. After drying the organic phase over MgSO₄ and removing the solvent, the residual oil was purified by flash chromatography using ethyl acetate/hexane (1:1, v/v). After the solvent was removed, the hydroscopic product methyl, 2-(2′-imidazolyl)-4-ethenylphenyl (1-(N-benzyloxycarbonyl-amino)-5-phthalimido)pentylphosphonate (1) was obtained as a yellow foam (0.16 g, 66%).

¹H-NMR (300 MHz, CDCl₃): δ 1.34-1.94 (m, 6H, H2-H4), 3.58-3.61 (m, 5H, H5 and P—(OCH₃), 3.85-4.05 (m, 1H, H1), 4.98 (bs, 2H, CH of Cbz), 5.08 (d, 1H, J=10.8 Hz, 1H, vinyl), 5.57 (d, 1H, J 17.6 Hz, vinyl), 6.83 (dd, J 17.5 and 10.8 Hz, 1H, vinyl), 6.76-7.18 (m, 10H, PhIm), 7.60-7.68 (m, 2H, Pht), 7.78-7.81 (m, 2H, Pht).

¹³C-NMR (75 MHz, CDCl₃ with drops of MD₃OD); δ 23.32 (d, ²J_{CP} 12.5 Hz, C2), 28.09 (C3), 30.06 (C4), 37.60 (C5), 47.94 (d, ¹J_{CP} 151.3 Hz, C1), 52.17 (d, ²J_{CP} 5.7, OCH₃) δ6.68 (CH₂ of Cbz), 108.54, 110.56, 112.69 112.67, (vinyl), 110.56 and 111.16 (C2-Ar) 117.94 and 118.30 (C6-Ar), 123.09 (Pht), 125.03 (C3′ and C4′), 127.64, 127.87, 128.31 (Ar of Cbz), 129.34 (C3-Ar), 129.55 (C4-Ar), 130.10 (C5-Ar) 131.98 (Pht), 133.90 (Pht), 135.10 (vinyl), 136.47 (Ar of Cbz), 140.87, 142.12 (C1′), 155.18 (d, ²J_{CP} 9.1 Hz, C1-Ar), 156.82 (d, ³J_{CP} 6.1 Hz, COO of Cbz), 168.52 (CO of Pht).

IR νₘₐₓ (neat, cm⁻¹): 3465 s (NH), 1708 s (CO), 1688 s (NH—CO), 1400-1600 s (aromatics) and 1084 m (PO).

³¹P NMR (121.5 MHz, CDCl₃): δ 26.40 (s).

ESI (EI⁺) m/z 629.5 (M+H)⁺, 651.4 (M+Na)⁺.

HR-MS (ESI⁺) Found: m/z 629.2160; C₃₃H₃₃N₄O₇P (M+H)⁺ requires 629.2165. This compound (I) exhibited instability on storage and thus did not yield consistent elemental analysis values on repetitive analyses.

### Synthesis of (1-(N-(benzoyloxycarbonylamino)-5-phthalimido)pentylcarboxylic acid (3)

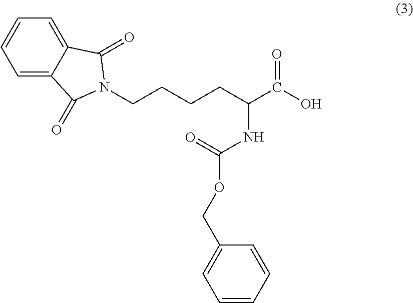

(1-(N-benzyloxycarbonylamino)-5-amino)pentylcarboxylic acid (25) (0.25 g, 0.89 mmol) was mixed with phthalic anhydride (0.13 g, 0.89 mmol). The mixture was irradiated for 5 min at 160° C. using a microwave oven. The sample was then dried in vacuo to give the (1-(N-(benzoyloxycarbonylamino)-5-phthalimido)pentylcarboxylic acid (3) product as a light yellow solid with a glassy consistency (0.37 g, 100%).

¹H NMR (200 MHz, D₂O): δ 1.26-1.70 (m, 6H, H2-H4), 3.67 (t, 2H, J=7.2 Hz, H5), 4.23 (bs, 1H, H1), 5.07 (s, 2H, CH₂ of Cbz), 7.38 (bs, 5H, Ar—H), 7.72-7.73 (m, 2H, Pht), 7.83-7.83 (m, 2H, Pht).

¹³C-NMR (75 MHz, D₂O); δ 23.00, 28.61, 32.56 (C₂-C₄), 37.98 (C5), 54.14 (C1), 67.69 (CH₂ of Cbz), 123.84, 128.67, 128.75, 129.06, 129.10, 132.67, 134.52, 136.81 (Ar and Pht), 156.76 (CO— of Cbz), 169.07 (CO-Pht), 176.59 (COOH).

IR:νₘₐₓ (neat, cm⁻¹): 3051 bs (OH), 1769 s (CO) and 1400-1600 s (aromatics).

MS (EST) m/z 409.3 (M−H)⁻.

HR-MS (ESI⁺) Found: m/z 411.1555 and 433.1376; C₂₂H₂₃N₂O₆ (M+H)⁺ requires 411.1556 and C₂₂H₂₃N₂O₆Na (M+Na)⁺ requires 433.1375.

Microanalysis Calc. for C₂₂H₂₅N₂O₇: C, 64.38; H, 5.40; N, 6.83%. Found: C, 64.24, H, 5.43, N, 6.89%.

### 6) Synthesis of Polymer (Imprinted Polymers and Non-Imprinted Polymers) and their Catalytic Evaluation

Deionised water was from a Milli-Q H₂O purification system (Millipore Bedford, Mass., USA.) and was filtered with a 0.2 μm pore sized Nylon 66 membrane filter (Alltech Assoc., Deerfield, Ill., U.S.A.). Polymers were sieved using a Precision Eforming LLC, stainless steel W/nickel mesh 150 3310-3 ANSI/ASTM E 161 (Cortland, N.Y., USA).

Synthesiser the preparations of the polymers were performed using Mettler Toledo miniblock parallel XT synthesiser (Columbia, Md., USA).

### Synthesis of the PTSPA-Imprinted Polymer (22)

In a 100 mL test tube, (Cbz-Lys(Pht)^{P}(OMe)(Ph-Im)) (1) (0.08 g, 0.13 mmol) was dissolved in CHCl₃ (5 mL). To this solution, methacrylic acid (MAA) (19) (0.22 mL, 2.60 mmol), ethylene dimethacrylate (EDMA) (20) (4.42 mL, 23.40 mmol) and 2,2′-azoisobutyronitrile (AIBN) (0.04 g, 0.24 mmol) were added. After placing the tube in a miniblock parallel synthesiser, the solution was purged by bubbling nitrogen through the mixture for 10 min. Thermal polymerisation was performed at 65° C. for 24 h and a white block polymer (21) was produced. After grinding the polymer using pestle and mortar, particle fractions between 30-90 micrometer were collected using two standard sieves.

Template extraction to produce the catalytically active polymer (22) was achieved using the following steps:
the polymer was stirred in 100 mL of CHCl₃/CH₃OH (1:1, v/v) at room temperature overnight and filtered;
the polymer was then transferred into a soxhlet extraction timble and extracted with methanol (100 mL) overnight and filtrated;
the polymer was then suspended in 100 mL of 1 M NaOH/CH₃OH (1:1, v/v) and the template was extracted at 60° C. for 24 h and finally,
the polymer was washed with distilled water until a pH of 7 of the filtrate was obtained, followed by a final rinse with CH₃OH.

### Synthesis of the PTSPA-Non-Imprinted Polymer (26)

In a 100 mL test tube, N-benzoyl-2-(2′-benzoxy-5′-ethenylphenyl)imidazole (23) (0.05 g, 0.13 mmol) was dissolved in CHCl₃ (5 mL), and to this solution, MAA (19) (0.22 mL, 2.60 mmol), EDMA (20) (4.42 mL, 23.40 mmol) and AIBN (0.04 g, 0.24 mmol) were added. After the tube was placed in a miniblock parallel synthesiser, the solution was purged by bubbling nitrogen through the mixture for 10 min. Thermal polymerisation was performed at 65° C. for 24 h, resulting in the production of a white block polymer (24). After crushing the polymer (using pestle and mortar), particle fractions between 30-90 micrometre were collected using two standard testing sieves. Template extraction to produce the blank control polymer (26) was achieved using the same procedures as described in the preparation of the PTSPA-imprinted polymer (22).

### Synthesis of the TSPA-Imprinted Polymer (30) Using DVB as Cross-Linker.

In a 100 mL test tube, (Cbz-Lys(Pht)^{P}(OMe)(OH)) (2) (0.07 g, 0.15 mmol) was suspended in ACN (1.1 mL) and 4-vinyl imidazole (4-VI) (27) (0.14 g, 1.50 mmol) was added and the solution was stirred. To the homogeneous solution, DVB (28) (0.43 mL, 3.00 mmol) and AIBN (0.04 g, 0.24 mmol) were added. After the tube was placed in a miniblock parallel synthesiser, the solution was purged by bubbling nitrogen through the mixture for 10 min. Thermal polymerisation was performed at 65° C. for 24 h and white polymer beads (29) were obtained. Template removal was achieved by subsequent washing of the polymer with ACN (100 mL), phosphate buffer (100 mL, 20 mM, pH 10) and methanol (100 mL). The imprinted polymer (30) was then oven dried at 60° C. for 24 h.

### Synthesis of TSPA-Non-Imprinted Polymer Using DVS as Cross-Linker

In a 100 mL test tube, 4-VI (27) (0.14 g, 1.50 mmol) was suspended in ACN (1.1 mL). To this, DVB (28) (0.43 mL, 3.00 mmol) and AIBN (0.04 g, 0.24 mmol) were added. After placing the tube in a miniblock parallel synthesiser, the solution was purged with nitrogen for 10 min. Thermal polymerisation was performed at 65° C. for 24 h and white polymer beads were obtained. The polymer was rinsed with ACN and oven dried at 60° C. for 24 h. Using this method, different TSPA-imprinted polymers and -non-imprinted polymers have been prepared utilising various concentrations of DVB (28), as specified above.

### Synthesis of the TSPA-Imprinted Polymer (30) Using EDMA as Cross-Linker

In a 100 mL tube, Cbz-Lys(Pht)^{P}(OMe)(OH) (2) (0.07 g, 0.15 mmol) was added to ACN (1.1 mL). To the suspension, 4-VI (27) (0.14 g, 1.50 mmol) was added and the solution stirred at room temperature resulting in a homogenous solution. To this solution AIBN (0.04 g, 0.24 mmol) and EDMA (20) (2.55 mL, 13.50 mmol) were added. After placing the tube in a miniblock parallel synthesiser, the solution was purged by bubbling nitrogen for 10 min. Thermal polymerisation was performed at 60° C. for 24 h and white polymer beads were obtained. The white polymer beads obtained were then washed with ACN (100 mL), phosphate buffer (100 mL, 20 mM, pH 10) and methanol (100 mL) for template extraction. The TSPA-imprinted polymer was then oven dried at 60° C. for 24 h.

### Synthesis of the GSCA-Imprinted Polymer (32) Using EDMA as Cross-Linker

In a 100 mL tube, (Cbz-Lys(Pht)-OH) (3) as template (0.06 g, 0.15 mmol) and ACN (1.1 mL) were added. To the suspension, 4-VI (27) (0.14 g, 1.50 mmol) was added and the solution was stirred at room temperature resulting in a homogenous solution. To the mixture AIBN (0.04 g) and EDMA (20) (2.55 mL, 13.50 mmol) were added. After the tube was placed in a miniblock parallel synthesiser, the solution was purged by bubbling nitrogen for 10 min. The mixture was then heated at 65° C. for 24 h and white polymer beads (31) were obtained. The polymer obtained was washed with ACN (100 mL), phosphate buffer (100 mL, 20 mM, pH 10) and methanol (100 mL) for template extraction. The polymer (32) obtained was then oven dried at 60° C. for 24 h.

Hydrolysis Studies with Cbz-L-Lys-ONp.HCl (38) with Different Imprinted Polymers and Non-Imprinted Polymers.

To the imprinted polymers (50 mg), ACN (0.5 mL) was added and the heterogeneous sample was stirred for 10 min for equilibration. After the polymer was spun down by centrifugation, the supernatant was removed by careful aspiration using a micropipette. To the wet polymer, the substrate Cbz-L-Lys-ONp.HCl (38) (1 μmol/mL) dissolved in 5 mL ACN/CH₃OH (4.8:0.2, v/v) was added and the mixture was stirred at room temperature. At different time intervals (every 15 s for the first 1.5 min, followed by every 1 min for 5 min, then at 10, 20 and 30 min), small aliquots (0.1 mL) were removed, centrifuged and analysed by an analytical HPLC with an isocratic elution mode using aqueous 0.1% TFA/ACN (60:40, v/v) and UV detection at 300 nm. Using this procedure, the hydrolysis of the substrate Z-L-Lys-ONp.HCl (38) at various concentrations (2, 3 and 4 μmol/mL) with different imprinted polymers and non-imprinted polymers was determined.

### Investigation of Imprinted Polymer Hydrolysed Product by LC-MS

Before and after incubating the substrate Cbz-L-Lys-ONp.HCl (38) with the PTSPA-imprinted polymer (22), LC-MS analysis was performed using gradient elution that employed an eluent A consisting of aqueous formic acid (0.05%) and an eluent B consisting of CH₃OH with a flow rate of 1 mL/min (Table 11). Using the same conditions, the standard PNP was also analysed as a reference.

TABLE 11
Mobile phase time and composition profile used in the LC-MS
(gradient elution) analysis of the PTSPA-imprinted polymer
hydrolysed Cbz-L-Lys-ONp.HCl (33) substrate.

| | (A) Aqueous formic | |
|---|---|---|
| Time (min) | acid (0.05%) | (B) CH₃OH |
| 0 | 90 | 10 |
| 1 | 90 | 10 |
| 10 | 40 | 60 |
| 11 | 10 | 90 |
| 12 | 10 | 90 |
| 13 | 90 | 10 |

Hydrolysis of the Substrate Cbz-D-Phe-ONp (36) with Different Imprinted Polymers and Non-Imprinted Polymers

To the polymer (50 mg), ACN (0.5 mL) was added and the suspension stirred for 30 min for equilibration. After the polymer was spun down by centrifugation, the supernatant was removed by careful aspiration using a micropipette. To the wet polymer, Z-D-Phe-ONp (36) (1 μmol/mL) dissolved in 5 mL of ACN/CH₃OH (4.8:0.2, v/v) was added and the mixture was stirred at room temperature. At different time intervals (every 15 s for the first 1.5 min, followed by every 1 min for 5 mins, then at 10, 20 and 30 min), small aliquots (0.1 mL) were removed. After centrifugation, the supernatants were analysed with an analytical HPLC with UV detection at 300 nm. In this study, an isocratic mobile phase composed of 0.1% aqueous TFA/ACN (70:30, v/v) was used. Using this procedure, different concentrations (2, 3 and 4 μmol/mL) of the substrate Z-D-Phe-ONp (36) were analysed after being incubated with different imprinted polymers and non-imprinted polymers.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A process for preparing a molecularly imprinted polymer (MIP) for hydrolysing amide or ester groups, said process comprising the steps of:
(i) preparing a molecular template comprising:
a tetrahedral chemical moiety which is covalently bound to a pocket forming portion,
(ii) polymerising a monomer and a cross-linking agent in the presence of the molecular template and a porogen; and
(iii) separating the template, or part thereof, from the polymer formed in (ii), to afford the MIP.

2. A process for preparing a molecularly imprinted polymer (MIP) which mimics the catalytic activity of trypsin, said process comprising the steps of:
(i) preparing a molecular template comprising:
(a) a tetrahedral chemical moiety which is covalently bound to a pocket forming portion; and
(b) a histidine like portion (hlp) which is covalently bound to a serine like portion (slp), said hlp or slp bearing a free-radical polymerisable group,
(ii) polymerising a monomer having a free-acid group (or protected form thereof) with a cross-linking agent and the molecular template in the presence of a porogen, such that the free-acid group is able to form a hydrogen bond with the hlp; and
(iii) separating the template, or part thereof, from the polymer formed from (ii), to afford the MIP.

3. A process according to claim 1 or claim 2 wherein the tetrahedral chemical moiety is selected from: 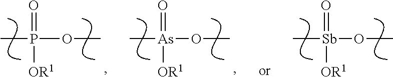
wherein R¹ is selected from hydrogen, or C₁-C₆ alkyl.

4. A process according to any one of claims 1 to 3 wherein the tetrahedral chemical moiety is a phosphonate of formula: 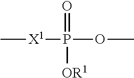
wherein:
R¹ is selected from hydrogen and C₁-C₂ alkyl; and
X¹ is selected from O, S, and optionally substituted alkylene.

5. A process according to any one of claims 1 to 4 wherein the pocket forming portion is a molecular scaffold which structurally mimics the amino acid side chain of lysine or arginine.

6. A process according to claim 5 wherein the pocket forming portion comprises an amino or guanidine moiety (or protected form thereof).

7. A process according to claim 1 or claim 2 wherein the tetrahedral chemical moiety which is covalently bound to a pocket forming portion is represented by formula: 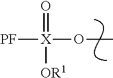
wherein:
X is selected from P, As, and Sb;
R¹ is selected from hydrogen and C₁-C₂ alkyl; and
PF is a pocket forming portion selected from optionally substituted alkyl, optionally protected amino, optionally protected guanidino, N-containing heterocycle, and N-containing heteroaryl.

8. A process according to claim 7 wherein the optionally substituted alkyl group for PF is selected from: 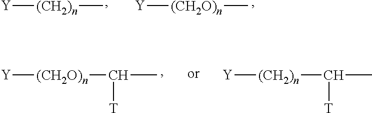
wherein:
n is selected from 0 to 6;
Y is selected from optionally protected amino, optionally protected guanidino, N-containing heterocycle, and N-containing heteroaryl; and
T is selected from optionally substituted C₁-C₃ alkyl, optionally substituted acylamino, optionally substituted oxyacylamino, optionally substituted aminoacyloxy, optionally substituted aminoacyl, optionally substituted oxyacyl, optionally substituted acyloxy, optionally substituted aminoacyloxy, optionally substituted acylamino, optionally substituted acyliminoxy, optionally substituted oxyacylimino, optionally substituted sulfinylamino, optionally substituted sulfonylamino, optionally substituted oxysulfinylamino, optionally substituted oxysulfronylamino and optionally substituted oxyacyloxy.

9. A process according to claim 8 wherein n is selected from 0-4.

10. A process according to claim 8 wherein n is 4.

11. A process according to any one of claims 8 to 10 wherein Y is amino or guanidino.

12. A process according to one of claims 8 to 10 wherein Y is selected from: 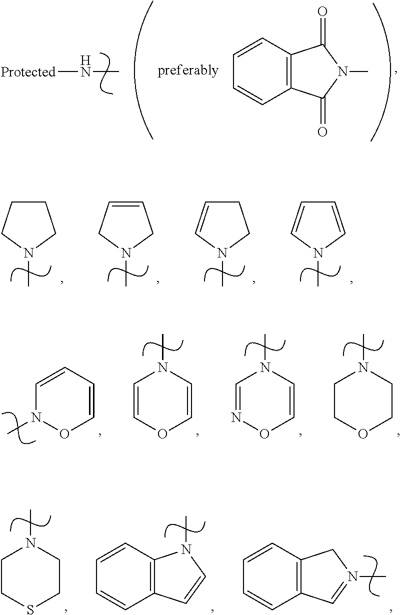
or
a substituted derivatives thereof.

13. A process according to claim 1 or claim 2 wherein the tetrahedral chemical moiety which is covalently bound to a pocket forming portion is represented by the formula: 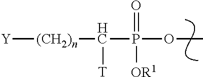
wherein:
n is selected from 0 to 6; (and preferably n is 0-4)
Y is selected from: 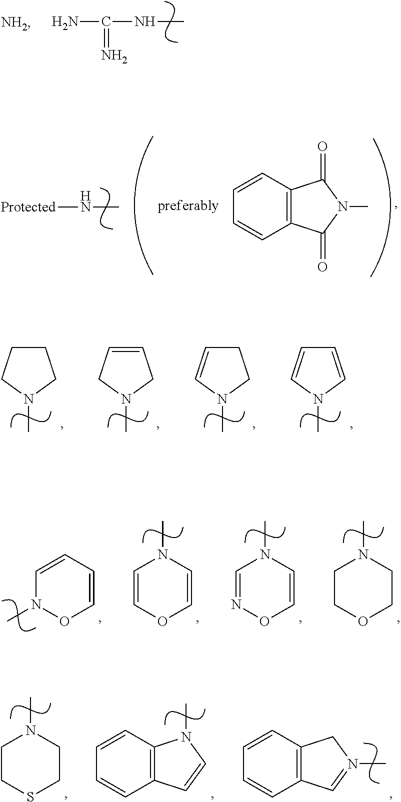
or
a substituted derivative thereof;
R′ is selected from hydrogen and C₁-C₂ alkyl; and
T is selected from —NHC(X′)O—R², —OC(X′)O—R², —CR³R⁴R⁵, —CR³R⁴C(X′)O—R² and a peptide residue;
R² is selected from optionally substituted aryl, optionally substituted arylalkyl, optionally substituted heteroaryl, and optionally substituted heterocyclyl;
X′ is S or O;
R³ and R⁴ are independently selected from H and C₁-C₃ alkyl; and
R⁵ is selected from optionally substituted aryl or optionally substituted arylalkyl.

14. A process according to claim 1 or claim 2 wherein the tetrahedral chemical moiety which is covalently bound to a pocket forming portion is represented by the formula: 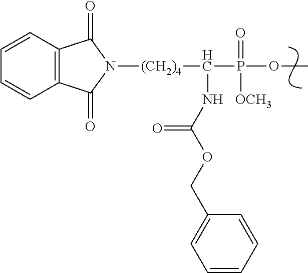
wherein the phenyl and/or phthalimido group may be further independently substituted with from 1 to 4 substituent groups.

15. A process according to claim 1 or claim 2 wherein the molecular template is represented by formula (I)
Y-L-X—O—Z (I)
wherein;
Y is selected from optionally protected amino, optionally protected guanidine, N-containing heterocycle, and N-containing heteroaryl;
L represents a divalent Linking group selected from optionally substituted C alkylene;
X is a tetrahedral chemical moiety wherein the tetrahedral atom is selected from phosphorus, arsenic, antimony, boron, silicon, sulphur or selenium; and
Z represents a residue of a serine like portion (rslp) which is covalently bound to a histidine like portion (hlp).

16. A process according to claim 15 wherein
X is selected from: 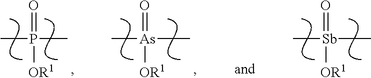
wherein R¹ is selected from hydrogen and C₁-C₂ alkyl;
L is selected from: 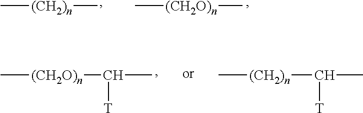
wherein:
n is selected from 0 to 4; and
T is selected from optionally substituted C₁-C₃ alkyl, optionally substituted oxyacylamino, optionally substituted aminoacyloxy, optionally substituted aminoacyl, optionally substituted oxyacyl, optionally substituted acyloxy, and optionally substituted oxyacyloxy; and
Y is selected from: 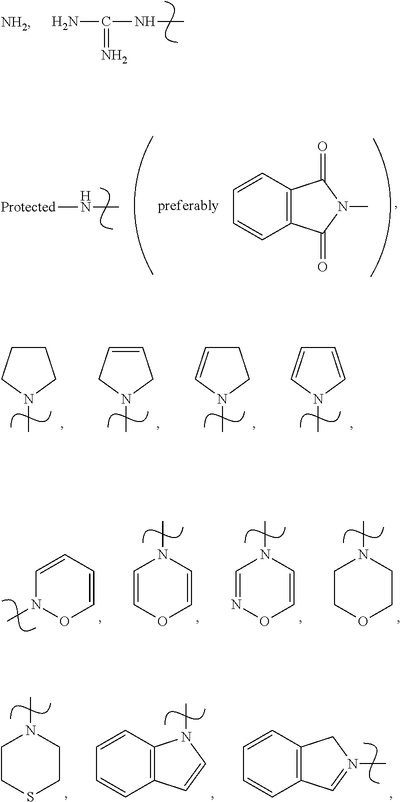
or
a substituted derivatives thereof.

17. A process according to claim 15 wherein:
X is: 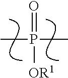
wherein R¹ is selected from hydrogen and C₁-C₂ alkyl;
L is selected from: 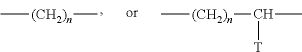
wherein:
n is selected from 0 to 4; and
T represents an optionally substituted oxyacylamino; and
Y is selected from: 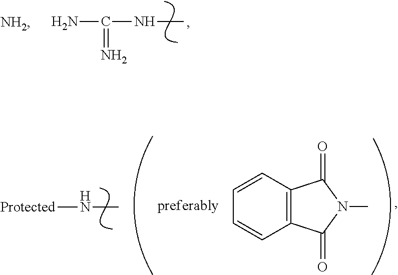
or a derivative thereof.

18. A process according to claim 15 wherein: 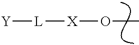
in formula (I) is represented by: 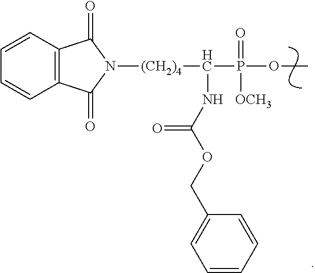
wherein the phenyl and/or phthalimido group may be further independently substituted with from 1 to 4 substituent groups.

19. A process according to any one of claims 15 to 18 wherein the —O—Z moiety may be selected from: 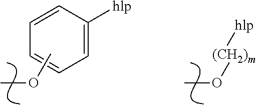
wherein m is an integer selected from 0-4.

20. A process according to claim 19 wherein the hlp portion may be represented by: 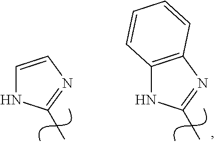
or
a substituted derivative thereof.

21. A process according to any one of claims 15 to 19 wherein the hlp or slp bears a free-radical polymerisable group.

22. A process according to claim 21 wherein —O—Z together may represent: 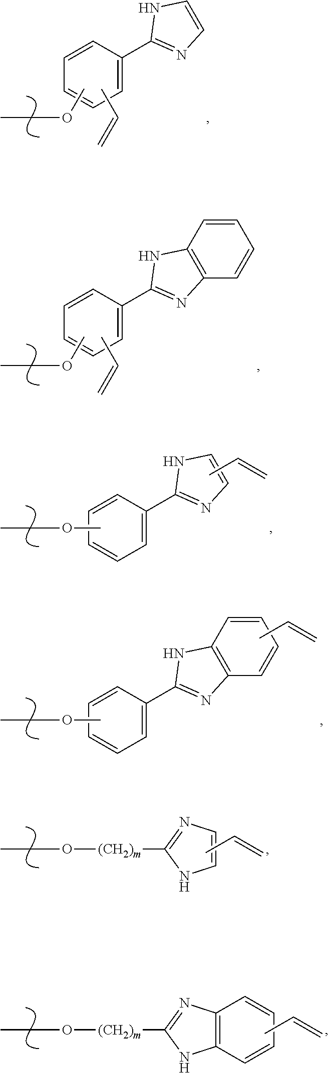
or
a substituted derivative thereof.

23. A process according to any one of claims 1 to 22 wherein the monomer is methacrylic acid.

24. A process according to any one of claims 1 to 23 wherein the crosslinking agent is EDMA.

25. A process according to any one of claims 1 to 24 wherein the porogen is selected from acetone, acetonitrile, chloroform, dichloromethane, dimethyl formamide (DMF), ethyl acetate, ethanol, methanol and dimethyl sulfoxide (DMSO), and mixtures thereof.

26. A process according to any one of claims 1 to 25 wherein the MIP is prepared by initially covalently linking the template molecule to the polymer.

27. A process according to claim 26 wherein the polymerising step is conducted by free-radical polymerisation.

28. A process according to claim 26 or claim 27 wherein the MIP is in the form of a bead.

29. A process according to claim 26 wherein the ratio of template to monomer is about 1:1.

30. A compound represented by formula (I)
Y-L-X—O—Z (I)
wherein;
Y is selected from optionally protected amino, optionally protected guanidine, N-containing heterocycle, and N-containing heteroaryl;
L represents a divalent Linking group selected from optionally substituted C₁-C₅ alkylene;
X is a tetrahedral chemical moiety selected from 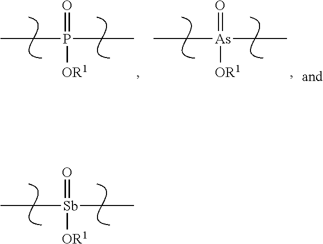
and
Z represents a residue of a serine like portion (rslp) which is covalently bound to a histidine like portion (hip), selected from: 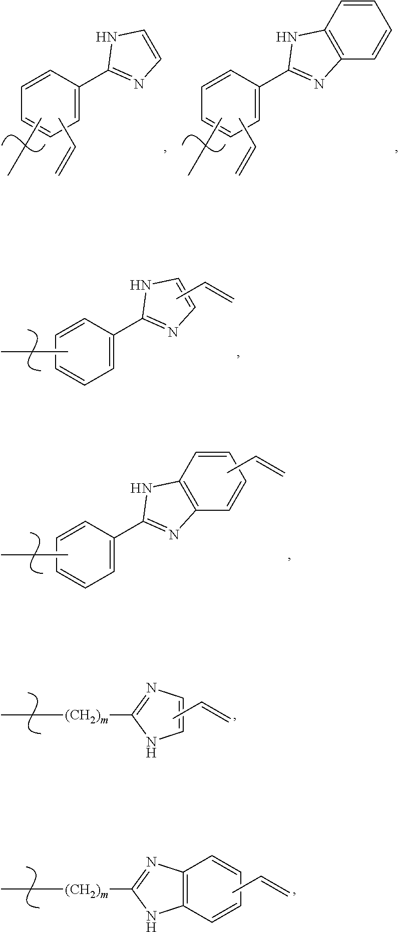
or
a substituted derivative thereof, where m is an integer of 0-4.

31. A compound according to claim 30 wherein:
L is selected from: 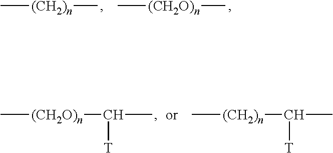
wherein:
n is selected from 0 to 4; and
T is selected from optionally substituted C₁-C₃ alkyl, optionally substituted oxyacylamino, optionally substituted aminoacyloxy, optionally substituted aminoacyl, optionally substituted oxyacyl, optionally substituted acyloxy, and optionally substituted oxyacyloxy; and
Y is selected from: 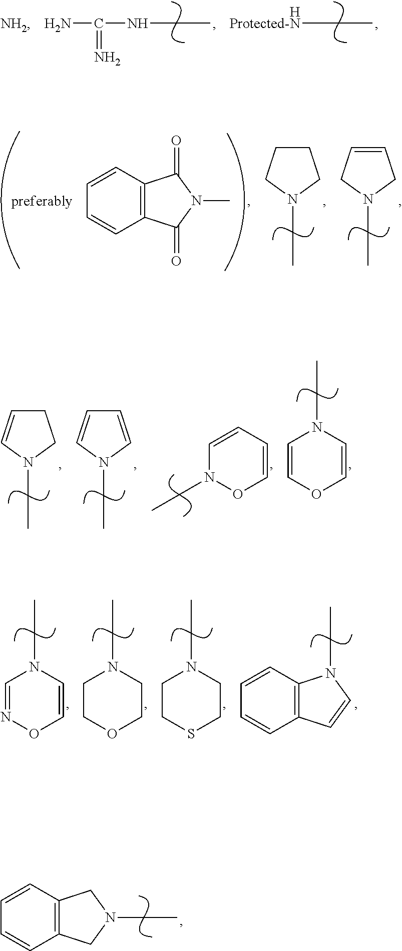
or
a substituted derivative thereof.

32. A compound according to claim 30 or claim 31 wherein:
X is: 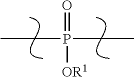
where R¹ is selected from hydrogen and C₁-C₂ alkyl;
L is selected from: 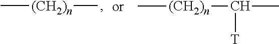
where:
n is selected from 0 to 4; and
T represents an optionally substituted oxyacylamino; and
Y is selected from: 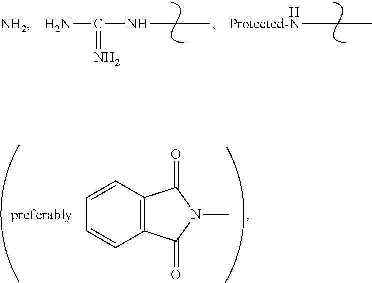
or a derivative thereof.

33. A compound according to any one of claims 30 to 32 wherein: 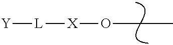
in formula (I) is represented by: 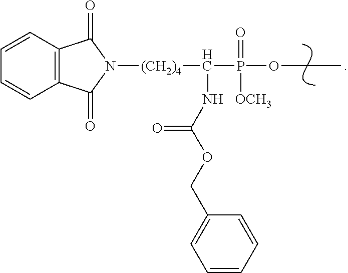
wherein the phenyl and/or phthalimido group may be further independently substituted with from 1 to 4 substituent groups.

34. A MIP obtained by a process according to any one of claims 1 to 29.

35. A MIP characterised by cross linked monomeric units comprising cavities which include:
(a) at least one hydroxyl moiety;
(b) at least one imidazole moiety; and
(c) at least one carboxyl moiety;
on the surface of said cavities.

36. A MIP according to claim 35 wherein the at least one hydroxyl moiety is selected from: 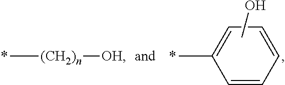
wherein n independently represents 0-4.

37. A MIP according to claim 35 wherein the at least one imidazole moiety is selected from:

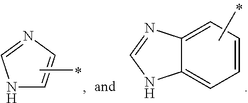

38. A MIP according to claim 35 wherein the at least one carboxyl moiety is selected from: 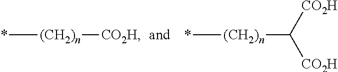
wherein each n independently represents 0-4.

39. A MIP according to claim 35 wherein the at least one hydroxyl moiety and at least one imidazole moiety are covalently bound, and are preferably represented by the formula (II):

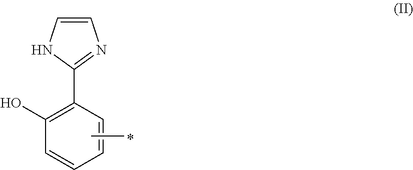

40. A MIP according to claim 39 wherein the at least one hydroxyl moiety and at least one imidazole moiety is represented by the formula (IIa): [chemical structure]
